(19) United States
(12) Patent Application Publication
(10) Pub. No.: US 2026/0092344 A1
(43) Pub. Date: Apr. 2, 2026

(54) NON-ORIENTED ELECTRICAL STEEL SHEET, IRON CORE, MANUFACTURING METHOD FOR IRON CORE, MOTOR, AND MANUFACTURING METHOD FOR MOTOR

(71) Applicant: NIPPON STEEL CORPORATION, Tokyo (JP)

(72) Inventors: Takeaki WAKISAKA, Tokyo (JP); Yoshiaki NATORI, Tokyo (JP)

(73) Assignee: NIPPON STEEL CORPORATION, Tokyo (JP)

(21) Appl. No.: 19/111,157

(22) PCT Filed: Sep. 19, 2023
(86) PCT No.: PCT/JP2023/033897

§ 371 Date: Mar. 12, 2025

(30) Foreign Application Priority Data
Sep. 29, 2022 (JP) 2022-156745

(51) Int. Cl. C22C 38/02; C21D 8/0221; C21D 8/0247; C21D 8/0278; H01F 1/147; H01F 41/02

(52) U.S. Cl. CPC C22C 38/02; C21D 8/0226; C21D 8/0236; C21D 8/0257; C21D 8/0273; C21D 8/0284; H01F 1/14783; H01F 41/0233

(57) ABSTRACT

A non-oriented electrical steel sheet includes a base steel sheet and an insulating coating, wherein the base steel sheet includes a predetermined chemical composition, a thickness of the base steel sheet is 0.10 mm or more and 0.35 mm or less, and when the base steel sheet is viewed in a cross section whose cutting direction is parallel to a thickness direction, an average grain size is 10 μm or less in a surface region which ranges from a surface of the base steel sheet to 1/20 of the thickness.

### TECHNICAL FIELD

The present invention relates to a non-oriented electrical steel sheet, an iron core, a manufacturing method for an iron core, a motor, and a manufacturing method for a motor. More specifically, the present invention relates to a non-oriented electrical steel sheet having excellent high-frequency iron loss, an iron core including the non-oriented electrical steel sheet and a manufacturing method for the iron core, and a motor including the iron core and a manufacturing method for the motor.

Priority is claimed on Japanese Patent Application No. 2022-156745, filed on Sep. 29, 2022, the content of which is incorporated herein by reference.

### BACKGROUND ART

Due to a need to reduce global warming gases, products with low energy consumption have been developed in industrial fields. For instance, in a field of an automobile, there are fuel-efficient vehicles such as hybrid-driven vehicles that combine a gasoline engine and a motor, and motor-driven electric vehicles. A technology common to these fuel-efficient vehicles is a motor, and miniaturizing the motor and increasing an efficiency of the motor have become an important technology.

For instance, it is demanded to miniaturize the drive motor used in hybrid driving vehicles and electric vehicles in order to save installation space and to reduce fuel consumption by weight reduction. In order to miniaturize the motor, it is necessary to increase the torque of the motor. Therefore, a non-oriented electrical steel sheet used as an iron core material of the motor has been required to further improve magnetic characteristics.

In addition, since the battery capacity which can be mounted on the vehicles is limited, it is demanded to increase the efficiency of the drive motor. In order to increase the efficiency of the motor, it is necessary to reduce energy loss. Therefore, the non-oriented electrical steel sheet used as the iron core material of the motor has been required to further reduce iron loss. In particular, for the motor for hybrid driving vehicles or electric vehicles, the rotation rate of the drive motor is increased in order to compensate for a decrease in torque due to miniaturization. Therefore, the non-oriented electrical steel sheet has been required to further reduce iron loss in the high frequency range.

For instance, Patent Document 1 discloses an electrical steel sheet which achieves both high magnetic flux density and low iron loss in high frequency by having a three-layer clad structure in which both surfaces of a grain-oriented electrical steel sheet as an inner layer are sandwiched by non-oriented electrical steel sheets to become surface layers. In addition, Patent Document 2 discloses a Fe-based metal sheet which achieves both high magnetic flux density and high strength by changing chemical compositions in a thickness direction and changing grain sizes in the thickness direction.

### CITATION LIST

### Patent Documents

Patent Document 1: Japanese Unexamined Patent Application, First Publication No. 2010-132938
Patent Document 2: Japanese Unexamined Patent Application, First Publication No. 2016-183358

### SUMMARY OF INVENTION

### Technical Problem

For the non-oriented electrical steel sheet used as the iron core material of the motor, it has been investigated to increase magnetic flux density, improve iron loss characteristics, and the like. However, at present, it is required to further improve the magnetic characteristics, particularly high-frequency iron loss, of the non-oriented electrical steel sheet.

An aspect of the present invention has been made in view of the above mentioned situations. An object of an aspect of the present invention is to provide a non-oriented electrical steel sheet having excellent high-frequency iron loss. In addition, an object of an aspect of the present invention is to provide an iron core including the non-oriented electrical steel sheet and a manufacturing method for the iron core, and a motor including the iron core and a manufacturing method for the motor.

### Solution to Problem

(1) A non-oriented electrical steel sheet according to an aspect of the present invention includes: a base steel sheet; and an insulating coating, wherein the base steel sheet includes, as a chemical composition, in terms of mass %,
1.0% or more and 5.0% or less of Si,
0% or more and 0.0050% or less of C,
0% or more and 3.0% or less of Mn,
0% or more and 0.30% or less of P,
0% or more and 0.010% or less of S,
0% or more and 3.0% or less of Al,
0% or more and 0.10% or less of Zn,
0% or more and 0.010% or less of N,
0% or more and 0.10% or less of Sn,
0% or more and 0.10% or less of Sb,
0% or more and 0.010% or less of Ca,
0% or more and 5.0% or less of Cr,
0% or more and 5.0% or less of Ni,
0% or more and 5.0% or less of Cu,
0% or more and 0.10% or less of Ce,
0% or more and 0.10% or less of B,
0% or more and 0.10% or less of O,
0% or more and 0.10% or less of Mg,
0% or more and 0.10% or less of Ti,
0% or more and 0.10% or less of V,
0% or more and 0.10% or less of Zr,
0% or more and 0.10% or less of Nd,
0% or more and 0.10% or less of Bi,
0% or more and 0.10% or less of W,
0% or more and 0.10% or less of Mo,
0% or more and 0.10% or less of Nb,
0% or more and 0.10% or less of Y, and
a balance consisting of Fe and impurities,
a thickness of the base steel sheet is 0.10 mm or more and 0.35 mm or less, and
when the base steel sheet is viewed in a cross section whose cutting direction is parallel to a thickness direction, an average grain size is 10 μm or less in a surface region which ranges from a surface of the base steel sheet to 1/20 of the thickness.

(2) In the non-oriented electrical steel sheet according to (1),
when the base steel sheet is viewed in the cross section,
an average grain size may be 50 μm or more and 200 μm or less in an intermediate region which ranges from 1/20 of the thickness to ¼ of the thickness based on the surface, and
an average grain size may be 50 μm or more and 200 μm or less in a central region which ranges from ¼ of the thickness to ½ of the thickness based on the surface.

(3) In the non-oriented electrical steel sheet according to (1) or (2),
the base steel sheet may limit, as the chemical composition, in terms of mass %, 0% or more and less than 0.030% of Sn.

(4) In the non-oriented electrical steel sheet according to any one of (1) to (3), when the base steel sheet is viewed in the cross section and when an R value is defined as R=9.9+12.4[Si]+10.0[Al]+6.6[Mn] which is calculated using a Si content, an Al content, and a Mn content in mass % in the chemical composition of the base steel sheet,
the R value may be 60 or more and 250 or less in a region which ranges from the surface to 1/10 of the thickness, and
the R value may be 30 or more and less than 60 in a region which ranges from 1/10 of the thickness to ½ of the thickness based on the surface.

(5) In the non-oriented electrical steel sheet according to any one of (1) to (4),
at a position of ½ of the thickness based on the surface, a {100} reflected intensity may be 2.4 or more, and an area fraction of {100} oriented grains may be 18% or more in an observed visual field.

(6) An iron core according to an aspect of the present invention may include the non-oriented electrical steel sheet according to any one of (1) to (5).

(7) A manufacturing method for an iron core according to an aspect of the present invention may include a process of laminating the non-oriented electrical steel sheet according to any one of (1) to (5).

(8) A motor according to an aspect of the present invention may include the iron core according to (6).

(9) A manufacturing method for a motor according to an aspect of the present invention may include: a process of laminating the non-oriented electrical steel sheet according to any one of (1) to (5) to obtain an iron core; and a process of assembling the iron core into a motor.

### Advantageous Effects of Invention

According to the above aspects of the present invention, it is possible to provide a non-oriented electrical steel sheet having excellent high-frequency iron loss. In addition, it is possible to provide an iron core including the non-oriented electrical steel sheet and a manufacturing method for the iron core, and a motor including the iron core and a manufacturing method for the motor.

### BRIEF DESCRIPTION OF DRAWINGS

FIG. 1 is a cross sectional illustration of a non-oriented electrical steel sheet according to an embodiment of the present invention.

FIG. 2 is a flowchart of a manufacturing method for a non-oriented electrical steel sheet according to an embodiment of the present invention.

### DESCRIPTION OF EMBODIMENTS

Hereinafter, a preferable embodiment of the present invention is described in detail. However, the present invention is not limited only to the configuration which is disclosed in the embodiment, and various modifications are possible without departing from the aspect of the present invention. In addition, the limitation range as described below includes a lower limit and an upper limit thereof. However, the value expressed by “more than” or “less than” does not include in the limitation range. “%” of the amount of respective elements expresses “mass %”.

### [Non-Oriented Electrical Steel Sheet]

The non-oriented electrical steel sheet according to the embodiment has the following features.

The non-oriented electrical steel sheet according to the embodiment includes: a base steel sheet; and an insulating coating, wherein
the base steel sheet includes, as a chemical composition, in terms of mass %,
1.0% or more and 5.0% or less of Si,
0% or more and 0.0050% or less of C,
0% or more and 3.0% or less of Mn,
0% or more and 0.30% or less of P,
0% or more and 0.010% or less of S,
0% or more and 3.0% or less of Al,
0% or more and 0.10% or less of Zn,
0% or more and 0.010% or less of N,
0% or more and 0.10% or less of Sn,
0% or more and 0.10% or less of Sb,
0% or more and 0.010% or less of Ca,
0% or more and 5.0% or less of Cr,
0% or more and 5.0% or less of Ni,
0% or more and 5.0% or less of Cu,
0% or more and 0.10% or less of Ce,
0% or more and 0.10% or less of B,
0% or more and 0.10% or less of O,
0% or more and 0.10% or less of Mg,
0% or more and 0.10% or less of Ti,
0% or more and 0.10% or less of V,
0% or more and 0.10% or less of Zr,
0% or more and 0.10% or less of Nd,
0% or more and 0.10% or less of Bi,
0% or more and 0.10% or less of W,
0% or more and 0.10% or less of Mo,
0% or more and 0.10% or less of Nb,
0% or more and 0.10% or less of Y, and
a balance consisting of Fe and impurities,
a thickness of the base steel sheet is 0.10 mm or more and 0.35 mm or less, and
when the base steel sheet is viewed in a cross section whose cutting direction is parallel to a thickness direction, an average grain size is 10 μm or less in a surface region which ranges from a surface of the base steel sheet to 1/20 of the thickness.

In the non-oriented electrical steel sheet according to the embodiment,
when the base steel sheet is viewed in the cross section,
an average grain size is preferably 50 μm or more and 200 μm or less in an intermediate region which ranges from 1/20 of the thickness to ¼ of the thickness based on the surface, and
an average grain size is preferably 50 μm or more and 200 μm or less in a central region which ranges from ¼ of the thickness to ½ of the thickness based on the surface.

In the non-oriented electrical steel sheet according to the embodiment,
the base steel sheet preferably limits, as the chemical composition, in terms of mass %, 0% or more and less than 0.030% of Sn.

In the non-oriented electrical steel sheet according to the embodiment,
when the base steel sheet is viewed in the cross section and when an R value is defined as R=9.9+12.4[Si]+10.0[Al]+6.6[Mn] which is calculated using a Si content, an Al content, and a Mn content in mass % in the chemical composition of the base steel sheet,
the R value is preferably 60 or more and 250 or less in a region which ranges from the surface to 1/10 of the thickness, and
the R value is preferably 30 or more and less than 60 in a region which ranges from 1/10 of the thickness to ½ of the thickness based on the surface.

In the non-oriented electrical steel sheet according to the embodiment,
at a position of ½ of the thickness based on the surface, a {100} reflected intensity is preferably 2.4 or more, and an area fraction of {100} oriented grains is preferably 18% or more in an observed visual field.

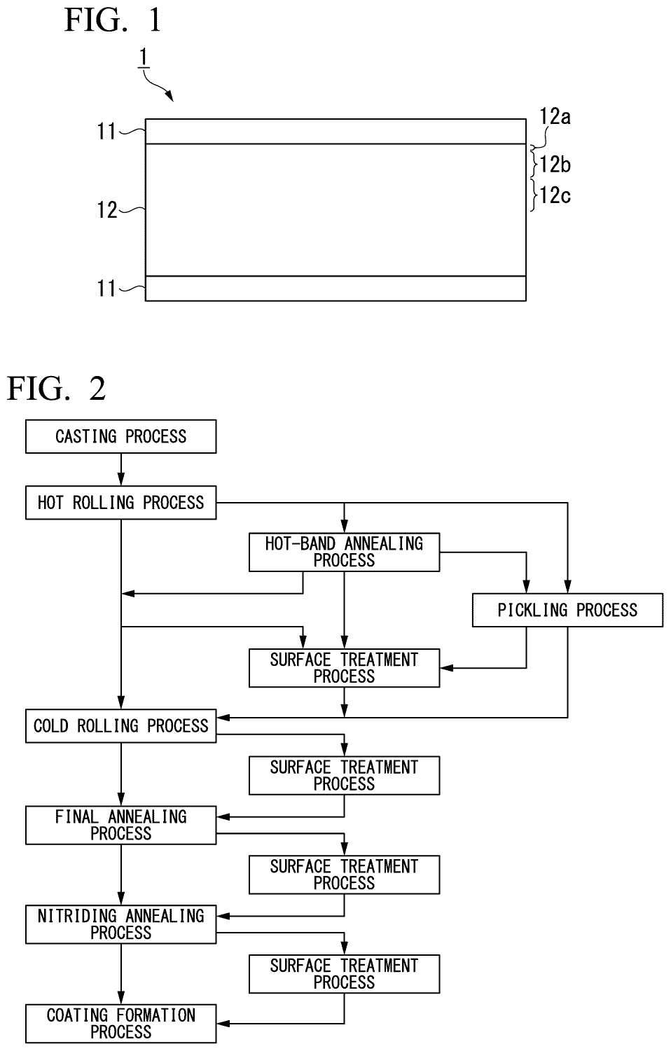

FIG. 1 is a cross sectional illustration of the non-oriented electrical steel sheet according to the embodiment. According to the embodiment, a non-oriented electrical steel sheet 1 includes an insulating coating 11 and a base steel sheet 12. When the base steel sheet 12 is viewed in a cross section whose cutting direction is parallel to the thickness direction, the base steel sheet 12 may be divided into: a surface region 12a which ranges from the surface to 1/20 of the thickness of the base steel sheet 12; an intermediate region 12b which ranges from 1/20 of the thickness to ¼ of the thickness of the base steel sheet 12; and a central region 12c which ranges from ¼ of the thickness to ½ of the thickness of the base steel sheet 12. Hereinafter, each of the features of the non-oriented electrical steel sheet according to the embodiment will be described in detail.

### [Thickness]

In the non-oriented electrical steel sheet according to the embodiment, the thickness of the base steel sheet is 0.35 mm or less. The thickness is preferably 0.30 mm or less. On the other hand, when the sheet thickness is excessively thin, productivity of the steel sheet and the motor deteriorates significantly and magnetic characteristics may deteriorate. Thus, the thickness of the base steel sheet is 0.10 mm or more. The thickness is preferably 0.15 mm or more.

The thickness of the base steel sheet may be measured by a micrometer. When the non-oriented electrical steel sheet to be a measurement sample has the insulating coating and the like on the surface, the thickness is measured after removing the coating.

For instance, the insulating coating may be removed by the following method.

First, the non-oriented electrical steel sheet having the insulating coating and the like may be immersed in sodium hydroxide aqueous solution, sulfuric acid aqueous solution, and nitric acid aqueous solution in this order, and then may be washed.

Finally, the steel sheet is dried with warm air. Thereby, it is possible to obtain the non oriented electrical steel sheet from which the insulation coating is removed (base steel sheet).

### [Average Grain Size]

In the non-oriented electrical steel sheet according to the embodiment, when the base steel sheet is viewed in a cross section whose cutting direction is parallel to the thickness direction, the average grain size is 10 μm or less in the surface region which ranges from the surface of the base steel sheet to 1/20 of the thickness. Although the surface region is described for one sheet surface of the base steel sheet, the above condition may be satisfied for both sheet surfaces of the base steel sheet.

In the surface region, the average grain size is preferably 9 μm or less, and more preferably 8 μm or less. On the other hand, in the surface region, the lower limit of the average grain size is not particularly limited. For instance, in the surface region, the average grain size is 1 μm or more.

When the average grain size satisfies the above conditions in the surface region, the high-frequency iron loss is preferably improved. For instance, the iron loss is the total loss of the eddy-current loss and the hysteresis loss. At the commercial frequencies (for instance, approximately 50 Hz), the ratio of the hysteresis loss is higher than that of the eddy-current loss in the iron loss. Also, at the commercial frequencies, the skin effect is not as remarkable as at the high frequencies. On the other hand, at the high frequencies (for instance, approximately 1 kHz), the ratio of the eddy-current loss increases in the iron loss, and the skin effect becomes remarkable. In the embodiment, it is estimated that: the average grain size becomes fine in the surface region, that is, the width of magnetic domain decreases in the surface region, and thereby, the iron loss, mainly the eddy-current loss, when the skin effect which is remarkable at the high frequencies is effective, is reduced.

The average grain size in the surface region described above is controlled by the specific manufacturing conditions in the embodiment. The manufacturing conditions for controlling the average grain size will be described later in detail.

In the non-oriented electrical steel sheet according to the embodiment, when the base steel sheet is viewed in the cross section, the average grain size is preferably 50 μm or more and 200 μm or less in the intermediate region which ranges from 1/20 of the thickness to ¼ of the thickness based on the surface, and the average grain size is preferably 50 μm or more and 200 μm or less in the central region which ranges from ¼ of the thickness to ½ of the thickness based on the surface. Although the intermediate region and the central region are described for one sheet surface of the base steel sheet, the above condition may be satisfied for both sheet surfaces of the base steel sheet. ½ of the thickness corresponds to the center of the base steel sheet in the thickness direction in the cross section.

In the intermediate region, the average grain size is preferably more than 60 μm, and more preferably 70 μm or more. In the intermediate region, the average grain size is preferably 150 μm or less, and more preferably 120 μm or less. Similarly, in the central region, the average grain size is preferably more than 60 μm, and more preferably 70 μm or more. In the central region, the average grain size is preferably 150 μm or less, and more preferably 120 μm or less.

As described above, the intermediate region is the region which ranges from 1/20 of the thickness to ¼ of the thickness based on the surface of the base steel sheet. When a region which ranges from 1/20 of the thickness to 1/10 of the thickness based on the surface is divided within the intermediate region, the region which ranges from 1/20 of the thickness to 1/10 of the thickness also preferably has an average grain size equal to that of the intermediate region. For instance, when the average grain size is more than 60 μm in the intermediate region, the average grain size is also preferably more than 60 μm in the region which ranges from 1/20 of the thickness to 1/10 of the thickness. Similarly, when the average grain size is 150 μm or less in the intermediate region, the average grain size is also preferably 150 μm or less in the region which ranges from 1/20 of the thickness to 1/10 of the thickness. A region which ranges from 1/10 of the thickness to ¼ of the thickness also preferably has an average grain size equal to that of the intermediate region.

When the average grain size satisfies the above conditions in the intermediate region and the central region, the hysteresis loss and the magnetic permeability are preferably improved. In particular, in a low magnetic field (for instance, excited magnetizing force of approximately 100 A/m) or in a middle magnetic field (for instance, excited magnetizing force of approximately 1000 A/m), the magnetization process proceeds mainly by domain wall movement, and thus it is preferable that grain boundaries, which inhibit the domain wall movement, are not excessive. In the embodiment, it is estimated that the average grain size is controlled in an appropriate size in the intermediate region and in the central region, and thereby, the hysteresis loss is reduced and the magnetic permeability from the low magnetic field to the middle magnetic field is increased.

The average grain size in the intermediate region and the central region described above is controlled by the specific manufacturing conditions in the embodiment. The manufacturing conditions for controlling the average grain size will be described later in detail.

In conventional techniques, when the grain size is changed along the thickness direction, the grain size often changes gradually from the surface region toward the intermediate region and the central region. In this case, for instance, the average grain size in the intermediate region often has a value between the values in the surface region and the central region. In particular, the region which ranges from 1/20 of the thickness to 1/10 of the thickness often has a fine average grain size. On the other hand, in the embodiment, the average grain size is controlled to be fine only in the surface region, and the average grain size is controlled to be an appropriate size in the intermediate region and the central region. Specifically, in the embodiment, the average grain size is fine in the surface region, but the average grain size in the intermediate region is equivalent to that in the central region. As a result, the high-frequency iron loss can be preferably improved.

The average grain size in the base steel sheet may be measured on the basis of an intercept method regulated by JIS G0551: 2020. For instance, in a longitudinal sectional micrograph, an average value of grain sizes may be measured by the intercept method along a direction orthogonal to the thickness direction. As the longitudinal sectional micrograph, an optical micrograph may be used, and for instance, a micrograph obtained at a magnification of 100-fold may be used. Under the above conditions, the average grain size may be determined for each of the surface region, the intermediate region, and the central region.

### [Texture]

In the non-oriented electrical steel sheet according to the embodiment, at a position of ½ of the thickness based on the surface of the base steel sheet, the {100} reflected intensity is preferably 2.4 or more, and the area fraction of {100} oriented grains is preferably 18% or more in an observed visual field.

At the position of ½ of the thickness, the {100} reflected intensity is preferably 3.5 or more, and more preferably 3.8 or more. On the other hand, at the position of ½ of the thickness, the upper limit of the {100} reflected intensity is not particularly limited. For instance, at the position of ½ of the thickness, the {100} reflected intensity is 10 or less.

When the {100} reflected intensity satisfies the above conditions at the position of ½ of the thickness, the magnetic characteristics in a high magnetic field are preferably improved. The crystal orientation in the vicinity of {100} is a texture contributing to improvement in magnetic flux density. For instance, when the Si content and the like increase as the steel composition of the base steel sheet, the saturated magnetic flux density decreases. However, when the {100} reflected intensity increases as the texture of the base steel sheet, the magnetic flux density is improved. In the embodiment, the {100} reflected intensity is appropriately controlled together with other technical features. Thereby, the magnetic characteristics in the high magnetic field, mainly the magnetic flux density in the high magnetic field (for instance, excited magnetizing force of approximately 5000 A/m), are improved.

In addition, at the position of ½ of the thickness, the area fraction of {100} oriented grains is preferably 20% or more, and more preferably 22% or more in an observed visual field. On the other hand, at the position of ½ of the thickness, the upper limit of the area fraction of {100} oriented grains is not particularly limited. For instance, at the position of ½ of the thickness, the area fraction of {100} oriented grains is 100% or less, and may be 35% or less.

When the area fraction of {100} oriented grains satisfies the above conditions at the position of ½ of the thickness, the magnetic characteristics in the high magnetic field are preferably improved. The crystal orientation in the vicinity of {100} is a texture contributing to improvement in magnetic flux density. For instance, when the Si content and the like increase as the steel composition of the base steel sheet, the saturated magnetic flux density decreases. However, when the area fraction of {100} oriented grains increases at the position of ½ of the thickness in the base steel sheet, the magnetic flux density is improved. In the embodiment, the area fraction of {100} oriented grains is appropriately controlled together with other technical features. Thereby, the magnetic characteristics in the high magnetic field, mainly the magnetic flux density in the high magnetic field (for instance, excited magnetizing force of approximately 5000 A/m), are improved.

The {100} reflected intensity and the area fraction of {100} oriented grains at the position of ½ of the thickness described above is controlled by the specific manufacturing conditions in the embodiment. The manufacturing conditions for controlling the average grain size will be described later in detail.

The {100} reflected intensity of the base steel sheet may be measured by comparing the integrated intensity of the {100}diffraction with the ideal intensity of a sample with a random orientation using the X-ray diffraction profile. The measurement can be performed using, for instance, a sample horizontal type strong X-ray diffractometer RINT-TTR3 or a powder X-ray diffractometer RINT-2000, each of which is manufactured by Rigaku Corporation. However, the measurement result does not essentially depend on the measuring instrument. Under the above conditions, the {100} reflected intensity at the position of ½ of the thickness may be determined. The position of ½ of the thickness may be revealed by polishing the sheet surface of the base steel sheet in parallel and gradually reducing the thickness.

The area fraction of {100} oriented grains in the base steel sheet may be measured by a scanning electron microscope with an electron beam backscatter diffractometer (SEM-EBSD). The measurement can be performed using, for instance, a scanning electron microscope JSM-6400 which is manufactured by JEOL Ltd.; an EBSD detector HIKARI which is manufactured by TSL; and an OIM analysis which is manufactured by TSL. However, the measurement result does not essentially depend on the measuring instrument. In the measurement, for instance, using a sample polished for EBSD such that polishing strain does not remain in the surface, the following settings may be employed: the step interval is 2 μm, the measurement area is 8000 μm×2400 μm, the angle difference of the crystal orientation is 15° or more for the grain boundary determination, and the determination of the area fraction of {100} oriented grains is based on tolerance 20°. Under the above conditions, the area fraction of {100} oriented grains at the position of ½ of the thickness may be determined. As described above, the position of ½ of the thickness may be revealed by polishing the sheet surface of the base steel sheet in parallel and gradually reducing the thickness. ½ of the thickness corresponds to the center of the base steel sheet in the thickness direction.

### [Chemical Composition]

In the non-oriented electrical steel sheet according to the embodiment, the base steel sheet, as a chemical composition, includes Si, includes an optional element as necessary, and may include a balance consisting of Fe and impurities.

Specifically, the base steel sheet includes, as a chemical composition, in terms of mass %,
1.0% or more and 5.0% or less of Si,
0% or more and 0.0050% or less of C,
0% or more and 3.0% or less of Mn,
0% or more and 0.30% or less of P,
0% or more and 0.010% or less of S,
0% or more and 3.0% or less of Al,
0% or more and 0.10% or less of Zn,
0% or more and 0.010% or less of N,
0% or more and 0.10% or less of Sn,
0% or more and 0.10% or less of Sb,
0% or more and 0.010% or less of Ca,
0% or more and 5.0% or less of Cr,
0% or more and 5.0% or less of Ni,
0% or more and 5.0% or less of Cu,
0% or more and 0.10% or less of Ce,
0% or more and 0.10% or less of B,
0% or more and 0.10% or less of O,
0% or more and 0.10% or less of Mg,
0% or more and 0.10% or less of Ti,
0% or more and 0.10% or less of V,
0% or more and 0.10% or less of Zr,
0% or more and 0.10% or less of Nd,
0% or more and 0.10% or less of Bi,
0% or more and 0.10% or less of W,
0% or more and 0.10% or less of Mo,
0% or more and 0.10% or less of Nb,
0% or more and 0.10% or less of Y, and
a balance consisting of Fe and impurities.

Hereinafter, each element will be described. The following chemical composition of the base steel sheet is an average value of the entire base steel sheet.

### Si: 1.0% or More and 5.0% or Less

Si (silicon) is an element effective in increasing the electrical resistivity of the steel sheet and reducing the iron loss. Therefore, the Si content is 1.0% or more. The Si content is preferably 1.5% or more, and more preferably 2.0% or more. On the other hand, when Si is excessively included, the magnetic flux density significantly decreases. Therefore, the Si content is 5.0% or less. The Si content is preferably 4.0% or less, and more preferably 3.50% or less.

### C: 0% or More and 0.0050% or Less

C (carbon) is an optional element. However, when C is excessively included, the magnetic characteristics are deteriorated. Therefore, the C content is 0.0050% or less. The C content is preferably 0.0030% or less. On the other hand, since the C content is preferably low, it is not necessary to limit the lower limit, and the lower limit may be 0%. However, since it is not easy to industrially control the content to 0%, the lower limit may be more than 0% or 0.0010%.

### Mn: 0% or More and 3.0% or Less

Mn (manganese) is an optional element. Mn has an effect of increasing the electrical resistivity of the steel sheet and reducing the iron loss. However, since the alloy cost of Mn is higher than that of Si or Al, an increase in the Mn content is economically disadvantageous. Therefore, the Mn content is 3.0% or less. The content is preferably 2.50% or less. It is not necessary to limit the lower limit of Mn, and the lower limit may be 0%. However, in order to more reliably obtain the above effect, the Mn content is preferably more than 0%, preferably 0.0010% or more, and more preferably 0.010% or more.

### P: 0% or More and 0.30% or Less

P (phosphorus) is an optional element. P has an effect of improving the texture of the non-oriented electrical steel sheet and improving the magnetic characteristics. However, P is also a solid-solution strengthening element. Therefore, when the P content is excessive, the steel sheet becomes hard and difficult to perform cold rolling. Therefore, the P content is 0.30% or less. The P content is preferably 0.20% or less. It is not necessary to limit the lower limit of P, and the lower limit may be 0%. However, in order to more reliably obtain the above effect, the P content is preferably more than 0%, preferably 0.0010% or more, and more preferably 0.0150% or more.

### S: 0% or More and 0.010% or Less

S (sulfur) is an optional element. However, S may combine with Mn in the steel to form fine MnS, suppresses grain growth during annealing, and deteriorate the magnetic characteristics of the non-oriented electrical steel sheet. Therefore, the S content is 0.010% or less. The S content is preferably 0.0050% or less, and more preferably 0.0030% or less. Since the S content is preferably low, it is not necessary to limit the lower limit, and the lower limit may be 0%. However, since it is not easy to industrially control the content to 0%, the lower limit may be more than 0% or 0.00010%.

### Al: 0% or More and 3.0% or Less

Al (aluminum) is an optional element. Al is an optional element effective in increasing the electrical resistivity of the steel sheet and reducing the iron loss.

However, when Al is excessively included, the magnetic flux density significantly decreases. Therefore, the Al content is 3.0% or less. It is not necessary to limit the lower limit of Al, and the lower limit may be 0%. However, in order to more reliably obtain the effect of the above action, the Al content is preferably 0.10% or more. In the embodiment, Al indicates acid-soluble aluminum.

### Zn: 0% or More and 0.10% or Less

Zn (zinc) is an optional element. Zn is an element effective in improving magnetic flux density, iron loss characteristics, and punching quality, but the above effect is saturated even if Zn is excessively included. Therefore, the Zn content is 0.10% or less. It is not necessary to limit the lower limit of Zn, and the lower limit may be 0%. However, in order to more reliably obtain the effect of the above action, the Zn content is preferably 0.0010% or more.

### N: 0% or More and 0.010% or Less

N (nitrogen) is an optional element. However, N may combine with Al to form fine AlN, suppresses grain growth during annealing, and deteriorate the magnetic characteristics. Therefore, the N content is 0.010% or less. The N content is preferably 0.0050% or less, and more preferably 0.0030% or less. Since the N content is preferably low, it is not necessary to limit the lower limit, and the lower limit may be 0%. However, since it is not easy to industrially control the content to 0%, the lower limit may be more than 0%, may be 0.00010% or more, may be 0.00150% or more, and may be 0.00250% or more.

### Sn: 0% or More and 0.10% or Less

### Sb: 0% or More and 0.10% or Less

Sn (tin) and Sb (antimony) are optional elements. Sn and Sb have an effect of improving the texture of the non-oriented electrical steel sheet and improving the magnetic characteristics (for instance, magnetic flux density). However, when Sn and Sb are excessively included, the steel may be embrittled to cause cold rolling fracture, and magnetic characteristics may be deteriorated. Therefore, the amount of each of Sn and Sb is 0.10% or less. In order that the average grain size is controlled to be fine in the surface region of the base steel sheet, the Sn content is preferably less than 0.030%. On the other hand, it is not necessary to limit the lower limit of Sn and Sb, and the lower limit may be 0%. However, in order to more reliably obtain the above effect, the Sn content is preferably more than 0%, preferably 0.0010% or more, and more preferably 0.010% or more. In addition, the Sb content is preferably more than 0%, preferably 0.0010% or more, preferably 0.0020% or more, further preferably 0.010% or more, and further preferably more than 0.0250%.

### Ca: 0% or More and 0.010% or Less

Ca (calcium) is an optional element. Ca is effective in controlling inclusions because Ca suppresses precipitation of fine sulfides (MnS, Cu₂S, or the like) by forming coarse sulfides. When Ca is appropriately added, the grain growth is improved, and thereby, the magnetic characteristics (for instance, iron loss) are improved. However, when Ca is excessively included, the above effect is saturated, and the cost increases. Therefore, the Ca content is 0.010% or less. The Ca content is preferably 0.0080% or less, and more preferably 0.0050% or less. It is not necessary to limit the lower limit of Ca, and the lower limit may be 0%. However, in order to more reliably obtain the above effect, the Ca content is preferably more than 0%, and preferably 0.00030% or more. The Ca content is preferably 0.0010% or more, and more preferably 0.0030% or more.

### Cr: 0% or More and 5.0% or Less

Cr (chromium) is an optional element. Cr has an effect of increasing electrical resistivity and improving magnetic characteristics (for instance, iron loss). However, when Cr is excessively included, the saturated magnetic flux density may decrease, the above effect is saturated, and the cost increases. Therefore, the Cr content is 5.0% or less. The Cr content is preferably 2.0% or less, and more preferably 1.0% or less. It is not necessary to limit the lower limit of Cr, and the lower limit may be 0%. However, in order to more reliably obtain the above effect, the Cr content is preferably more than 0%, and preferably 0.0010% or more. Cr suppresses formation of Kirkendall voids in the base steel sheet. Therefore, the Cr content is preferably 0.50% or more.

### Ni: 0% or More and 5.0% or Less

Ni (nickel) is an optional element. Ni has an effect of improving magnetic characteristics (for instance, saturated magnetic flux density). However, when Ca is excessively included, the above effect is saturated, and the cost increases. Therefore, the Ni content is 5.0% or less. The Ni content is preferably 0.50% or less, and more preferably 0.10% or less. It is not necessary to limit the lower limit of Ni, and the lower limit may be 0%. However, in order to more reliably obtain the above effect, the Ni content is preferably more than 0%, and preferably 0.0010% or more.

### Cu: 0% or More and 5.0% or Less

Cu (copper) is an optional element. Cu has an effect of improving the steel sheet strength. However, when Cr is excessively included, the saturated magnetic flux density may decrease, the above effect is saturated, and the cost increases. Therefore, the Cu content is 5.0% or less. The Cu content is preferably 0.10% or less. It is not necessary to limit the lower limit of Cu, and the lower limit may be 0%. However, in order to more reliably obtain the above effect, the Cu content is preferably more than 0%, and preferably 0.0010% or more.

### Ce: 0% or More and 0.10% or Less

Ce (cerium) is an optional element. Ce has an effect of suppressing the precipitation of fine sulfides (MnS, Cu₂S, or the like) by forming coarse sulfides, coarse oxysulfides, and the like. As a result, the grain growth is improved, and the iron loss is improved. However, when the content is excessive, the iron loss may be deteriorated by forming oxides in addition to sulfides and oxysulfides, the effect thereof is saturated, and the cost increases. Therefore, the Ce content is 0.10% or less. The Ce content is preferably 0.010% or less, more preferably 0.0090% or less, and still more preferably 0.0080% or less. It is not necessary to limit the lower limit of Ce, and the lower limit may be 0%. However, in order to more reliably obtain the above effect, the Ce content is preferably more than 0%, and preferably 0.0010% or more. The Ce content is more preferably 0.0020% or more, still more preferably 0.0030% or more, and still more preferably 0.0050% or more.

In addition to the above elements, the non-oriented electrical steel sheet according to the embodiment may contain, as the chemical composition, the optional elements such as B, O, Mg, Ti, V, Zr, Nd, Bi, W, Mo, Nb, and Y. Amounts of these optional elements may be controlled on the basis of known knowledge. For instance, the amounts of these optional elements may be as follows. The lower limit of these optional elements may be more than 0%.
0% or more and 0.10% or less of B
0% or more and 0.10% or less of O
0% or more and 0.10% or less of Mg
0% or more and 0.10% or less of Ti
0% or more and 0.10% or less of V
0% or more and 0.10% or less of Zr
0% or more and 0.10% or less of Nd
0% or more and 0.10% or less of Bi
0% or more and 0.10% or less of W
0% or more and 0.10% or less of Mo
0% or more and 0.10% or less of Nb
0% or more and 0.10% or less of Y

In the non-oriented electrical steel sheet of the embodiment, the base steel sheet preferably includes, as the chemical composition, in terms of mass %, at least one of:
0.0010% or more and 0.0050% or less of C,
0.0010% or more and 3.0% or less of Mn,
0.0010% or more and 0.30% or less of P,
0.00010% or more and 0.010% or less of S,
more than 0.00150% and 0.010% or less of N,
0.00010% or more and 0.10% or less of B,
0.00010% or more and 0.10% or less of O,
0.00010% or more and 0.10% or less of Mg,
0.00030% or more and 0.010% or less of Ca,
0.00010% or more and 0.10% or less of Ti,
0.00010% or more and 0.10% or less of V,
0.0010% or more and 5.0% or less of Cr,
0.0010% or more and 5.0% or less of Ni,
0.0010% or more and 5.0% or less of Cu,
0.00020% or more and 0.10% or less of Zr,
0.0010% or more and 0.10% or less of Sn,
0.0010% or more and 0.10% or less of Sb,
0.0010% or more and 0.10% or less of Ce,
0.0020% or more and 0.10% or less of Nd,
0.0020% or more and 0.10% or less of Bi,
0.0020% or more and 0.10% or less of W,
0.0020% or more and 0.10% or less of Mo,
0.00010% or more and 0.10% or less of Nb, and
0.0020% or more and 0.10% or less of Y.

In addition, the B content is preferably 0.010% or less, the O content is preferably 0.010% or less, the Mg content is preferably 0.0050% or less, the Ti content is preferably 0.0020% or less, the V content is preferably 0.0020% or less, the Zr content is preferably 0.0020% or less, the Nd content is preferably 0.010% or less, the Bi content is preferably 0.010% or less, the W content is preferably 0.010% or less, the Mo content is preferably 0.01% or less, the Nb content is preferably 0.0020% or less, and the Y content is preferably 0.010% or less. In addition, the Ti content is preferably 0.0010% or more, the V content is preferably 0.0020% or more, and the Nb content is preferably 0.0020% or more.

The chemical composition as described above may be measured by typical analytical methods for the steel. For instance, the chemical composition may be measured by using ICP-AES (Inductively Coupled Plasma-Atomic Emission Spectrometer: inductively coupled plasma emission spectroscopy spectrometry). Herein, Al may be measured as the acid soluble Al by ICP-AES using filtrate after heating and dissolving the sample in acid. In addition, C and S may be measured by the infrared absorption method after combustion, N may be measured by the thermal conductometric method after fusion in a current of inert gas, and O may be measured by, for instance, the non-dispersive infrared absorption method after fusion in a current of inert gas.

The above-described chemical composition of the base steel sheet is an average value in the entire base steel sheet. In the non-oriented electrical steel sheet according to the embodiment, when the base steel sheet is viewed in the cross section and when an R value is defined as R=9.9+12.4[Si]+10.0[Al]+6.6[Mn] which is calculated using a Si content, an Al content, and a Mn content in mass % in the chemical composition of the base steel sheet, the R value is preferably 60 or more and 250 or less in a region which ranges from the surface to 1/10 of the thickness, and the R value is preferably 30 or more and less than 60 in a region which ranges from 1/10 of the thickness to ½ of the thickness based on the surface. Although each of the regions is described for one sheet surface of the base steel sheet, the above conditions may be satisfied for both sheet surfaces of the base steel sheet.

In the region which ranges from the surface to 1/10 of the thickness, the R value is preferably 65 or more, and more preferably 70 or more. In this region, the R value is preferably 240 or less, and more preferably 230 or less. On the other hand, in the region which ranges from 1/10 of the thickness to ½ of the thickness based on the surface, the R value is preferably 35 or more, and more preferably 40 or more. In this region, the R value is preferably 58 or less, and more preferably 56 or less.

When the R value satisfies the above conditions in the region which ranges from the surface to 1/10 of the thickness and in the region which ranges from 1/10 of the thickness to ½ of the thickness, especially when the R value satisfies the above conditions in the region which ranges from the surface to 1/10 of the thickness, the high-frequency iron loss is preferably improved. It is estimated that: when the R value is controlled as described above, the electrical resistivity is increased in the vicinity of the surface of the steel sheet, and thereby, the iron loss in a case that the skin effect which is remarkable at the high frequencies is effective, mainly the eddy-current loss, is reduced.

In the region which ranges from the surface to 1/10 of the thickness and in the region which ranges from 1/10 of the thickness to ½ of the thickness, the R value is controlled by the specific manufacturing conditions in the embodiment. The manufacturing conditions for controlling the R value will be described later in detail.

The R value may be determined by observing a cross section whose cutting direction is parallel to the thickness direction with an electron probe micro analyzer (EPMA). Specifically, a test piece is cut out so that the cutting direction is parallel to the thickness direction. The cross-sectional structure of this cross section is observed with EPMA at a magnification at which the thickness of the base steel sheet is included in the observed visual field. In the case where the thickness of the base steel sheet is not included in the observed visual field, the cross-sectional structure is observed in a plurality of continuous visual fields.

The base steel sheet in the observed visual field described above may be subjected to line analysis along the thickness direction by EPMA to determine the Si content, the Al content, and the Mn content in the region which ranges from the surface of the base steel sheet to 1/10 of the thickness, and the Si content, the Al content, and the Mn content in the region which ranges from 1/10 of the thickness to ½ of the thickness. From the line analysis result, the R value may be determined each in the region which ranges from the surface to 1/10 of the thickness and in the region which ranges from 1/10 of the thickness to ½ of the thickness. ½ of the thickness corresponds to the center of the base steel sheet in the thickness direction in the cross section.

[Manufacturing Method for Non-Oriented Electrical Steel Sheet]

Hereinafter, an example of the manufacturing method for the non-oriented electrical steel sheet according to the embodiment will be described. For the non-oriented electrical steel sheet according to the embodiment, the manufacturing method thereof is not particularly limited as long as the above-described configurations are included. The following manufacturing method is an example for manufacturing the non-oriented electrical steel sheet according to the embodiment, and is a preferred example of the manufacturing method for the non-oriented electrical steel sheet according to the embodiment.

For instance, the manufacturing method for the non-oriented electrical steel sheet according to the embodiment may include a casting process, a hot rolling process, a cold rolling process, a final annealing process, a nitriding annealing process, and a coating formation process.

Specifically, the manufacturing method for the non-oriented electrical steel sheet according to the embodiment may include
a casting process, a hot rolling process, a cold rolling process, a final annealing process, a nitriding annealing process, and a coating formation process, wherein;
in the casting process, a slab is cast, the slab including, as a chemical composition, in terms of mass %,
1.0% or more and 5.0% or less of Si,
0% or more and 0.0050% or less of C,
0% or more and 3.0% or less of Mn,
0% or more and 0.30% or less of P,
0% or more and 0.010% or less of S,
0% or more and 3.0% or less of Al,
0% or more and 0.10% or less of Zn,
0% or more and 0.010% or less of N,
0% or more and 0.10% or less of Sn,
0% or more and 0.10% or less of Sb,
0% or more and 0.010% or less of Ca,
0% or more and 5.0% or less of Cr,
0% or more and 5.0% or less of Ni,
0% or more and 5.0% or less of Cu,
0% or more and 0.10% or less of Ce,
0% or more and 0.10% or less of B,
0% or more and 0.10% or less of O,
0% or more and 0.10% or less of Mg,
0% or more and 0.10% or less of Ti,
0% or more and 0.10% or less of V,
0% or more and 0.10% or less of Zr,
0% or more and 0.10% or less of Nd,
0% or more and 0.10% or less of Bi,
0% or more and 0.10% or less of W,
0% or more and 0.10% or less of Mo,
0% or more and 0.10% or less of Nb,
0% or more and 0.10% or less of Y, and
a balance consisting of Fe and impurities;
in the hot rolling process, the slab is subjected to the hot rolling;
in the cold rolling process, the steel sheet is subjected to the cold rolling;
in the final annealing process,
as an oxidation stage, the steel sheet heated from room temperature is held in an atmosphere of 5 vol % or more and 15 vol % or less of hydrogen and a dew point of 40° C. or more and 60° C. or less in a temperature range of 170° C. or more and 190° C. or less for 90 seconds or more and 110 seconds or less,
as a heating stage, the steel sheet after the oxidation stage is heated in an atmosphere of 5 vol % or more and 15 vol % or less of hydrogen and a dew point of 40° C. or more and 60° C. or less at an average heating rate of 40° C./sec or more and 60° C./sec or less to a temperature range of 680° C. or more and 720° C. or less, and then heated in an atmosphere of 5 vol % or more and 25 vol % or less of hydrogen and a dew point of −20° C. or more and 20° C. or less at an average heating rate of 40° C./sec or more and 60° C./sec or less to a temperature range of 780° C. or more and 1050° C. or less,
as a holding stage, the steel sheet after the heating stage is held in an atmosphere of 5 vol % or more and 25 vol % or less of hydrogen and a dew point of −20° C. or more and 20° C. or less in a temperature range of 780° C. or more and 1050° C. or less for 10 seconds or more and 20 seconds or less, and
as a cooling stage, the steel sheet after the holding stage is cooled to a temperature range of room temperature or more and 720° C. or less;
in the nitriding annealing process, the steel sheet after the final annealing process is held in an atmosphere of 95 vol % or more and 100 vol % or less of nitrogen and a dew point of −50° C. or more and 0° C. or less in a temperature range of 680° C. or more and 720° C. or less for 70 seconds or more and 90 seconds or less; and
in the coating formation process,
as a coating formation stage, a coating is formed on the steel sheet after the nitriding annealing process, and
as an annealing stage, the steel sheet is held as necessary in a temperature range of 750° C. or more and 850° C. or less for 30 minutes or more and 150 minutes or less.

The manufacturing method for the non-oriented electrical steel sheet according to the embodiment may include a hot-band annealing process after the hot rolling process. The manufacturing method for the non-oriented electrical steel sheet according to the embodiment may include a pickling process after the hot rolling process or after the hot-band annealing process. The manufacturing method for the non-oriented electrical steel sheet according to the embodiment may include a surface treatment process after the hot rolling process, after the hot-band annealing process, after the pickling process, or after the cold rolling process.

FIG. 2 is a flowchart of the manufacturing method for the non-oriented electrical steel sheet according to the embodiment. Hereinafter, each process will be described in detail.

### [Casting Process]

In the casting process, a slab (steel piece) having the above chemical composition may be cast. The chemical composition of the slab described above is substantially the same as the chemical composition of the base steel sheet of the non-oriented electrical steel sheet described above.

For the final non-oriented electrical steel sheet, in order that the average grain size is controlled to be fine in the surface region which ranges from the surface of the base steel sheet to 1/20 of the thickness, the Sn content is preferably less than 0.030%. In order to preferably nitride the sheet surface in the nitriding annealing process which is the post process, it is preferable that Sn is not segregated in the surface layer of the steel sheet or the Sn content itself is low.

The casting method is not particularly limited. For instance, the slab may be made by a continuous casting method. Alternatively, an ingot may be made by using the molten steel, and then, the slab may be made by blooming the ingot. Moreover, the slab may be made by other methods.

The thickness of the slab is not particularly limited, but may be, for instance, 150 mm or more and 350 mm or less. The thickness of the slab is preferably 220 mm or more and 280 mm or less. As the slab, a so-called thin slab having a thickness of 10 mm or more and 70 mm or less may be used.

In order to preferably control the {100} reflected intensity and the area fraction of {100} oriented grains at the position of ½ of the thickness in the base steel sheet of the final non-oriented electrical steel sheet, it is preferable that a thin slab continuous casting method is employed, the thickness of the slab is 30 mm or more and 60 mm or less, a columnar grain whose {100} is parallel to the steel sheet surface is sufficiently developed in the thin slab, and {100} <011> orientation which is obtained by deforming the columnar grain in hot rolling remains in the hot-rolled steel sheet. For the purpose, it is preferable that electromagnetic stirring is not performed in the continuous casting. In addition, it is preferable that fine inclusions in the molten steel, which promote nucleation for solidification, are reduced as much as possible.

The fine inclusions in the molten steel may be reduced, for instance, by reducing the amount of elements forming the fine inclusions, for instance, Ti. The fine inclusions in the molten steel may be measured, for instance, by quenching a sample obtained from the molten steel to obtain a steel ingot, and subjecting the steel ingot to electrolytic extraction to analyze the residue.

### [Hot Rolling Process]

In the hot rolling process, the slab may be hot-rolled to obtain a hot-rolled steel sheet. The conditions for hot rolling are not particularly limited. For instance, the thickness (final thickness) of the hot-rolled steel sheet is preferably 1.0 mm or more and 2.5 mm or less. When the thickness is 1.0 mm or more, applied load to the hot rolling mill is low, and high productivity is achieved in the hot rolling process.

The reheating temperature of the slab before hot rolling is not particularly limited, but may be 1000° C. or more and 1300° C. or less from the viewpoint of cost and the like. In the final hot rolling after the rough rolling, the final rolling temperature in the final hot rolling is preferably 900° C. or higher, and more preferably 950° C. or higher.

### [Cold Rolling Process]

In the cold rolling process, the steel sheet may be cold-rolled to obtain a cold-rolled steel sheet. In the cold rolling process, the thickness (final thickness) of the cold-rolled steel sheet may be 0.10 mm or more and 0.35 mm or less. The steel sheet to be cold-rolled may be any of the steel sheet after the hot rolling process, the steel sheet after the hot-band annealing process, the steel sheet after the pickling process, and the steel sheet after the surface treatment process.

Other conditions of the cold rolling are not particularly limited. For instance, the cumulative rolling reduction is preferably 60 to 95% in the cold rolling. When the rolling reduction is 60% or more, the effect of P on the texture of the non-oriented electrical steel sheet can be more stably obtained. When the rolling reduction is 95% or less, the non-oriented electrical steel sheet can be industrially stably manufactured.

The steel sheet temperature may be room temperature during the cold rolling.

The cold rolling may be warm rolling in which the steel sheet temperature is 100 to 200° C. The steel sheet may be preheated or the roll may be preheated in order to heat the steel sheet to a temperature of 100 to 200° C.

### [Final Annealing Process]

In the final annealing process, the steel sheet may be subjected to an oxidation stage, a heating stage, a holding stage, and a cooling stage. In the final annealing process, it is preferable to perform a pretreatment for preferably nitriding the sheet surface in the nitriding annealing process which is the post process. The steel sheet to be subjected to the final annealing may be any of the steel sheet after the cold rolling process and the steel sheet after the surface treatment process.

### [Oxidation Stage]

In the oxidation stage in the final annealing process, the steel sheet after the cold rolling process or after the surface treatment process may be held in an atmosphere of 5 vol % or more and 15 vol % or less of hydrogen and a dew point of 40° C. or more and 60° C. or less in a temperature range of 170° C. or more and 190° C. or less for 90 seconds or more and 110 seconds or less.

In the atmosphere in the oxidation stage, hydrogen is preferably 7 vol % or more, and more preferably 9 vol % or more. The hydrogen is preferably 13 vol % or less, and more preferably 11 vol % or less. In the atmosphere in the oxidation stage, the dew point is preferably 42° C. or higher, and more preferably 44° C. or higher. The dew point is preferably 58° C. or lower, and more preferably 56° C. or lower. In addition, the temperature range for holding in the oxidation stage is preferably 173° C. or higher, and more preferably 175° C. or higher. The temperature range is preferably 188° C. or lower, and more preferably 185° C. or lower. In the oxidation stage, the time for holding in the above temperature range is preferably 93 seconds or more, and more preferably 95 seconds or more. The time is preferably 108 seconds or less, and more preferably 105 seconds or less.

In the oxidation stage, fayalite (Fe₂SiO₄) is preferably formed in the surface layer of the steel sheet in a wet atmosphere. Conventionally, nitriding annealing is hardly performed as a post process following the final annealing. In addition, it has not been known that oxides are purposely formed in the surface layer of the steel sheet in the final annealing in order for the nitriding annealing which is the post process following the final annealing. In general, it has been considered that nitriding is inhibited in the post process when the oxides are formed in the surface layer of the steel sheet. The present inventors have found that nitriding is preferably performed in the post process when the fayalite is formed in the surface layer of the steel sheet in the oxidation stage in the final annealing process. It is considered that the fayalite acts as a catalyst and promotes nitriding in the post process.

### [Heating Stage]

In the heating stage in the final annealing process, the steel sheet after the oxidation stage may be heated in an atmosphere of 5 vol % or more and 15 vol % or less of hydrogen and a dew point of 40° C. or more and 60° C. or less at an average heating rate of 40° C./sec or more and 60° C./sec or less to a temperature range of 680° C. or more and 720° C. or less. Thereafter, the steel sheet may be heated in an atmosphere of 5 vol % or more and 25 vol % or less of hydrogen and a dew point of −20° C. or more and 20° C. or less at an average heating rate of 40° C./sec or more and 60° C./sec or less to a temperature range of 780° C. or more and 1050° C. or less.

In the atmosphere in the first half of the heating stage, hydrogen is preferably 7 vol % or more, and more preferably 9 vol % or more. The hydrogen is preferably 13 vol % or less, and more preferably 11 vol % or less. In the atmosphere in the first half of the heating stage, the dew point is preferably 42° C. or higher, and more preferably 44° C. or higher. The dew point is preferably 58° C. or lower, and more preferably 56° C. or lower. In the first half of the heating stage, the average heating rate is preferably 43° C./sec or more, and more preferably 45° C./sec or more. The average heating rate is preferably 58° C./sec or less, and more preferably 55° C./sec or less. The average heating rate indicates a value obtained when the temperature rise from the start temperature to the heating temperature is divided by the time from the start temperature to the heating temperature. In addition, the temperature range in the first half of the heating stage is preferably 685° C. or higher, and more preferably 690° C. or higher. The temperature range is preferably 715° C. or lower, and more preferably 710° C. or lower.

In the atmosphere in the second half of the heating stage, hydrogen is preferably 7 vol % or more, and more preferably 9 vol % or more. The hydrogen is preferably 23 vol % or less, and more preferably 21 vol % or less. In the atmosphere in the second half of the heating stage, the dew point is preferably −18° C. or higher, and more preferably −16° C. or higher. The dew point is preferably 18° C. or lower, and more preferably 16° C. or lower. In the second half of the heating stage, the average heating rate is preferably 43° C./sec or more, and more preferably 45° C./sec or more. The average heating rate is preferably 58° C./sec or less, and more preferably 55° C./sec or less. The average heating rate indicates a value obtained when the temperature rise from the start temperature to the heating temperature is divided by the time from the start temperature to the heating temperature. In addition, the temperature range in the second half of the heating stage is preferably 785° C. or higher, and more preferably 790° C. or higher. The temperature range is preferably 1040° C. or lower, and more preferably 1030° C. or lower.

### [Holding Stage]

In the holding stage in the final annealing process, the steel sheet after the heating stage may be subjected to holding in an atmosphere of 5 vol % or more and 25 vol % or less of hydrogen and a dew point of −20° C. or more and 20° C. or less in a temperature range of 780° C. or more and 1050° C. or less for 10 seconds or more and 20 seconds or less.

In the atmosphere in the holding stage, hydrogen is preferably 7 vol % or more, and more preferably 9 vol % or more. The hydrogen is preferably 23 vol % or less, and more preferably 21 vol % or less. In the atmosphere in the holding stage, the dew point is preferably −18° C. or higher, and more preferably −16° C. or higher. The dew point is preferably 18° C. or lower, and more preferably 16° C. or lower. In addition, the temperature range held in the holding stage is preferably 785° C. or higher, and more preferably 790° C. or higher. The temperature range is preferably 1040° C. or lower, and more preferably 1030° C. or lower. In the holding stage, the time for holding in the above temperature range is preferably 12 seconds or more, and more preferably 14 seconds or more. The time is preferably 18 seconds or less, and more preferably 16 seconds or less.

### [Cooling Stage]

In the cooling stage in the final annealing process, the steel sheet after the holding stage may be cooled to a temperature range of room temperature or more and 720° C. or less.

The temperature range in the cooling stage is preferably 100° C. or higher, and more preferably 150° C. or higher. The temperature range is preferably 700 or lower, and more preferably 650° C. or lower. The average cooling rate in the cooling stage is not particularly limited. However, the average cooling rate is preferably 5° C./sec or more, and more preferably 7° C./sec or more. The average cooling rate is preferably 20° C./sec or less, and more preferably 15° C./sec or less. The average cooling rate indicates a value obtained when the temperature from the holding temperature to the cooling completion is divided by the cooling time from the holding temperature to the controlled cooling temperature.

### [Nitriding Annealing Process]

In the nitriding annealing process, the steel sheet after the final annealing process may be held in an atmosphere of 95 vol % or more and 100 vol % or less of nitrogen and a dew point of −50° C. or more and 0° C. or less in a temperature range of 680° C. or more and 720° C. or less for 70 seconds or more and 90 seconds or less.

In the atmosphere in the nitriding annealing process, the nitrogen is preferably 96 vol % or more, and more preferably 97 vol % or more. The nitrogen is preferably 99 vol % or less, and more preferably 98 vol % or less. In the atmosphere in the nitriding annealing process, the dew point is preferably −45° C. or higher, and more preferably −40° C. or higher. The dew point is preferably −5° C. or lower, and more preferably −10° C. or lower. In addition, the temperature range held in the nitriding annealing process is preferably 685° C. or higher, and more preferably 690° C. or higher. The temperature range is preferably 715° C. or lower, and more preferably 710° C. or lower. In the nitriding annealing process, the time for holding in the above temperature range is preferably 73 seconds or more, and more preferably 75 seconds or more. The time is preferably 88 seconds or less, and more preferably 85 seconds or less.

Through the nitriding annealing, nitrides (for instance, AlN) are formed in the surface layer of the steel sheet. With the nitrides, in the final non-oriented electrical steel sheet, the average grain size is controlled to be fine in the surface region which ranges from the surface of the base steel sheet to 1/20 of the thickness. Conventionally, when a non-oriented electrical steel sheet is manufactured, unlike the embodiment, it is not typical to purposely form the nitrides in the surface layer of the steel sheet. In general, it has been considered that the nitrides formed in the surface layer of the steel sheet adversely affect the magnetic characteristics of the non-oriented electrical steel sheet. The present inventors have found that, when nitriding annealing is performed after the final annealing, the average grain size is controlled to be fine in the surface region of the base steel sheet of the final non-oriented electrical steel sheet, and thereby, the iron loss in a case that the skin effect which is remarkable at the high frequencies is effective, mainly the eddy-current loss, is reduced.

### [Coating Formation Process]

In the coating formation process, the steel sheet after the nitriding annealing process may be subjected to a coating formation stage, and as necessary, is subjected to an annealing stage.

### [Coating Formation Stage]

The coating formation conditions in the coating formation stage are not particularly limited, and may be known conditions. For instance, an insulating coating made of only an organic component, only an inorganic component, or an organic-inorganic composite may be applied to the sheet surface to form a coating. From the viewpoint of reducing the environmental load, a chromium-free insulating coating may be formed. In addition, the coating formation process may be a process of applying an insulating coating that is adhesiveness by heating and pressurizing. As coating material exhibiting adhesiveness, an acrylic resin, a phenol resin, an epoxy resin, a melamine resin, or the like can be used.

### [Annealing Stage]

In the annealing stage, the steel sheet may be held in a temperature range of 750° C. or more and 850° C. or less for 30 minutes or more and 150 minutes or less. The steel sheet to be subjected to the annealing stage may be either the steel sheet after the coating formation stage or the steel sheet that has been punched after the coating formation stage and has a shape for making an iron core.

The temperature range held in the annealing stage is preferably 760° C. or higher, and more preferably 770° C. or higher. The temperature range is preferably 840° C. or lower, and more preferably 830° C. or lower. In the annealing stage, the time for holding in the above temperature range is preferably 45 minutes or more, and more preferably 60 minutes or more. The time is preferably 135 minutes or less, and more preferably 120 minutes or less.

Through the annealing stage, the strain remaining in the steel is relieved, the steel is recrystallized, and the grain grows to the preferred grain size. At the time, in the surface region of the base steel sheet, the average grain size is controlled to be fine by the nitrides. The non-oriented electrical steel sheet manufactured by being subjected to the annealing stage in the coating formation process has the features of the non-oriented electrical steel sheet described above.

The atmosphere in the annealing stage is not particularly limited. For instance, the atmosphere in the annealing stage may be a nitrogen atmosphere, a hydrogen atmosphere, or a mixed atmosphere of nitrogen and hydrogen. In the atmosphere in the annealing stage, the dew point is preferably −50° C. or higher, and more preferably −40° C. or higher. The dew point is preferably 0° C. or lower, and more preferably −10° C. or lower.

### [Hot-Band Annealing Process]

The manufacturing method for the non-oriented electrical steel sheet according to the embodiment may include a hot-band annealing process after the hot rolling process. Through the hot-band annealing, preferable magnetic characteristics are obtained. The hot-band annealing may be a heat conservation treatment where the hot-rolled steel sheet is heat-conservation-treated during cooling after the hot rolling.

The conditions in the hot-band annealing are not particularly limited, and may be known conditions. For instance, when box annealing is performed, it is preferable to hold in a temperature range of 700° C. or more and 900° C. or less for 60 minutes or more and 20 hours or less. When continuous annealing is performed, it is preferable to hold in a temperature range of 900° C. or more and 1100° C. or less for 1 second or more and 180 seconds or less.

### [Pickling Process]

The manufacturing method for the non-oriented electrical steel sheet according to the embodiment may include a pickling process after the hot rolling process or after the hot-band annealing process. The scale formed on the surface of the steel sheet is removed by pickling. The conditions in the pickling are not particularly limited, and may be known conditions.

### [Surface Treatment Process]

The manufacturing method for the non-oriented electrical steel sheet according to the embodiment may include a surface treatment process after the hot rolling process, after the hot-band annealing process, after the pickling process, after the cold rolling process, after the final annealing process, or after the nitriding annealing process.

In the surface treatment process, Al—Si based plating, Al—Mn based plating, Al—Si—Mn based plating, and the like may be applied to the surface of the steel sheet. These plating alloys are diffused into the steel sheet by the final annealing, nitriding annealing, or the coating formation annealing. Thereby, the R value is preferably controlled in the region which ranges from the surface of the base steel sheet to 1/10 of the thickness and in the region which ranges from 1/10 of the thickness to ½ of the thickness in the final non-oriented electrical steel sheet.

In the plating arranged on the surface of the steel sheet, Al is included in an amount of preferably 90 mass % or more, and more preferably 95 mass % or more. Al is preferably 100 mass % or less, and more preferably 99 mass % or less. In the plating arranged on the surface of the steel sheet, Si is included in an amount of preferably 0.1 mass % or more, and more preferably 0.3 mass % or more. Si is preferably 10 mass % or less, and more preferably 7 mass % or less. In the plating arranged on the surface of the steel sheet, Mn is included in an amount of preferably 0.01 mass % or more, and more preferably 0.1 mass % or more. Mn is preferably 5 mass % or less, and more preferably 3 mass % or less.

The thickness of the plating arranged on the surface of the steel sheet is preferably 5 μm or more, and more preferably 7 μm or more. The thickness is preferably 30 μm or less, and more preferably 25 μm or less. When plating is performed before the cold rolling, the thickness of the plating is reduced to approximately ⅕ in the cold rolling. Therefore, it is preferable to control the thickness in consideration of the thickness reduction caused by the cold rolling. For instance, the thickness is preferably 25 μm or more and 35 μm or less within the above numerical range.

The method for arranging the plating on the surface of the steel sheet is not particularly limited. For instance, hot-dip plating, electro plating, molten salt electrolysis, physical vapor deposition (PVD), or chemical vapor deposition (CVD) may be employed. Among them, hot-dip plating is preferable in consideration of being the material for the motor, processing cost, and the like.

### [Iron Core]

The iron core according to the embodiment may include the non-oriented electrical steel sheet described above. Specifically, the iron core may be the lamination in which the non-oriented electrical steel sheets having the above-described features and having a shape for making the iron core are laminated and unified. The iron core according to the embodiment is an integrally punched iron core or a segmented iron core.

### [Manufacturing Method for Iron Core]

The manufacturing method for the iron core according to the embodiment may include a process of laminating the non-oriented electrical steel sheet described above.

Specifically, the manufacturing method for the iron core may include a laminating process in which the non-oriented electrical steel sheets having the above-described features and having a shape for making the iron core are laminated and unified. The number of the laminated non-oriented electrical steel sheets and the laminating conditions may be adjusted according to the purpose.

When the steel sheet provided to the manufacturing method for the iron core according to the embodiment does not have a shape for making the iron core, a punching process of punching the steel sheet to obtain a punched piece may be included before the laminating process. The punching shape of the steel sheet and punching conditions may be adjusted according to the purpose.

In addition, the manufacturing method for the iron core according to the embodiment may include a stress relieving annealing process after the punching process or after the laminating process.

When the stress relieving annealing process is performed in the manufacturing method for the iron core according to the embodiment, the manufacturing method for the non-oriented electrical steel sheet may omit the annealing stage in the coating formation process. For instance, the steel sheet after the nitriding annealing process described above is subjected to the coating formation stage in the coating formation process and is not subjected to the annealing stage in the coating formation process, the steel sheet after the coating formation stage is subjected to the punching process, and the punched piece is subjected to the laminating process. Then, after the punching process or after the laminating process, the stress relieving annealing process is performed.

Through the stress relieving annealing process, the strain remaining in the steel is relieved, the steel is recrystallized, and the grain grows to the preferred grain size. At the time, in the surface region of the base steel sheet of the punched piece, the average grain size is controlled to be fine by the nitride. In other words, the punched piece after the stress relieving annealing process (or the punched piece included in the lamination after the stress relieving annealing process) has the features of the non-oriented electrical steel sheet described above. Therefore, it is possible to confirm whether or not the non-oriented electrical steel sheet taken out by disassembling the iron core has the features of the non-oriented electrical steel sheet described above.

In the stress relieving annealing process, the punched piece or the lamination may be held in a temperature range of 750° C. or more and 850° C. or less for 30 minutes or more and 150 minutes or less. The atmosphere in the stress relieving annealing process is not particularly limited. For instance, the atmosphere in the stress relieving annealing process may be a nitrogen atmosphere, a hydrogen atmosphere, or a mixed atmosphere of nitrogen and hydrogen. The dew point of the atmosphere in the stress relieving annealing process may be −50 to 0° C.

### [Motor]

The motor according to the embodiment may include the above-described iron core. Although, a motor mainly includes a stator, a rotor, a bearing, a bracket, and a lead wire, the motor according to the embodiment may include the above-described iron core as the iron core of the stator or the rotor. The motor according to the embodiment is preferably a driving motor of hybrid driving vehicles or electric vehicles, and is preferably a PM motor such as an IPM motor or an SPM motor, for instance.

### [Manufacturing Method for Motor]

The manufacturing method for the motor according to the embodiment may include: a process of laminating the non-oriented electrical steel sheet described above to obtain an iron core; and a process of assembling the iron core into a motor. Specifically, the manufacturing method for the motor may include: a laminating process of laminating the non-oriented electrical steel sheets having the above-described features and having a shape for making the iron core to obtain the iron core; and an assembling process of assembling the iron core as a stator iron core or a rotor iron core into the motor. The number of the laminated non-oriented electrical steel sheets and the laminating conditions and the assembling conditions of the iron core may be adjusted according to the purpose.

Similarly to the manufacturing method for the iron core described above, when the steel sheet provided to the manufacturing method for the motor according to the embodiment does not have a shape for making the iron core, a punching process of punching the steel sheet to obtain a punched piece may be included before the laminating process. The punching shape of the steel sheet and punching conditions may be adjusted according to the purpose.

Similarly to the manufacturing method for the iron core described above, the manufacturing method for the motor according to the embodiment may include a stress relieving annealing process after the punching process or after the laminating process. When the stress relieving annealing process is performed, the manufacturing method for the non-oriented electrical steel sheet may omit the annealing stage in the coating formation process. As described above, the material after the stress relieving annealing process has the features of the non-oriented electrical steel sheet described above. Therefore, it is possible to confirm whether or not the non-oriented electrical steel sheet taken out by disassembling the motor has the features of the non-oriented electrical steel sheet described above. The stress relieving annealing conditions in the manufacturing method for the motor according to the embodiment may be the same as the stress relieving annealing conditions in the manufacturing method for the iron core.

### EXAMPLES

The effects of an aspect of the present invention are described in detail with reference to the following examples. However, the condition in the examples is an example condition employed to confirm the operability and the effects of the present invention, so that the present invention is not limited to the example condition. The present invention can employ various types of conditions as long as the conditions do not depart from the scope of the present invention and can achieve the object of the present invention. Hereinafter, the present invention is explained in detail with reference to examples and comparative examples.

Using a slab with an adjusted chemical composition, each process was performed under the conditions shown in Tables 7 to 42 to manufacture a non-oriented electrical steel sheet. When all of them were manufactured, a slab was manufactured by a continuous casting method, and pickling was performed after the hot-band annealing. In addition, as necessary, hot-dip plating was performed as a surface treatment on the steel sheet after cold rolling.

Except for Test No. 136 shown in the table, the final annealing process was performed, and then the nitriding annealing process was performed. On the other hand, for Test No. 136, the nitriding annealing process was performed, and then the final annealing process was performed. In the nitriding annealing in Test No. 136, the nitrogen in the atmosphere was 100%, the dew point of the atmosphere was −25° C., the annealing temperature was 770° C., and the annealing time was 80 seconds.

In addition, except for Test No. 137 shown in the table, in the coating formation process, the coating formation stage was performed, and then the annealing stage was performed. On the other hand, in Test No. 137, in the coating formation process, the coating formation stage was performed, then punching and the like were performed to provide a shape for making the iron core, and then the stress relieving annealing was performed at 800° C. for 60 minutes as the annealing stage.

In the tables, “Electromagnetic stirring” indicates whether or not electromagnetic stirring was performed during the continuous casting. The “Fine inclusions” indicates whether or not fine inclusions in the molten steel, which promote nucleation for solidification, were included. The “Cooling temperature” indicates the controlled cooling temperature when the steel sheet was cooled after the holding stage. The “Coating type” indicates the type of the insulating coating formed on the steel sheet after the nitriding annealing process.

For the manufactured non-oriented electrical steel sheet, the chemical composition, the thickness, the average grain size, the R value, and the reflected intensity and area fraction of {100} oriented grains were measured. These measurement methods are as described above. The measurement results are shown in Tables 1 to 51. The average grain size and the R value were equivalent on both sheet surfaces of the base steel sheet. The thickness of the base steel sheet was equal to the final thickness of the steel sheet after the cold rolling process. In addition, in the manufactured non-oriented electrical steel sheet, the chemical composition of the base steel sheet is equivalent to the chemical composition of the slab, except for Al, Si, and Mn. In the tables, the element represented by “-” indicates that the element was not intentionally controlled or manufactured.

For the manufactured non-oriented electrical steel sheet, the magnetic flux density, the magnetic permeability, and the iron loss characteristics were evaluated.

The magnetic flux density, magnetic permeability, and iron loss characteristics were evaluated on the basis of Single Sheet Tester (SST) method regulated by JIS C2556:2015. Instead of taking a test piece with size regulated by JIS, a test piece having a smaller size, for instance, a test piece having a width of 55 mm×a length of 55 mm, may be taken and measured in accordance with Single Sheet Tester. In a case where the test piece having a width of 55 mm×a length of 55 mm was hardly taken, the measurement based on the single sheet tester may be performed using two test pieces of a width of 8 mm×a length of 16 mm as a test piece of a width of 16 mm×a length of 16 mm. At that time, an Epstein equivalent value which was converted so as to correspond to a measurement value with an Epstein tester regulated in JIS C 2550:2011 may be used.

As the magnetic flux density in the high magnetic field, a magnetic flux density B₅₀ in the rolling direction was measured in terms of T (Tesla) when the steel sheet was magnetized at a magnetizing force of 5000 A/m. The case where the magnetic flux density B₅₀ is 1.60 T or more was determined as acceptable. The case where the magnetic flux density B₅₀ is more than 1.63 T was determined as preferably excellent in the magnetic flux density in the high magnetic field.

As the high-frequency iron loss characteristics, the iron loss W_{10/1k} in the rolling direction was measured in terms of W/kg when the steel sheet was magnetized at 1 kHz to a magnetic flux density of 1.0 T. The case where the iron loss W_{10/1k} is 36 W/kg or less was determined as acceptable. The case where the iron loss W_{10/1k} is less than 35 W/kg was determined as preferably excellent in high-frequency iron loss characteristics.

As the magnetic permeability, the magnetic permeability in the rolling direction was measured in terms of H/m when the steel sheet was magnetized to 1.0 T under a DC magnetic field. The case where the magnetic permeability is 0.007 H/m or more was determined as acceptable. The case where the magnetic permeability is 0.010 H/m or more was determined as preferably excellent in magnetic permeability, and the case where the magnetic permeability is 0.013 H/m or more was determined as more preferably excellent in magnetic permeability.

As the commercial frequency iron loss, the iron loss W_{15/50} in the rolling direction was measured in terms of W/kg when the steel sheet was magnetized at 50 Hz to a magnetic flux density of 1.5 T. The case where the iron loss W_{15/50} is 2.22 W/kg or less was determined as acceptable. The case where the iron loss W_{15/50} is 2.20 W/kg or less was determined as preferably excellent in commercial frequency iron loss, and the case where the iron loss W_{15/50} is less than 2.10 W/kg was determined as more preferably excellent in commercial frequency iron loss.

As shown in Tables 1 to 51, among Test No. 1 to 214, all of Inventive Examples were preferably controlled in chemical composition, thickness, and average grain size as the non-oriented electrical steel sheet, and excellent in high-frequency iron loss. Although not shown in the tables, in Inventive Examples, the average grain size in the intermediate region was equivalent to the average grain size in the region which ranges from 1/20 of the thickness to 1/10 of the thickness.

On the other hand, among Test No. 1 to 214, Comparative Examples were not preferably controlled in at least one of chemical composition, thickness, and average grain size. The non-oriented electrical steel sheet of Test No. 124 did not have the insulating coating. Therefore, it was clear that the magnetic characteristics be deteriorated when the non-oriented electrical steel sheets were laminated. Accordingly, the magnetic flux density and the iron loss characteristics were not evaluated.

Next, the manufactured non-oriented electrical steel sheet was punched as necessary, and the punched pieces were laminated to manufacture an iron core. The manufactured iron core included the non-oriented electrical steel sheet. In addition, the manufactured iron core was subjected to stress relieving annealing as necessary, and the iron core was manufactured as a stator iron core or a rotor iron core to assemble a motor. The manufactured motor included the iron core. In the stress relieving annealing, the iron core was held in a temperature range of 750° C. or more and 850° C. or less for 30 minutes or more and 150 minutes or less.

The manufactured motor was connected to a load motor via a torque sensor (TM 308, which is manufactured by MAGTROL). The manufactured motor was driven by supplying three-phase alternating current from an inverter. The current and voltage supplied from the inverter were measured with a power meter (model WT1804E, which is manufactured by Yokogawa Electric Corporation) and used as the input. From the torque T (unit: N-m) and the rotation speed N (rpm) measured by the torque sensor, the output was defined as 2πTN/60=output (W). The efficiency (%) was determined by output/input×100.

The manufactured iron core and the manufactured motor were excellent in torque characteristics and energy efficiency when the non-oriented electrical steel sheet of Inventive Example was used among Test No. 1 to 214. On the other hand, the manufactured iron core and the manufactured motor were not excellent in torque characteristics or energy efficiency when the non-oriented electrical steel sheet of Comparative Examples was used among Test No. 1 to 214 as compared with those of the non-oriented electrical steel sheet of Inventive Example.

In the non-oriented electrical steel sheet of Test No. 125, the annealing temperature was 700° C. in the annealing stage in the coating formation process, and therefore the average grain size was not preferably controlled in the intermediate region and the central region of the base steel sheet. However, in the motor manufactured using the non-oriented electrical steel sheet of Test No. 125, the average grain size was preferably controlled in the intermediate region and the central region by the stress relieving annealing, and accordingly, the torque characteristics and the energy efficiency of the motor were equivalent to the motor manufactured using the non-oriented electrical steel sheet of Test No. 9.

In addition, in the non-oriented electrical steel sheet taken out by disassembling the iron core and the motor manufactured using the non-oriented electrical steel sheet of Examples among Test No. 1 to 214, the chemical composition, the thickness, and the average grain size were preferably controlled similarly to the above results.

TABLE 1

| | MANUFACTURING RESULTS | | | | | | | | | | | | | |
|---|---|---|---|---|---|---|---|---|---|---|---|---|---|---|
| STEEL | CHEMICAL COMPOSITION OF BASE STEEL SHEET (UNIT: mass %, BALANCE: Fe AND IMPURITIES) | | | | | | | | | | | | | |
| TYPE | Si | C | Mn | P | S | Al | Zn | N | Sn | Sb | Ca | Cr | Ni | Cu |
| S1 | 1.8 | 0.002 | 0.2 | 0.01 | 0.002 | 2.3 | — | 0.002 | — | — | — | — | — | — |
| S2 | 1.6 | 0.002 | 1.9 | 0.01 | 0.002 | 1.6 | — | 0.002 | — | — | — | — | — | — |
| S3 | 3.0 | 0.002 | 0.2 | 0.01 | 0.001 | 1.1 | — | 0.002 | — | — | — | — | — | — |
| S4 | 2.1 | 0.002 | 0.2 | 0.08 | 0.002 | 0.9 | — | 0.002 | — | — | — | — | — | — |
| S5 | 2.3 | 0.002 | 1.1 | 0.01 | 0.002 | 1.7 | — | 0.002 | 0.025 | — | — | — | — | — |
| S6 | 2.3 | 0.002 | 1.1 | 0.01 | 0.002 | 1.7 | 0.01 | 0.002 | 0.025 | — | 0.003 | — | — | — |
| S7 | 2.3 | 0.002 | 1.1 | 0.01 | 0.002 | 1.7 | — | 0.002 | — | 0.025 | — | — | — | — |
| S8 | 2.3 | 0.002 | 1.1 | 0.01 | 0.002 | 1.7 | — | 0.002 | — | 0.025 | 0.003 | — | — | — |
| S9 | 3.0 | 0.002 | 0.3 | 0.01 | 0.001 | 0.6 | — | 0.002 | — | — | — | — | — | — |
| S10 | 0.9 | 0.002 | 0.2 | 0.01 | 0.001 | 2.4 | — | 0.002 | — | — | — | — | — | — |
| S11 | 1.1 | 0.002 | 0.2 | 0.01 | 0.001 | 2.3 | — | 0.002 | — | — | — | — | — | — |
| S12 | 3.1 | 0.002 | 0.2 | 0.01 | 0.001 | 0.1 | — | 0.002 | — | — | — | — | — | — |
| S13 | 3.3 | 0.002 | 0.2 | 0.01 | 0.001 | 0.1 | — | 0.002 | — | — | — | — | — | — |
| S14 | 3.5 | 0.002 | 0.2 | 0.01 | 0.001 | 0.1 | — | 0.002 | — | — | — | — | — | — |
| S15 | 3.7 | 0.002 | 0.2 | 0.01 | 0.001 | 0.1 | — | 0.002 | — | — | — | — | — | — |
| S16 | 5.1 | 0.002 | 0.2 | 0.01 | 0.001 | 0.4 | — | 0.002 | — | — | — | — | — | — |
| S17 | 1.4 | 0.002 | 0.2 | 0.01 | 0.001 | 2.5 | — | 0.002 | — | — | — | — | — | — |
| S18 | 1.6 | 0.002 | 0.2 | 0.01 | 0.001 | 2.3 | — | 0.002 | — | — | — | — | — | — |
| S19 | 3.0 | 0.006 | 0.3 | 0.01 | 0.001 | 0.6 | — | 0.002 | — | — | — | — | — | — |
| S20 | 3.0 | 0.002 | 3.1 | 0.01 | 0.001 | 0.6 | — | 0.002 | — | — | — | — | — | — |
| S21 | 3.0 | 0.002 | 0.3 | 0.33 | 0.001 | 0.6 | — | 0.002 | — | — | — | — | — | — |
| S22 | 3.0 | 0.002 | 0.3 | 0.01 | 0.012 | 0.6 | — | 0.002 | — | — | — | — | — | — |
| S23 | 3.0 | 0.002 | 0.3 | 0.01 | 0.001 | 0.6 | — | 0.013 | — | — | — | — | — | — |
| S24 | 3.0 | 0.002 | 0.3 | 0.01 | 0.001 | 0.6 | — | 0.002 | — | — | — | — | — | — |
| S25 | 3.0 | 0.002 | 0.3 | 0.01 | 0.001 | 0.6 | — | 0.002 | — | — | — | — | — | — |

TABLE 2

| | MANUFACTURING RESULTS | | | | | | | | | | | | | |
|---|---|---|---|---|---|---|---|---|---|---|---|---|---|---|
| STEEL | CHEMICAL COMPOSITION OF BASE STEEL SHEET (UNIT: mass %, BALANCE: Fe AND IMPURITIES) | | | | | | | | | | | | | |
| TYPE | Si | C | Mn | P | S | Al | Zn | N | Sn | Sb | Ca | Cr | Ni | Cu |
| S26 | 3.0 | 0.002 | 0.3 | 0.01 | 0.001 | 0.6 | — | 0.002 | — | — | 0.0006 | — | — | — |
| S27 | 3.0 | 0.002 | 0.3 | 0.01 | 0.001 | 0.6 | — | 0.002 | — | — | 0.0010 | — | — | — |
| S28 | 3.0 | 0.002 | 0.3 | 0.01 | 0.001 | 0.6 | — | 0.002 | — | — | 0.008 | — | — | — |
| S29 | 3.0 | 0.002 | 0.3 | 0.01 | 0.001 | 0.6 | — | 0.002 | — | — | 0.014 | — | — | — |
| S30 | 3.0 | 0.002 | 0.3 | 0.01 | 0.001 | 0.6 | — | 0.002 | — | — | — | — | — | — |
| S31 | 3.0 | 0.002 | 0.3 | 0.01 | 0.001 | 0.6 | — | 0.002 | — | — | — | — | — | — |
| S32 | 3.0 | 0.002 | 0.3 | 0.01 | 0.001 | 0.6 | — | 0.002 | — | — | — | 5.5 | — | — |
| S33 | 3.0 | 0.002 | 0.3 | 0.01 | 0.001 | 0.6 | — | 0.002 | — | — | — | — | 5.1 | — |
| S34 | 3.0 | 0.002 | 0.3 | 0.01 | 0.001 | 0.6 | — | 0.002 | — | — | — | — | — | 5.3 |
| S35 | 3.0 | 0.002 | 0.3 | 0.01 | 0.001 | 0.6 | — | 0.002 | — | — | — | — | — | — |
| S36 | 3.0 | 0.002 | 0.3 | 0.01 | 0.001 | 0.6 | — | 0.002 | 0.030 | — | — | — | — | — |
| S37 | 3.0 | 0.002 | 0.3 | 0.01 | 0.001 | 0.6 | — | 0.002 | 0.080 | — | — | — | — | — |
| S38 | 3.0 | 0.002 | 0.3 | 0.01 | 0.001 | 0.6 | — | 0.002 | 0.120 | — | — | — | — | — |
| S39 | 3.0 | 0.002 | 0.3 | 0.01 | 0.001 | 0.6 | — | 0.002 | — | 0.030 | — | — | — | — |
| S40 | 3.0 | 0.002 | 0.3 | 0.01 | 0.001 | 0.6 | — | 0.002 | — | 0.070 | — | — | — | — |
| S41 | 3.0 | 0.002 | 0.3 | 0.01 | 0.001 | 0.6 | — | 0.002 | — | 0.110 | — | — | — | — |
| S42 | 3.0 | 0.002 | 0.3 | 0.01 | 0.001 | 0.6 | — | 0.002 | — | — | — | — | — | — |
| S43 | 3.0 | 0.002 | 0.3 | 0.01 | 0.001 | 0.6 | — | 0.002 | — | — | — | — | — | — |
| S44 | 3.0 | 0.002 | 0.3 | 0.01 | 0.001 | 0.6 | — | 0.002 | — | — | — | — | — | — |
| S45 | 3.0 | 0.002 | 0.3 | 0.01 | 0.001 | 0.6 | — | 0.002 | — | — | — | — | — | — |
| S46 | 3.0 | 0.002 | 0.3 | 0.01 | 0.001 | 0.6 | — | 0.002 | — | — | — | — | — | — |
| S47 | 3.0 | 0.002 | 0.3 | 0.01 | 0.001 | 0.6 | — | 0.002 | — | — | — | — | — | — |
| S48 | 3.0 | 0.002 | 0.3 | 0.01 | 0.001 | 0.6 | — | 0.002 | — | — | — | — | — | — |
| S49 | 3.0 | 0.002 | 0.3 | 0.01 | 0.001 | 0.6 | — | 0.002 | — | — | — | — | — | — |
| S50 | 3.0 | 0.002 | 0.3 | 0.01 | 0.001 | 0.6 | — | 0.002 | — | — | — | — | — | — |

TABLE 3

| | MANUFACTURING RESULTS | | | | | | | | | | | | | |
|---|---|---|---|---|---|---|---|---|---|---|---|---|---|---|
| STEEL | CHEMICAL COMPOSITION OF BASE STEEL SHEET (UNIT: mass %, BALANCE: Fe AND IMPURITIES) | | | | | | | | | | | | | |
| TYPE | Si | C | Mn | P | S | Al | Zn | N | Sn | Sb | Ca | Cr | Ni | Cu |
| S51 | 3.0 | 0.002 | 0.3 | 0.01 | 0.001 | 0.6 | — | 0.002 | — | — | — | — | — | — |
| S52 | 3.0 | 0.002 | 0.3 | 0.01 | 0.001 | 0.6 | — | 0.002 | — | — | — | — | — | — |
| S53 | 3.0 | 0.002 | 0.3 | 0.01 | 0.001 | 0.6 | — | 0.002 | — | — | — | — | — | — |
| S54 | 3.0 | 0.002 | 0.3 | 0.01 | 0.001 | 0.6 | — | 0.002 | — | — | — | — | — | — |
| S55 | 3.0 | 0.002 | 0.3 | 0.01 | 0.001 | 0.6 | — | 0.002 | — | — | — | 1.2 | — | — |
| S56 | 3.0 | 0.002 | 0.3 | 0.01 | 0.001 | 0.6 | — | 0.002 | — | — | — | — | 0.8 | — |
| S57 | 3.0 | 0.002 | 0.3 | 0.01 | 0.001 | 0.6 | — | 0.002 | — | — | — | — | — | 1.1 |
| S58 | 3.0 | 0.002 | 0.3 | 0.01 | 0.001 | 0.6 | — | 0.002 | — | — | — | — | — | — |
| S59 | 3.0 | 0.002 | 0.3 | 0.01 | 0.001 | 0.6 | — | 0.002 | — | — | — | — | — | — |
| S60 | 3.0 | 0.002 | 0.3 | 0.01 | 0.001 | 0.6 | — | 0.002 | — | — | — | — | — | — |
| S61 | 3.0 | 0.002 | 0.3 | 0.01 | 0.001 | 0.6 | — | 0.002 | — | — | — | — | — | — |
| S62 | 3.0 | 0.002 | 0.3 | 0.01 | 0.001 | 0.6 | — | 0.002 | — | — | — | — | — | — |
| S63 | 3.0 | 0.002 | 0.3 | 0.01 | 0.001 | 0.6 | — | 0.002 | — | — | — | — | — | — |
| S64 | 3.0 | 0.002 | 0.3 | 0.01 | 0.001 | 0.6 | — | 0.002 | — | — | — | — | — | — |
| S65 | 3.7 | 0.002 | 0.2 | 0.01 | 0.001 | 0.4 | — | 0.002 | — | — | — | — | — | — |
| S66 | 4.1 | 0.002 | 0.2 | 0.01 | 0.002 | 0.3 | — | 0.002 | — | — | — | — | — | — |
| S67 | 2.5 | 0.002 | 0.2 | 0.01 | 0.001 | 0.3 | — | 0.002 | — | — | — | — | — | — |
| S68 | 2.7 | 0.002 | 0.2 | 0.01 | 0.001 | 0.3 | — | 0.002 | — | — | — | — | — | — |
| S69 | 3.3 | 0.002 | 0.5 | 0.01 | 0.001 | 0.9 | — | 0.002 | — | — | — | — | — | — |
| S70 | 3.3 | 0.002 | 0.5 | 0.01 | 0.001 | 0.9 | — | 0.002 | — | — | — | — | — | — |
| S71 | 2.7 | 0.002 | 0.2 | 0.01 | 0.001 | 0.3 | — | 0.002 | — | — | — | — | — | — |
| S72 | 2.9 | 0.002 | 0.2 | 0.01 | 0.001 | 0.3 | — | 0.002 | — | — | — | — | — | — |
| S73 | 3.3 | 0.002 | 0.5 | 0.01 | 0.001 | 0.9 | — | 0.002 | — | — | — | — | — | — |
| S74 | 3.4 | 0.003 | 0.1 | 0.01 | 0.002 | 0.03 | — | 0.001 | 0.080 | — | — | — | — | — |
| S75 | 2.0 | 0.002 | 2.5 | 0.01 | 0.002 | 1.3 | — | 0.002 | — | — | — | — | — | — |
| S76 | 1.2 | 0.002 | 0.2 | 0.01 | 0.001 | 2.8 | — | 0.002 | — | — | — | — | — | — |

TABLE 4

| | MANUFACTURING RESULTS | | | | | | | | | | | | |
|---|---|---|---|---|---|---|---|---|---|---|---|---|---|
| STEEL | CHEMICAL COMPOSITION OF BASE STEEL SHEET (UNIT: mass %, BALANCE: Fe AND IMPURITIES) | | | | | | | | | | | | |
| TYPE | Ce | B | O | Mg | Ti | V | Zr | Nd | Bi | W | Mo | Nb | Y |
| S1 | — | — | 0.002 | — | 0.001 | — | — | — | — | — | — | — | — |
| S2 | — | — | 0.002 | — | 0.001 | — | — | — | — | — | — | — | — |
| S3 | — | — | 0.002 | — | 0.001 | — | — | — | — | — | — | — | — |
| S4 | — | — | 0.002 | — | 0.001 | — | — | — | — | — | — | — | — |
| S5 | — | — | 0.002 | — | 0.001 | — | — | — | — | — | — | — | — |
| S6 | — | — | 0.002 | — | 0.001 | — | — | — | — | — | — | — | — |
| S7 | — | — | 0.002 | — | 0.001 | — | — | — | — | — | — | — | — |
| S8 | — | — | 0.002 | — | 0.001 | — | — | — | — | — | — | — | — |
| S9 | — | — | 0.002 | — | 0.001 | — | — | — | — | — | — | — | — |
| S10 | — | — | 0.002 | — | 0.001 | — | — | — | — | — | — | — | — |
| S11 | — | — | 0.002 | — | 0.001 | — | — | — | — | — | — | — | — |
| S12 | — | — | 0.002 | — | 0.001 | — | — | — | — | — | — | — | — |
| S13 | — | — | 0.002 | — | 0.001 | — | — | — | — | — | — | — | — |
| S14 | — | — | 0.002 | — | 0.001 | — | — | — | — | — | — | — | — |
| S15 | — | — | 0.002 | — | 0.001 | — | — | — | — | — | — | — | — |
| S16 | — | — | 0.002 | — | 0.001 | — | — | — | — | — | — | — | — |
| S17 | — | — | 0.002 | — | 0.001 | — | — | — | — | — | — | — | — |
| S18 | — | — | 0.002 | — | 0.001 | — | — | — | — | — | — | — | — |
| S19 | — | — | 0.002 | — | 0.001 | — | — | — | — | — | — | — | — |
| S20 | — | — | 0.002 | — | 0.001 | — | — | — | — | — | — | — | — |
| S21 | — | — | 0.002 | — | 0.001 | — | — | — | — | — | — | — | — |
| S22 | — | — | 0.002 | — | 0.001 | — | — | — | — | — | — | — | — |
| S23 | — | — | 0.002 | — | 0.001 | — | — | — | — | — | — | — | — |
| S24 | — | 0.110 | 0.002 | — | 0.001 | — | — | — | — | — | — | — | — |
| S25 | — | — | 0.002 | 0.130 | 0.001 | — | — | — | — | — | — | — | — |

TABLE 5

| | MANUFACTURING RESULTS | | | | | | | | | | | | |
|---|---|---|---|---|---|---|---|---|---|---|---|---|---|
| STEEL | CHEMICAL COMPOSITION OF BASE STEEL SHEET (UNIT: mass %, BALANCE: Fe AND IMPURITIES) | | | | | | | | | | | | |
| TYPE | Ce | B | O | Mg | Ti | V | Zr | Nd | Bi | W | Mo | Nb | Y |
| S26 | — | — | 0.002 | — | 0.001 | — | — | — | — | — | — | — | — |
| S27 | — | — | 0.002 | — | 0.001 | — | — | — | — | — | — | — | — |
| S28 | — | — | 0.002 | — | 0.001 | — | — | — | — | — | — | — | — |
| S29 | — | — | 0.002 | — | 0.001 | — | — | — | — | — | — | — | — |
| S30 | — | — | 0.002 | — | 0.121 | — | — | — | — | — | — | — | — |
| S31 | — | — | 0.002 | — | 0.001 | 0.118 | — | — | — | — | — | — | — |
| S32 | — | — | 0.002 | — | 0.001 | — | — | — | — | — | — | — | — |
| S33 | — | — | 0.002 | — | 0.001 | — | — | — | — | — | — | — | — |
| S34 | — | — | 0.002 | — | 0.001 | — | — | — | — | — | — | — | — |
| S35 | — | — | 0.002 | — | 0.001 | — | 0.125 | — | — | — | — | — | — |
| S36 | — | — | 0.002 | — | 0.001 | — | — | — | — | — | — | — | — |
| S37 | — | — | 0.002 | — | 0.001 | — | — | — | — | — | — | — | — |
| S38 | — | — | 0.002 | — | 0.001 | — | — | — | — | — | — | — | — |
| S39 | — | — | 0.002 | — | 0.001 | — | — | — | — | — | — | — | — |
| S40 | — | — | 0.002 | — | 0.001 | — | — | — | — | — | — | — | — |
| S41 | — | — | 0.002 | — | 0.001 | — | — | — | — | — | — | — | — |
| S42 | 0.003 | — | 0.002 | — | 0.001 | — | — | — | — | — | — | — | — |
| S43 | 0.008 | — | 0.002 | — | 0.001 | — | — | — | — | — | — | — | — |
| S44 | 0.150 | — | 0.002 | — | 0.001 | — | — | — | — | — | — | — | — |
| S45 | — | — | 0.002 | — | 0.001 | — | — | 0.105 | — | — | — | — | — |
| S46 | — | — | 0.002 | — | 0.001 | — | — | — | 0.138 | — | — | — | — |
| S47 | — | — | 0.002 | — | 0.001 | — | — | — | — | 0.127 | — | — | — |
| S48 | — | — | 0.002 | — | 0.001 | — | — | — | — | — | 0.13 | — | — |
| S49 | — | — | 0.002 | — | 0.001 | — | — | — | — | — | — | 0.15 | — |
| S50 | — | — | 0.002 | — | 0.001 | — | — | — | — | — | — | — | 0.143 |

TABLE 6

| | MANUFACTURING RESULTS | | | | | | | | | | | | |
|---|---|---|---|---|---|---|---|---|---|---|---|---|---|
| STEEL | CHEMICAL COMPOSITION OF BASE STEEL SHEET (UNIT: mass %, BALANCE: Fe AND IMPURITIES) | | | | | | | | | | | | |
| TYPE | Ce | B | O | Mg | Ti | V | Zr | Nd | Bi | W | Mo | Nb | Y |
| S51 | — | 0.003 | 0.002 | — | 0.001 | — | — | — | — | — | — | — | — |
| S52 | — | — | 0.002 | 0.013 | 0.001 | — | — | — | — | — | — | — | — |
| S53 | — | — | 0.002 | — | 0.0023 | — | — | — | — | — | — | — | — |
| S54 | — | — | 0.002 | — | 0.0010 | 0.0015 | — | — | — | — | — | — | — |
| S55 | — | — | 0.002 | — | 0.001 | — | — | — | — | — | — | — | — |
| S56 | — | — | 0.002 | — | 0.001 | — | — | — | — | — | — | — | — |
| S57 | — | — | 0.002 | — | 0.001 | — | — | — | — | — | — | — | — |
| S58 | — | — | 0.002 | — | 0.001 | — | 0.0022 | — | — | — | — | — | — |
| S59 | — | — | 0.002 | — | 0.001 | — | — | 0.001 | — | — | — | — | — |
| S60 | — | — | 0.002 | — | 0.001 | — | — | — | 0.001 | — | — | — | — |
| S61 | — | — | 0.002 | — | 0.001 | — | — | — | — | 0.002 | — | — | — |
| S62 | — | — | 0.002 | — | 0.001 | — | — | — | — | — | 0.001 | — | — |
| S63 | — | — | 0.002 | — | 0.001 | — | — | — | — | — | — | 0.001 | — |
| S64 | — | — | 0.002 | — | 0.001 | — | — | — | — | — | — | — | 0.002 |
| S65 | — | — | 0.002 | — | 0.001 | — | — | — | — | — | — | — | — |
| S66 | — | — | 0.002 | — | 0.001 | — | — | — | — | — | — | — | — |
| S67 | — | — | 0.002 | — | 0.001 | — | — | — | — | — | — | — | — |
| S68 | — | — | 0.002 | — | 0.001 | — | — | — | — | — | — | — | — |
| S69 | — | — | 0.002 | — | 0.001 | — | — | — | — | — | — | — | — |
| S70 | — | — | 0.002 | — | 0.001 | — | — | — | — | — | — | — | — |
| S71 | — | — | 0.002 | — | 0.001 | — | — | — | — | — | — | — | — |
| S72 | — | — | 0.002 | — | 0.001 | — | — | — | — | — | — | — | — |
| S73 | — | — | 0.002 | — | 0.001 | — | — | — | — | — | — | — | — |
| S74 | — | — | 0.002 | — | 0.001 | — | — | — | — | — | — | — | — |
| S75 | — | — | 0.002 | — | 0.001 | — | — | — | — | — | — | — | — |
| S76 | — | — | 0.002 | — | 0.001 | — | — | — | — | — | — | — | — |

TABLE 7

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 1 | S1 | No | No | 45 | 1150 | 2.0 |
| 2 | S2 | No | No | 45 | 1150 | 2.0 |
| 3 | S3 | No | No | 45 | 1150 | 2.0 |
| 4 | S4 | No | No | 45 | 1150 | 2.0 |
| 5 | S5 | No | No | 45 | 1150 | 2.0 |
| 6 | S6 | No | No | 45 | 1150 | 2.0 |
| 7 | S7 | No | No | 45 | 1150 | 2.0 |
| 8 | S8 | No | No | 45 | 1150 | 2.0 |
| 9 | S9 | No | No | 45 | 1150 | 2.0 |
| 10 | S10 | No | No | 45 | 1150 | 2.0 |
| 11 | S11 | No | No | 45 | 1150 | 2.0 |
| 12 | S12 | No | No | 45 | 1150 | 2.0 |
| 13 | S13 | No | No | 45 | 1150 | 2.0 |
| 14 | S14 | No | No | 45 | 1150 | 2.0 |
| 15 | S15 | No | No | 45 | 1150 | 2.0 |
| 16 | S16 | No | No | 45 | 1150 | 2.0 |
| 17 | S17 | No | No | 45 | 1150 | 2.0 |
| 18 | S18 | No | No | 45 | 1150 | 2.0 |
| 19 | S19 | No | No | 45 | 1150 | 2.0 |
| 20 | S20 | No | No | 45 | 1150 | 2.0 |
| 21 | S21 | No | No | 45 | 1150 | 2.0 |
| 22 | S22 | No | No | 45 | 1150 | 2.0 |
| 23 | S23 | No | No | 45 | 1150 | 2.0 |
| 24 | S24 | No | No | 45 | 1150 | 2.0 |
| 25 | S25 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 1 | 1000 | 1 | CONTINUOUS ANNEALING | 87.5 | 0.25 |
| 2 | 1000 | 1 | CONTINUOUS ANNEALING | 87.5 | 0.25 |
| 3 | 1000 | 1 | CONTINUOUS ANNEALING | 87.5 | 0.25 |
| 4 | 1000 | 1 | CONTINUOUS ANNEALING | 87.5 | 0.25 |
| 5 | 1000 | 1 | CONTINUOUS ANNEALING | 87.5 | 0.25 |
| 6 | 1000 | 1 | CONTINUOUS ANNEALING | 87.5 | 0.25 |
| 7 | 1000 | 1 | CONTINUOUS ANNEALING | 87.5 | 0.25 |
| 8 | 1000 | 1 | CONTINUOUS ANNEALING | 87.5 | 0.25 |
| 9 | 1000 | 1 | CONTINUOUS ANNEALING | 87.5 | 0.25 |
| 10 | 1000 | 1 | CONTINUOUS ANNEALING | 87.5 | 0.25 |
| 11 | 1000 | 1 | CONTINUOUS ANNEALING | 87.5 | 0.25 |
| 12 | 1000 | 1 | CONTINUOUS ANNEALING | 87.5 | 0.25 |
| 13 | 1000 | 1 | CONTINUOUS ANNEALING | 87.5 | 0.25 |
| 14 | 1000 | 1 | CONTINUOUS ANNEALING | 87.5 | 0.25 |
| 15 | 1000 | 1 | CONTINUOUS ANNEALING | 87.5 | 0.25 |
| 16 | 1000 | 1 | CONTINUOUS ANNEALING | FRACTURE | — |
| 17 | 1000 | 1 | CONTINUOUS ANNEALING | 87.5 | 0.25 |
| 18 | 1000 | 1 | CONTINUOUS ANNEALING | 87.5 | 0.25 |
| 19 | 1000 | 1 | CONTINUOUS ANNEALING | 87.5 | 0.25 |
| 20 | 1000 | 1 | CONTINUOUS ANNEALING | 87.5 | 0.25 |
| 21 | 1000 | 1 | CONTINUOUS ANNEALING | FRACTURE | — |
| 22 | 1000 | 1 | CONTINUOUS ANNEALING | 87.5 | 0.25 |
| 23 | 1000 | 1 | CONTINUOUS ANNEALING | 87.5 | 0.25 |
| 24 | 1000 | 1 | CONTINUOUS ANNEALING | 87.5 | 0.25 |
| 25 | 1000 | 1 | CONTINUOUS ANNEALING | 87.5 | 0.25 |

TABLE 8

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 26 | S26 | No | No | 45 | 1150 | 2.0 |
| 27 | S27 | No | No | 45 | 1150 | 2.0 |
| 28 | S28 | No | No | 45 | 1150 | 2.0 |
| 29 | S29 | No | No | 45 | 1150 | 2.0 |
| 30 | S30 | No | No | 45 | 1150 | 2.0 |
| 31 | S31 | No | No | 45 | 1150 | 2.0 |
| 32 | S32 | No | No | 45 | 1150 | 2.0 |
| 33 | S33 | No | No | 45 | 1150 | 2.0 |
| 34 | S34 | No | No | 45 | 1150 | 2.0 |
| 35 | S35 | No | No | 45 | 1150 | 2.0 |
| 36 | S36 | No | No | 45 | 1150 | 2.0 |
| 37 | S37 | No | No | 45 | 1150 | 2.0 |
| 38 | S38 | No | No | 45 | 1150 | 2.0 |
| 39 | S39 | No | No | 45 | 1150 | 2.0 |
| 40 | S40 | No | No | 45 | 1150 | 2.0 |
| 41 | S41 | No | No | 45 | 1150 | 2.0 |
| 42 | S42 | No | No | 45 | 1150 | 2.0 |
| 43 | S43 | No | No | 45 | 1150 | 2.0 |
| 44 | S44 | No | No | 45 | 1150 | 2.0 |
| 45 | S45 | No | No | 45 | 1150 | 2.0 |
| 46 | S46 | No | No | 45 | 1150 | 2.0 |
| 47 | S47 | No | No | 45 | 1150 | 2.0 |
| 48 | S48 | No | No | 45 | 1150 | 2.0 |
| 49 | S49 | No | No | 45 | 1150 | 2.0 |
| 50 | S50 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 26 | 1000 | 1 | CONTINUOUS ANNEALING | 87.5 | 0.25 |
| 27 | 1000 | 1 | CONTINUOUS ANNEALING | 87.5 | 0.25 |
| 28 | 1000 | 1 | CONTINUOUS ANNEALING | 87.5 | 0.25 |
| 29 | 1000 | 1 | CONTINUOUS ANNEALING | 87.5 | 0.25 |
| 30 | 1000 | 1 | CONTINUOUS ANNEALING | 87.5 | 0.25 |
| 31 | 1000 | 1 | CONTINUOUS ANNEALING | 87.5 | 0.25 |
| 32 | 1000 | 1 | CONTINUOUS ANNEALING | 87.5 | 0.25 |
| 33 | 1000 | 1 | CONTINUOUS ANNEALING | 87.5 | 0.25 |
| 34 | 1000 | 1 | CONTINUOUS ANNEALING | 87.5 | 0.25 |
| 35 | 1000 | 1 | CONTINUOUS ANNEALING | 87.5 | 0.25 |
| 36 | 1000 | 1 | CONTINUOUS ANNEALING | 87.5 | 0.25 |
| 37 | 1000 | 1 | CONTINUOUS ANNEALING | 87.5 | 0.25 |
| 38 | 1000 | 1 | CONTINUOUS ANNEALING | FRACTURE | — |
| 39 | 1000 | 1 | CONTINUOUS ANNEALING | 87.5 | 0.25 |
| 40 | 1000 | 1 | CONTINUOUS ANNEALING | 87.5 | 0.25 |
| 41 | 1000 | 1 | CONTINUOUS ANNEALING | FRACTURE | — |
| 42 | 1000 | 1 | CONTINUOUS ANNEALING | 87.5 | 0.25 |
| 43 | 1000 | 1 | CONTINUOUS ANNEALING | 87.5 | 0.25 |
| 44 | 1000 | 1 | CONTINUOUS ANNEALING | 87.5 | 0.25 |
| 45 | 1000 | 1 | CONTINUOUS ANNEALING | 87.5 | 0.25 |
| 46 | 1000 | 1 | CONTINUOUS ANNEALING | 87.5 | 0.25 |
| 47 | 1000 | 1 | CONTINUOUS ANNEALING | 87.5 | 0.25 |
| 48 | 1000 | 1 | CONTINUOUS ANNEALING | 87.5 | 0.25 |
| 49 | 1000 | 1 | CONTINUOUS ANNEALING | 87.5 | 0.25 |
| 50 | 1000 | 1 | CONTINUOUS ANNEALING | 87.5 | 0.25 |

TABLE 9

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 51 | S51 | No | No | 45 | 1150 | 2.0 |
| 52 | S52 | No | No | 45 | 1150 | 2.0 |
| 53 | S53 | No | No | 45 | 1150 | 2.0 |
| 54 | S54 | No | No | 45 | 1150 | 2.0 |
| 55 | S55 | No | No | 45 | 1150 | 2.0 |
| 56 | S56 | No | No | 45 | 1150 | 2.0 |
| 57 | S57 | No | No | 45 | 1150 | 2.0 |
| 58 | S58 | No | No | 45 | 1150 | 2.0 |
| 59 | S59 | No | No | 45 | 1150 | 2.0 |
| 60 | S60 | No | No | 45 | 1150 | 2.0 |
| 61 | S61 | No | No | 45 | 1150 | 2.0 |
| 62 | S62 | No | No | 45 | 1150 | 2.0 |
| 63 | S63 | No | No | 45 | 1150 | 2.0 |
| 64 | S64 | No | No | 45 | 1150 | 2.0 |
| 65 | S65 | No | No | 45 | 1150 | 2.0 |
| 66 | S66 | No | No | 45 | 1150 | 2.0 |
| 67 | S9 | Yes | No | 45 | 1150 | 2.0 |
| 68 | S9 | No | Yes | 45 | 1150 | 2.0 |
| 69 | S9 | No | No | 75 | 1150 | 2.0 |
| 70 | S9 | No | No | 45 | 950 | 2.0 |
| 71 | S9 | No | No | 45 | 1350 | 2.0 |
| 72 | S9 | No | No | 45 | 1150 | 0.8 |
| 73 | S9 | No | No | 45 | 1150 | 2.7 |
| 74 | S9 | No | No | 45 | 1150 | 2.0 |
| 75 | S9 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 51 | 1000 | 1 | CONTINUOUS ANNEALING | 87.5 | 0.25 |
| 52 | 1000 | 1 | CONTINUOUS ANNEALING | 87.5 | 0.25 |
| 53 | 1000 | 1 | CONTINUOUS ANNEALING | 87.5 | 0.25 |
| 54 | 1000 | 1 | CONTINUOUS ANNEALING | 87.5 | 0.25 |
| 55 | 1000 | 1 | CONTINUOUS ANNEALING | 87.5 | 0.25 |
| 56 | 1000 | 1 | CONTINUOUS ANNEALING | 87.5 | 0.25 |
| 57 | 1000 | 1 | CONTINUOUS ANNEALING | 87.5 | 0.25 |
| 58 | 1000 | 1 | CONTINUOUS ANNEALING | 87.5 | 0.25 |
| 59 | 1000 | 1 | CONTINUOUS ANNEALING | 87.5 | 0.25 |
| 60 | 1000 | 1 | CONTINUOUS ANNEALING | 87.5 | 0.25 |
| 61 | 1000 | 1 | CONTINUOUS ANNEALING | 87.5 | 0.25 |
| 62 | 1000 | 1 | CONTINUOUS ANNEALING | 87.5 | 0.25 |
| 63 | 1000 | 1 | CONTINUOUS ANNEALING | 87.5 | 0.25 |
| 64 | 1000 | 1 | CONTINUOUS ANNEALING | 87.5 | 0.25 |
| 65 | 1000 | 1 | CONTINUOUS ANNEALING | 87.5 | 0.25 |
| 66 | 1000 | 1 | CONTINUOUS ANNEALING | 87.5 | 0.25 |
| 67 | 1000 | 1 | CONTINUOUS ANNEALING | 87.5 | 0.25 |
| 68 | 1000 | 1 | CONTINUOUS ANNEALING | 87.5 | 0.25 |
| 69 | 1000 | 1 | CONTINUOUS ANNEALING | 87.5 | 0.25 |
| 70 | 1000 | 1 | CONTINUOUS ANNEALING | 87.5 | 0.25 |
| 71 | 1000 | 1 | CONTINUOUS ANNEALING | 87.5 | 0.25 |
| 72 | 1000 | 1 | CONTINUOUS ANNEALING | 68.8 | 0.25 |
| 73 | 1000 | 1 | CONTINUOUS ANNEALING | 90.7 | 0.25 |
| 74 | 650 | 60 | BOX ANNEALING | 87.5 | 0.25 |
| 75 | 1150 | 1 | CONTINUOUS ANNEALING | 87.5 | 0.25 |

TABLE 10

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 76 | S9 | No | No | 45 | 1150 | 2.0 |
| 77 | S9 | No | No | 45 | 1150 | 2.0 |
| 78 | S9 | No | No | 45 | 1150 | 0.8 |
| 79 | S9 | No | No | 45 | 1150 | 2.7 |
| 80 | S9 | No | No | 45 | 1150 | 1.0 |
| 81 | S9 | No | No | 45 | 1150 | 2.0 |
| 82 | S9 | No | No | 45 | 1150 | 2.0 |
| 83 | S9 | No | No | 45 | 1150 | 2.0 |
| 84 | S9 | No | No | 45 | 1150 | 2.0 |
| 85 | S9 | No | No | 45 | 1150 | 2.0 |
| 86 | S9 | No | No | 45 | 1150 | 2.0 |
| 87 | S9 | No | No | 45 | 1150 | 2.0 |
| 88 | S9 | No | No | 45 | 1150 | 2.0 |
| 89 | S9 | No | No | 45 | 1150 | 2.0 |
| 90 | S9 | No | No | 45 | 1150 | 2.0 |
| 91 | S9 | No | No | 45 | 1150 | 2.0 |
| 92 | S9 | No | No | 45 | 1150 | 2.0 |
| 93 | S9 | No | No | 45 | 1150 | 2.0 |
| 94 | S9 | No | No | 45 | 1150 | 2.0 |
| 95 | S9 | No | No | 45 | 1150 | 2.0 |
| 96 | S9 | No | No | 45 | 1150 | 2.0 |
| 97 | S9 | No | No | 45 | 1150 | 2.0 |
| 98 | S9 | No | No | 45 | 1150 | 2.0 |
| 99 | S9 | No | No | 45 | 1150 | 2.0 |
| 100 | S9 | No | No | 45 | 1150 | 2.0 |
| 101 | S9 | No | No | 45 | 1150 | 2.0 |
| 102 | S9 | No | No | 45 | 1150 | 2.0 |
| 103 | S9 | No | No | 45 | 1150 | 2.0 |
| 104 | S9 | No | No | 45 | 1150 | 2.0 |
| 105 | S9 | No | No | 45 | 1150 | 2.0 |
| 106 | S9 | No | No | 45 | 1150 | 2.0 |
| 107 | S9 | No | No | 45 | 1150 | 2.0 |
| 108 | S9 | No | No | 45 | 1150 | 2.0 |
| 109 | S9 | No | No | 45 | 1150 | 2.0 |
| 110 | S9 | No | No | 45 | 1150 | 2.0 |
| 111 | S9 | No | No | 45 | 1150 | 2.0 |
| 112 | S9 | No | No | 45 | 1150 | 2.0 |
| 113 | S9 | No | No | 45 | 1150 | 2.0 |
| 114 | S9 | No | No | 45 | 1150 | 2.0 |
| 115 | S9 | No | No | 45 | 1150 | 2.0 |
| 116 | S9 | No | No | 45 | 1150 | 2.0 |
| 117 | S9 | No | No | 45 | 1150 | 2.0 |
| 118 | S9 | No | No | 45 | 1150 | 2.0 |
| 119 | S9 | No | No | 45 | 1150 | 2.0 |
| 120 | S9 | No | No | 45 | 1150 | 2.0 |
| 121 | S9 | No | No | 45 | 1150 | 2.0 |
| 122 | S9 | No | No | 45 | 1150 | 2.0 |
| 123 | S9 | No | No | 45 | 1150 | 2.0 |
| 124 | S9 | No | No | 45 | 1150 | 2.0 |
| 125 | S9 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 76 | 1000 | 0.008 | CONTINUOUS ANNEALING | 87.5 | 0.25 |
| 77 | 800 | 1440 | BOX ANNEALING | 87.5 | 0.25 |
| 78 | 1000 | 1 | CONTINUOUS ANNEALING | 56.3 | 0.35 |
| 79 | 1000 | 1 | CONTINUOUS ANNEALING | 96.3 | 0.10 |
| 80 | 1000 | 1 | CONTINUOUS ANNEALING | 95.0 | 0.05 |
| 81 | 1000 | 1 | CONTINUOUS ANNEALING | 80.0 | 0.40 |
| 82 | 1000 | 1 | CONTINUOUS ANNEALING | 87.5 | 0.25 |
| 83 | 1000 | 1 | CONTINUOUS ANNEALING | 87.5 | 0.25 |
| 84 | 1000 | 1 | CONTINUOUS ANNEALING | 87.5 | 0.25 |
| 85 | 1000 | 1 | CONTINUOUS ANNEALING | 87.5 | 0.25 |
| 86 | 1000 | 1 | CONTINUOUS ANNEALING | 87.5 | 0.25 |
| 87 | 1000 | 1 | CONTINUOUS ANNEALING | 87.5 | 0.25 |
| 88 | 1000 | 1 | CONTINUOUS ANNEALING | 87.5 | 0.25 |
| 89 | 1000 | 1 | CONTINUOUS ANNEALING | 87.5 | 0.25 |
| 90 | 1000 | 1 | CONTINUOUS ANNEALING | 87.5 | 0.25 |
| 91 | 1000 | 1 | CONTINUOUS ANNEALING | 87.5 | 0.25 |
| 92 | 1000 | 1 | CONTINUOUS ANNEALING | 87.5 | 0.25 |
| 93 | 1000 | 1 | CONTINUOUS ANNEALING | 87.5 | 0.25 |
| 94 | 1000 | 1 | CONTINUOUS ANNEALING | 87.5 | 0.25 |
| 95 | 1000 | 1 | CONTINUOUS ANNEALING | 87.5 | 0.25 |
| 96 | 1000 | 1 | CONTINUOUS ANNEALING | 87.5 | 0.25 |
| 97 | 1000 | 1 | CONTINUOUS ANNEALING | 87.5 | 0.25 |
| 98 | 1000 | 1 | CONTINUOUS ANNEALING | 87.5 | 0.25 |
| 99 | 1000 | 1 | CONTINUOUS ANNEALING | 87.5 | 0.25 |
| 100 | 1000 | 1 | CONTINUOUS ANNEALING | 87.5 | 0.25 |
| 101 | 1000 | 1 | CONTINUOUS ANNEALING | 87.5 | 0.25 |
| 102 | 1000 | 1 | CONTINUOUS ANNEALING | 87.5 | 0.25 |
| 103 | 1000 | 1 | CONTINUOUS ANNEALING | 87.5 | 0.25 |
| 104 | 1000 | 1 | CONTINUOUS ANNEALING | 87.5 | 0.25 |
| 105 | 1000 | 1 | CONTINUOUS ANNEALING | 87.5 | 0.25 |
| 106 | 1000 | 1 | CONTINUOUS ANNEALING | 87.5 | 0.25 |
| 107 | 1000 | 1 | CONTINUOUS ANNEALING | 87.5 | 0.25 |
| 108 | 1000 | 1 | CONTINUOUS ANNEALING | 87.5 | 0.25 |
| 109 | 1000 | 1 | CONTINUOUS ANNEALING | 87.5 | 0.25 |
| 110 | 1000 | 1 | CONTINUOUS ANNEALING | 87.5 | 0.25 |
| 111 | 1000 | 1 | CONTINUOUS ANNEALING | 87.5 | 0.25 |
| 112 | 1000 | 1 | CONTINUOUS ANNEALING | 87.5 | 0.25 |
| 113 | 1000 | 1 | CONTINUOUS ANNEALING | 87.5 | 0.25 |
| 114 | 1000 | 1 | CONTINUOUS ANNEALING | 87.5 | 0.25 |
| 115 | 1000 | 1 | CONTINUOUS ANNEALING | 87.5 | 0.25 |
| 116 | 1000 | 1 | CONTINUOUS ANNEALING | 87.5 | 0.25 |
| 117 | 1000 | 1 | CONTINUOUS ANNEALING | 87.5 | 0.25 |
| 118 | 1000 | 1 | CONTINUOUS ANNEALING | 87.5 | 0.25 |
| 119 | 1000 | 1 | CONTINUOUS ANNEALING | 87.5 | 0.25 |
| 120 | 1000 | 1 | CONTINUOUS ANNEALING | 87.5 | 0.25 |
| 121 | 1000 | 1 | CONTINUOUS ANNEALING | 87.5 | 0.25 |
| 122 | 1000 | 1 | CONTINUOUS ANNEALING | 87.5 | 0.25 |
| 123 | 1000 | 1 | CONTINUOUS ANNEALING | 87.5 | 0.25 |
| 124 | 1000 | 1 | CONTINUOUS ANNEALING | 87.5 | 0.25 |
| 125 | 1000 | 1 | CONTINUOUS ANNEALING | 87.5 | 0.25 |

TABLE 12

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 126 | S9 | No | No | 45 | 1150 | 2.0 |
| 127 | S9 | No | No | 45 | 1150 | 2.0 |
| 128 | S9 | No | No | 45 | 1150 | 2.0 |
| 129 | S67 | No | No | 45 | 1150 | 2.0 |
| 130 | S68 | No | No | 45 | 1150 | 2.0 |
| 131 | S69 | No | No | 45 | 1150 | 2.0 |
| 132 | S70 | No | No | 45 | 1150 | 2.0 |
| 133 | S71 | No | No | 45 | 1150 | 2.0 |
| 134 | S72 | No | No | 45 | 1150 | 2.0 |
| 135 | S73 | No | No | 45 | 1150 | 2.0 |
| 136 | S74 | No | No | 45 | 1150 | 2.0 |
| 137 | S9 | No | No | 45 | 1150 | 2.0 |
| 138 | S75 | No | No | 45 | 1150 | 2.0 |
| 139 | S76 | No | No | 45 | 1150 | 2.0 |
| 140 | S9 | No | No | 45 | 1150 | 2.0 |
| 141 | S9 | No | No | 45 | 1150 | 2.0 |
| 142 | S9 | No | No | 45 | 1150 | 2.0 |
| 143 | S9 | No | No | 45 | 1150 | 2.0 |
| 144 | S9 | No | No | 45 | 1150 | 2.0 |
| 145 | S9 | No | No | 45 | 1150 | 2.0 |
| 146 | S9 | No | No | 45 | 1150 | 2.0 |
| 147 | S9 | No | No | 45 | 1150 | 2.0 |
| 148 | S9 | No | No | 45 | 1150 | 2.0 |
| 149 | S9 | No | No | 45 | 1150 | 2.0 |
| 150 | S9 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 126 | 1000 | 1 | CONTINUOUS ANNEALING | 87.5 | 0.25 |
| 127 | 1000 | 1 | CONTINUOUS ANNEALING | 87.5 | 0.25 |
| 128 | 1000 | 1 | CONTINUOUS ANNEALING | 87.5 | 0.25 |
| 129 | 1000 | 1 | CONTINUOUS ANNEALING | 87.5 | 0.25 |
| 130 | 1000 | 1 | CONTINUOUS ANNEALING | 87.5 | 0.25 |
| 131 | 1000 | 1 | CONTINUOUS ANNEALING | 87.5 | 0.25 |
| 132 | 1000 | 1 | CONTINUOUS ANNEALING | 87.5 | 0.25 |
| 133 | 1000 | 1 | CONTINUOUS ANNEALING | 87.5 | 0.25 |
| 134 | 1000 | 1 | CONTINUOUS ANNEALING | 87.5 | 0.25 |
| 135 | 1000 | 1 | CONTINUOUS ANNEALING | 87.5 | 0.25 |
| 136 | 1100 | 1.7 | CONTINUOUS ANNEALING | 86.5 | 0.27 |
| 137 | 1000 | 1 | CONTINUOUS ANNEALING | 87.5 | 0.25 |
| 138 | 1000 | 1 | CONTINUOUS ANNEALING | 87.5 | 0.25 |
| 139 | 1000 | 1 | CONTINUOUS ANNEALING | 87.5 | 0.25 |
| 140 | 1000 | 5 | CONTINUOUS ANNEALING | FRACTURE | — |
| 141 | 1000 | 1 | CONTINUOUS ANNEALING | 87.5 | 0.25 |
| 142 | 1000 | 1 | CONTINUOUS ANNEALING | 87.5 | 0.25 |
| 143 | 1000 | 1 | CONTINUOUS ANNEALING | 87.5 | 0.25 |
| 144 | 1000 | 1 | CONTINUOUS ANNEALING | 87.5 | 0.25 |
| 145 | 1000 | 1 | CONTINUOUS ANNEALING | 87.5 | 0.25 |
| 146 | 1000 | 1 | CONTINUOUS ANNEALING | 87.5 | 0.25 |
| 147 | 1000 | 1 | CONTINUOUS ANNEALING | 87.5 | 0.25 |
| 148 | 1000 | 1 | CONTINUOUS ANNEALING | 87.5 | 0.25 |
| 149 | 1000 | 1 | CONTINUOUS ANNEALING | 87.5 | 0.25 |
| 150 | 1000 | 1 | CONTINUOUS ANNEALING | 87.5 | 0.25 |

TABLE 13

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 151 | S9 | No | No | 45 | 1150 | 2.0 |
| 152 | S9 | No | No | 45 | 1150 | 2.0 |
| 153 | S9 | No | No | 45 | 1150 | 2.0 |
| 154 | S9 | No | No | 45 | 1150 | 2.0 |
| 155 | S9 | No | No | 45 | 1150 | 2.0 |
| 156 | S9 | No | No | 45 | 1150 | 2.0 |
| 157 | S9 | No | No | 45 | 1150 | 2.0 |
| 158 | S9 | No | No | 45 | 1150 | 2.0 |
| 159 | S9 | No | No | 45 | 1150 | 2.0 |
| 160 | S9 | No | No | 45 | 1150 | 2.0 |
| 161 | S9 | No | No | 45 | 1150 | 2.0 |
| 162 | S9 | No | No | 45 | 1150 | 2.0 |
| 163 | S9 | No | No | 45 | 1150 | 2.0 |
| 164 | S9 | No | No | 45 | 1150 | 2.0 |
| 165 | S9 | No | No | 45 | 1150 | 2.0 |
| 166 | S9 | No | No | 45 | 1150 | 2.0 |
| 167 | S9 | No | No | 45 | 1150 | 2.0 |
| 168 | S9 | No | No | 45 | 1150 | 2.0 |
| 169 | S9 | No | No | 45 | 1150 | 2.0 |
| 170 | S9 | No | No | 45 | 1150 | 2.0 |
| 171 | S9 | No | No | 45 | 1150 | 2.0 |
| 172 | S9 | No | No | 45 | 1150 | 2.0 |
| 173 | S9 | No | No | 45 | 1150 | 2.0 |
| 174 | S9 | No | No | 45 | 1150 | 2.0 |
| 175 | S9 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 151 | 1000 | 1 | CONTINUOUS ANNEALING | 87.5 | 0.25 |
| 152 | 1000 | 1 | CONTINUOUS ANNEALING | 87.5 | 0.25 |
| 153 | 1000 | 1 | CONTINUOUS ANNEALING | 87.5 | 0.25 |
| 154 | 1000 | 1 | CONTINUOUS ANNEALING | 87.5 | 0.25 |
| 155 | 1000 | 1 | CONTINUOUS ANNEALING | 87.5 | 0.25 |
| 156 | 1000 | 1 | CONTINUOUS ANNEALING | 87.5 | 0.25 |
| 157 | 1000 | 1 | CONTINUOUS ANNEALING | 87.5 | 0.25 |
| 158 | 1000 | 1 | CONTINUOUS ANNEALING | 87.5 | 0.25 |
| 159 | 1000 | 1 | CONTINUOUS ANNEALING | 87.5 | 0.25 |
| 160 | 1000 | 1 | CONTINUOUS ANNEALING | 87.5 | 0.25 |
| 161 | 1000 | 1 | CONTINUOUS ANNEALING | 87.5 | 0.25 |
| 162 | 1000 | 1 | CONTINUOUS ANNEALING | 87.5 | 0.25 |
| 163 | 1000 | 1 | CONTINUOUS ANNEALING | 87.5 | 0.25 |
| 164 | 1000 | 1 | CONTINUOUS ANNEALING | 87.5 | 0.25 |
| 165 | 1000 | 1 | CONTINUOUS ANNEALING | 87.5 | 0.25 |
| 166 | 1000 | 1 | CONTINUOUS ANNEALING | 87.5 | 0.25 |
| 167 | 1000 | 1 | CONTINUOUS ANNEALING | 87.5 | 0.25 |
| 168 | 1000 | 1 | CONTINUOUS ANNEALING | 87.5 | 0.25 |
| 169 | 1000 | 1 | CONTINUOUS ANNEALING | 87.5 | 0.25 |
| 170 | 1000 | 1 | CONTINUOUS ANNEALING | 87.5 | 0.25 |
| 171 | 1000 | 1 | CONTINUOUS ANNEALING | 87.5 | 0.25 |
| 172 | 1000 | 1 | CONTINUOUS ANNEALING | 87.5 | 0.25 |
| 173 | 1000 | 1 | CONTINUOUS ANNEALING | 87.5 | 0.25 |
| 174 | 1000 | 1 | CONTINUOUS ANNEALING | 87.5 | 0.25 |
| 175 | 1000 | 1 | CONTINUOUS ANNEALING | 87.5 | 0.25 |

TABLE 14

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 176 | S9 | No | No | 45 | 1150 | 2.0 |
| 177 | S9 | No | No | 45 | 1150 | 2.0 |
| 178 | S9 | No | No | 45 | 1150 | 2.0 |
| 179 | S9 | No | No | 45 | 1150 | 2.0 |
| 180 | S9 | No | No | 45 | 1150 | 2.0 |
| 181 | S9 | No | No | 45 | 1150 | 2.0 |
| 182 | S9 | No | No | 45 | 1150 | 2.0 |
| 183 | S9 | No | No | 45 | 1150 | 2.0 |
| 184 | S9 | No | No | 45 | 1150 | 2.0 |
| 185 | S9 | No | No | 45 | 1150 | 2.0 |
| 186 | S9 | No | No | 45 | 1150 | 2.0 |
| 187 | S9 | No | No | 45 | 1150 | 2.0 |
| 188 | S9 | No | No | 45 | 1150 | 2.0 |
| 189 | S9 | No | No | 45 | 1150 | 2.0 |
| 190 | S9 | No | No | 45 | 1150 | 2.0 |
| 191 | S9 | No | No | 45 | 1150 | 2.0 |
| 192 | S9 | No | No | 45 | 1150 | 2.0 |
| 193 | S9 | No | No | 45 | 1150 | 2.0 |
| 194 | S9 | No | No | 45 | 1150 | 2.0 |
| 195 | S9 | No | No | 45 | 1150 | 2.0 |
| 196 | S9 | No | No | 45 | 1150 | 2.0 |
| 197 | S9 | No | No | 45 | 1150 | 2.0 |
| 198 | S9 | No | No | 45 | 1150 | 2.0 |
| 199 | S9 | No | No | 45 | 1150 | 2.0 |
| 200 | S9 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 176 | 1000 | 1 | CONTINUOUS ANNEALING | 87.5 | 0.25 |
| 177 | 1000 | 1 | CONTINUOUS ANNEALING | 87.5 | 0.25 |
| 178 | 1000 | 1 | CONTINUOUS ANNEALING | 87.5 | 0.25 |
| 179 | 1000 | 1 | CONTINUOUS ANNEALING | 87.5 | 0.25 |
| 180 | 1000 | 1 | CONTINUOUS ANNEALING | 87.5 | 0.25 |
| 181 | 1000 | 1 | CONTINUOUS ANNEALING | 87.5 | 0.25 |
| 182 | 1000 | 1 | CONTINUOUS ANNEALING | 87.5 | 0.25 |
| 183 | 1000 | 1 | CONTINUOUS ANNEALING | 87.5 | 0.25 |
| 184 | 1000 | 1 | CONTINUOUS ANNEALING | 87.5 | 0.25 |
| 185 | 1000 | 1 | CONTINUOUS ANNEALING | 87.5 | 0.25 |
| 186 | 1000 | 1 | CONTINUOUS ANNEALING | 87.5 | 0.25 |
| 187 | 1000 | 1 | CONTINUOUS ANNEALING | 87.5 | 0.25 |
| 188 | 1000 | 1 | CONTINUOUS ANNEALING | 87.5 | 0.25 |
| 189 | 1000 | 1 | CONTINUOUS ANNEALING | 87.5 | 0.25 |
| 190 | 1000 | 1 | CONTINUOUS ANNEALING | 87.5 | 0.25 |
| 191 | 1000 | 1 | CONTINUOUS ANNEALING | 87.5 | 0.25 |
| 192 | 1000 | 1 | CONTINUOUS ANNEALING | 87.5 | 0.25 |
| 193 | 1000 | 1 | CONTINUOUS ANNEALING | 87.5 | 0.25 |
| 194 | 1000 | 1 | CONTINUOUS ANNEALING | 87.5 | 0.25 |
| 195 | 1000 | 1 | CONTINUOUS ANNEALING | 87.5 | 0.25 |
| 196 | 1000 | 1 | CONTINUOUS ANNEALING | 87.5 | 0.25 |
| 197 | 1000 | 1 | CONTINUOUS ANNEALING | 87.5 | 0.25 |
| 198 | 1000 | 1 | CONTINUOUS ANNEALING | 87.5 | 0.25 |
| 199 | 1000 | 1 | CONTINUOUS ANNEALING | 87.5 | 0.25 |
| 200 | 1000 | 1 | CONTINUOUS ANNEALING | 87.5 | 0.25 |

TABLE 15

| | | MANUFACTURING CONDITIONS | | | | |
|---|---|---|---|---|---|---|
| | | | | | HOT ROLLING | |
| | | CASTING | | | REHEATING | THICKNESS OF |
| | | | | THICKNESS | TEMPERATURE | HOT ROLLED |
| | STEEL | ELECTROMAGNETIC | FINE | OF SLAB | OF SLAB | STEEL SHEET |
| No. | TYPE | STIRRING | INCLUSIONS | mm | ° C. | mm |
| 201 | S9 | No | No | 45 | 1150 | 2.0 |
| 202 | S9 | No | No | 45 | 1150 | 2.0 |
| 203 | S9 | No | No | 45 | 1150 | 2.0 |
| 204 | S9 | No | No | 45 | 1150 | 2.0 |
| 205 | S9 | No | No | 45 | 1150 | 2.0 |
| 206 | S9 | No | No | 45 | 1150 | 2.0 |
| 207 | S9 | No | No | 45 | 1150 | 2.0 |
| 208 | S9 | No | No | 45 | 1150 | 2.0 |
| 209 | S9 | No | No | 45 | 1150 | 2.0 |
| 210 | S9 | No | No | 45 | 1150 | 2.0 |
| 211 | S9 | No | No | 45 | 1150 | 2.0 |
| 212 | S9 | No | No | 45 | 1150 | 2.0 |
| 213 | S9 | No | No | 45 | 1150 | 2.0 |
| 214 | S67 | No | No | 45 | 1150 | 2.0 |

| | MANUFACTURING CONDITIONS | | | | |
|---|---|---|---|---|---|
| | | | | COLD ROLLING | |
| | HOT BAND ANNEALING | | | CUMULATIVE | |
| | HOLDING | HOLDING | | ROLLING | FINAL |
| | TEMPERATURE | TIME | | REDUCTION | THICKNESS |
| No. | ° C. | min. | TYPE OF ANNEALING | % | mm |
| 201 | 1000 | 1 | CONTINUOUS ANNEALING | 87.5 | 0.25 |
| 202 | 1000 | 1 | CONTINUOUS ANNEALING | 87.5 | 0.25 |
| 203 | 1000 | 1 | CONTINUOUS ANNEALING | 87.5 | 0.25 |
| 204 | 1000 | 1 | CONTINUOUS ANNEALING | 87.5 | 0.25 |
| 205 | 1000 | 1 | CONTINUOUS ANNEALING | 87.5 | 0.25 |
| 206 | 1000 | 1 | CONTINUOUS ANNEALING | 87.5 | 0.25 |
| 207 | 1000 | 1 | CONTINUOUS ANNEALING | 87.5 | 0.25 |
| 208 | 1000 | 1 | CONTINUOUS ANNEALING | 87.5 | 0.25 |
| 209 | 1000 | 1 | CONTINUOUS ANNEALING | 87.5 | 0.25 |
| 210 | 1000 | 1 | CONTINUOUS ANNEALING | 87.5 | 0.25 |
| 211 | 1000 | 1 | CONTINUOUS ANNEALING | 87.5 | 0.25 |
| 212 | 1000 | 1 | CONTINUOUS ANNEALING | 87.5 | 0.25 |
| 213 | 1000 | 1 | CONTINUOUS ANNEALING | 87.5 | 0.25 |
| 214 | 1000 | 1 | CONTINUOUS ANNEALING | 87.5 | 0.25 |

TABLE 16

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 1 | S1 | Al—Si—Mn BASED PLATING | 95 | 4.0 | 1.0 | 10 | — | — |
| 2 | S2 | Al—Si—Mn BASED PLATING | 95 | 4.0 | 1.0 | 10 | — | — |
| 3 | S3 | Al—Si—Mn BASED PLATING | 95 | 4.0 | 1.0 | 10 | — | — |
| 4 | S4 | Al—Si—Mn BASED PLATING | 95 | 4.0 | 1.0 | 10 | — | — |
| 5 | S5 | Al—Si—Mn BASED PLATING | 95 | 4.0 | 1.0 | 10 | — | — |
| 6 | S6 | Al—Si—Mn BASED PLATING | 95 | 4.0 | 1.0 | 10 | — | — |
| 7 | S7 | Al—Si—Mn BASED PLATING | 95 | 4.0 | 1.0 | 10 | — | — |
| 8 | S8 | Al—Si—Mn BASED PLATING | 95 | 4.0 | 1.0 | 10 | — | — |
| 9 | S9 | Al—Si—Mn BASED PLATING | 95 | 4.0 | 1.0 | 10 | — | — |
| 10 | S10 | Al—Si—Mn BASED PLATING | 95 | 4.0 | 1.0 | 10 | — | — |
| 11 | S11 | Al—Si—Mn BASED PLATING | 95 | 4.0 | 1.0 | 10 | — | — |
| 12 | S12 | Al—Si—Mn BASED PLATING | 95 | 4.0 | 1.0 | 10 | — | — |
| 13 | S13 | Al—Si—Mn BASED PLATING | 95 | 4.0 | 1.0 | 10 | — | — |
| 14 | S14 | Al—Si—Mn BASED PLATING | 95 | 4.0 | 1.0 | 10 | — | — |
| 15 | S15 | Al—Si—Mn BASED PLATING | 95 | 4.0 | 1.0 | 10 | — | — |
| 16 | S16 | — | — | — | — | — | — | — |
| 17 | S17 | Al—Si—Mn BASED PLATING | 95 | 4.0 | 1.0 | 10 | — | — |
| 18 | S18 | Al—Si—Mn BASED PLATING | 95 | 4.0 | 1.0 | 10 | — | — |
| 19 | S19 | Al—Si—Mn BASED PLATING | 95 | 4.0 | 1.0 | 10 | — | — |
| 20 | S20 | Al—Si—Mn BASED PLATING | 95 | 4.0 | 1.0 | 10 | — | — |
| 21 | S21 | — | — | — | — | — | — | — |
| 22 | S22 | Al—Si—Mn BASED PLATING | 95 | 4.0 | 1.0 | 10 | — | — |
| 23 | S23 | Al—Si—Mn BASED PLATING | 95 | 4.0 | 1.0 | 10 | — | — |
| 24 | S24 | Al—Si—Mn BASED PLATING | 95 | 4.0 | 1.0 | 10 | — | — |
| 25 | S25 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 1 | — | — | 10 | 50 | 180 | 100 |
| 2 | — | — | 10 | 50 | 180 | 100 |
| 3 | — | — | 10 | 50 | 180 | 100 |
| 4 | — | — | 10 | 50 | 180 | 100 |
| 5 | — | — | 10 | 50 | 180 | 100 |
| 6 | — | — | 10 | 50 | 180 | 100 |
| 7 | — | — | 10 | 50 | 180 | 100 |
| 8 | — | — | 10 | 50 | 180 | 100 |
| 9 | — | — | 10 | 50 | 180 | 100 |
| 10 | — | — | 10 | 50 | 180 | 100 |
| 11 | — | — | 10 | 50 | 180 | 100 |
| 12 | — | — | 10 | 50 | 180 | 100 |
| 13 | — | — | 10 | 50 | 180 | 100 |
| 14 | — | — | 10 | 50 | 180 | 100 |
| 15 | — | — | 10 | 50 | 180 | 100 |
| 16 | — | — | — | — | — | — |
| 17 | — | — | 10 | 50 | 180 | 100 |
| 18 | — | — | 10 | 50 | 180 | 100 |
| 19 | — | — | 10 | 50 | 180 | 100 |
| 20 | — | — | 10 | 50 | 180 | 100 |
| 21 | — | — | — | — | — | — |
| 22 | — | — | 10 | 50 | 180 | 100 |
| 23 | — | — | 10 | 50 | 180 | 100 |
| 24 | — | — | 10 | 50 | 180 | 100 |
| 25 | — | — | 10 | 50 | 180 | 100 |

TABLE 17

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 26 | S26 | Al—Si—Mn BASED PLATING | 95 | 4.0 | 1.0 | 10 | — | — |
| 27 | S27 | Al—Si—Mn BASED PLATING | 95 | 4.0 | 1.0 | 10 | — | — |
| 28 | S28 | Al—Si—Mn BASED PLATING | 95 | 4.0 | 1.0 | 10 | — | — |
| 29 | S29 | Al—Si—Mn BASED PLATING | 95 | 4.0 | 1.0 | 10 | — | — |
| 30 | S30 | Al—Si—Mn BASED PLATING | 95 | 4.0 | 1.0 | 10 | — | — |
| 31 | S31 | Al—Si—Mn BASED PLATING | 95 | 4.0 | 1.0 | 10 | — | — |
| 32 | S32 | Al—Si—Mn BASED PLATING | 95 | 4.0 | 1.0 | 10 | — | — |
| 33 | S33 | Al—Si—Mn BASED PLATING | 95 | 4.0 | 1.0 | 10 | — | — |
| 34 | S34 | Al—Si—Mn BASED PLATING | 95 | 4.0 | 1.0 | 10 | — | — |
| 35 | S35 | Al—Si—Mn BASED PLATING | 95 | 4.0 | 1.0 | 10 | — | — |
| 36 | S36 | Al—Si—Mn BASED PLATING | 95 | 4.0 | 1.0 | 10 | — | — |
| 37 | S37 | Al—Si—Mn BASED PLATING | 95 | 4.0 | 1.0 | 10 | — | — |
| 38 | S38 | — | — | — | — | — | — | — |
| 39 | S39 | Al—Si—Mn BASED PLATING | 95 | 4.0 | 1.0 | 10 | — | — |
| 40 | S40 | Al—Si—Mn BASED PLATING | 95 | 4.0 | 1.0 | 10 | — | — |
| 41 | S41 | — | — | — | — | — | — | — |
| 42 | S42 | Al—Si—Mn BASED PLATING | 95 | 4.0 | 1.0 | 10 | — | — |
| 43 | S43 | Al—Si—Mn BASED PLATING | 95 | 4.0 | 1.0 | 10 | — | — |
| 44 | S44 | Al—Si—Mn BASED PLATING | 95 | 4.0 | 1.0 | 10 | — | — |
| 45 | S45 | Al—Si—Mn BASED PLATING | 95 | 4.0 | 1.0 | 10 | — | — |
| 46 | S46 | Al—Si—Mn BASED PLATING | 95 | 4.0 | 1.0 | 10 | — | — |
| 47 | S47 | Al—Si—Mn BASED PLATING | 95 | 4.0 | 1.0 | 10 | — | — |
| 48 | S48 | Al—Si—Mn BASED PLATING | 95 | 4.0 | 1.0 | 10 | — | — |
| 49 | S49 | Al—Si—Mn BASED PLATING | 95 | 4.0 | 1.0 | 10 | — | — |
| 50 | S50 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 26 | — | — | 10 | 50 | 180 | 100 |
| 27 | — | — | 10 | 50 | 180 | 100 |
| 28 | — | — | 10 | 50 | 180 | 100 |
| 29 | — | — | 10 | 50 | 180 | 100 |
| 30 | — | — | 10 | 50 | 180 | 100 |
| 31 | — | — | 10 | 50 | 180 | 100 |
| 32 | — | — | 10 | 50 | 180 | 100 |
| 33 | — | — | 10 | 50 | 180 | 100 |
| 34 | — | — | 10 | 50 | 180 | 100 |
| 35 | — | — | 10 | 50 | 180 | 100 |
| 36 | — | — | 10 | 50 | 180 | 100 |
| 37 | — | — | 10 | 50 | 180 | 100 |
| 38 | — | — | — | — | — | — |
| 39 | — | — | 10 | 50 | 180 | 100 |
| 40 | — | — | 10 | 50 | 180 | 100 |
| 41 | — | — | — | — | — | — |
| 42 | — | — | 10 | 50 | 180 | 100 |
| 43 | — | — | 10 | 50 | 180 | 100 |
| 44 | — | — | 10 | 50 | 180 | 100 |
| 45 | — | — | 10 | 50 | 180 | 100 |
| 46 | — | — | 10 | 50 | 180 | 100 |
| 47 | — | — | 10 | 50 | 180 | 100 |
| 48 | — | — | 10 | 50 | 180 | 100 |
| 49 | — | — | 10 | 50 | 180 | 100 |
| 50 | — | — | 10 | 50 | 180 | 100 |

TABLE 18

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 51 | S51 | Al—Si—Mn BASED PLATING | 95 | 4.0 | 1.0 | 10 | — | — |
| 52 | S52 | Al—Si—Mn BASED PLATING | 95 | 4.0 | 1.0 | 10 | — | — |
| 53 | S53 | Al—Si—Mn BASED PLATING | 95 | 4.0 | 1.0 | 10 | — | — |
| 54 | S54 | Al—Si—Mn BASED PLATING | 95 | 4.0 | 1.0 | 10 | — | — |
| 55 | S55 | Al—Si—Mn BASED PLATING | 95 | 4.0 | 1.0 | 10 | — | — |
| 56 | S56 | Al—Si—Mn BASED PLATING | 95 | 4.0 | 1.0 | 10 | — | — |
| 57 | S57 | Al—Si—Mn BASED PLATING | 95 | 4.0 | 1.0 | 10 | — | — |
| 58 | S58 | Al—Si—Mn BASED PLATING | 95 | 4.0 | 1.0 | 10 | — | — |
| 59 | S59 | Al—Si—Mn BASED PLATING | 95 | 4.0 | 1.0 | 10 | — | — |
| 60 | S60 | Al—Si—Mn BASED PLATING | 95 | 4.0 | 1.0 | 10 | — | — |
| 61 | S61 | Al—Si—Mn BASED PLATING | 95 | 4.0 | 1.0 | 10 | — | — |
| 62 | S62 | Al—Si—Mn BASED PLATING | 95 | 4.0 | 1.0 | 10 | — | — |
| 63 | S63 | Al—Si—Mn BASED PLATING | 95 | 4.0 | 1.0 | 10 | — | — |
| 64 | S64 | Al—Si—Mn BASED PLATING | 95 | 4.0 | 1.0 | 10 | — | — |
| 65 | S65 | Al—Si—Mn BASED PLATING | 95 | 4.0 | 1.0 | 10 | — | — |
| 66 | S66 | Al—Si—Mn BASED PLATING | 95 | 4.0 | 1.0 | 10 | — | — |
| 67 | S9 | Al—Si—Mn BASED PLATING | 95 | 4.0 | 1.0 | 10 | — | — |
| 68 | S9 | Al—Si—Mn BASED PLATING | 95 | 4.0 | 1.0 | 10 | — | — |
| 69 | S9 | Al—Si—Mn BASED PLATING | 95 | 4.0 | 1.0 | 10 | — | — |
| 70 | S9 | Al—Si—Mn BASED PLATING | 95 | 4.0 | 1.0 | 10 | — | — |
| 71 | S9 | Al—Si—Mn BASED PLATING | 95 | 4.0 | 1.0 | 10 | — | — |
| 72 | S9 | Al—Si—Mn BASED PLATING | 95 | 4.0 | 1.0 | 10 | — | — |
| 73 | S9 | Al—Si—Mn BASED PLATING | 95 | 4.0 | 1.0 | 10 | — | — |
| 74 | S9 | Al—Si—Mn BASED PLATING | 95 | 4.0 | 1.0 | 10 | — | — |
| 75 | S9 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 51 | — | — | 10 | 50 | 180 | 100 |
| 52 | — | — | 10 | 50 | 180 | 100 |
| 53 | — | — | 10 | 50 | 180 | 100 |
| 54 | — | — | 10 | 50 | 180 | 100 |
| 55 | — | — | 10 | 50 | 180 | 100 |
| 56 | — | — | 10 | 50 | 180 | 100 |
| 57 | — | — | 10 | 50 | 180 | 100 |
| 58 | — | — | 10 | 50 | 180 | 100 |
| 59 | — | — | 10 | 50 | 180 | 100 |
| 60 | — | — | 10 | 50 | 180 | 100 |
| 61 | — | — | 10 | 50 | 180 | 100 |
| 62 | — | — | 10 | 50 | 180 | 100 |
| 63 | — | — | 10 | 50 | 180 | 100 |
| 64 | — | — | 10 | 50 | 180 | 100 |
| 65 | — | — | 10 | 50 | 180 | 100 |
| 66 | — | — | 10 | 50 | 180 | 100 |
| 67 | — | — | 10 | 50 | 180 | 100 |
| 68 | — | — | 10 | 50 | 180 | 100 |
| 69 | — | — | 10 | 50 | 180 | 100 |
| 70 | — | — | 10 | 50 | 180 | 100 |
| 71 | — | — | 10 | 50 | 180 | 100 |
| 72 | — | — | 10 | 50 | 180 | 100 |
| 73 | — | — | 10 | 50 | 180 | 100 |
| 74 | — | — | 10 | 50 | 180 | 100 |
| 75 | — | — | 10 | 50 | 180 | 100 |

TABLE 19

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 76 | S9 | Al—Si—Mn BASED PLATING | 95 | 4.0 | 1.0 | 10 | — | — |
| 77 | S9 | Al—Si—Mn BASED PLATING | 95 | 4.0 | 1.0 | 10 | — | — |
| 78 | S9 | Al—Si—Mn BASED PLATING | 95 | 4.0 | 1.0 | 10 | — | — |
| 79 | S9 | Al—Si—Mn BASED PLATING | 95 | 4.0 | 1.0 | 10 | — | — |
| 80 | S9 | Al—Si—Mn BASED PLATING | 95 | 4.0 | 1.0 | 10 | — | — |
| 81 | S9 | Al—Si—Mn BASED PLATING | 95 | 4.0 | 1.0 | 10 | — | — |
| 82 | S9 | None | — | — | — | — | — | — |
| 83 | S9 | Al—Si—Mn BASED PLATING | 95 | 4.0 | 1.0 | 10 | — | — |
| 84 | S9 | Al—Si—Mn BASED PLATING | 95 | 4.0 | 1.0 | 10 | — | — |
| 85 | S9 | Al—Si—Mn BASED PLATING | 95 | 4.0 | 1.0 | 10 | — | — |
| 86 | S9 | Al—Si—Mn BASED PLATING | 95 | 4.0 | 1.0 | 10 | — | — |
| 87 | S9 | Al—Si—Mn BASED PLATING | 95 | 4.0 | 1.0 | 10 | — | — |
| 88 | S9 | Al—Si—Mn BASED PLATING | 95 | 4.0 | 1.0 | 10 | — | — |
| 89 | S9 | Al—Si—Mn BASED PLATING | 95 | 4.0 | 1.0 | 10 | — | — |
| 90 | S9 | Al—Si—Mn BASED PLATING | 95 | 4.0 | 1.0 | 10 | — | — |
| 91 | S9 | Al—Si—Mn BASED PLATING | 95 | 4.0 | 1.0 | 10 | — | — |
| 92 | S9 | Al—Si—Mn BASED PLATING | 95 | 4.0 | 1.0 | 10 | — | — |
| 93 | S9 | Al—Si—Mn BASED PLATING | 95 | 4.0 | 1.0 | 10 | — | — |
| 94 | S9 | Al—Si—Mn BASED PLATING | 95 | 4.0 | 1.0 | 10 | — | — |
| 95 | S9 | Al—Si—Mn BASED PLATING | 95 | 4.0 | 1.0 | 10 | — | — |
| 96 | S9 | Al—Si—Mn BASED PLATING | 95 | 4.0 | 1.0 | 10 | — | — |
| 97 | S9 | Al—Si—Mn BASED PLATING | 95 | 4.0 | 1.0 | 10 | — | — |
| 98 | S9 | Al—Si—Mn BASED PLATING | 95 | 4.0 | 1.0 | 10 | — | — |
| 99 | S9 | Al—Si—Mn BASED PLATING | 95 | 4.0 | 1.0 | 10 | — | — |
| 100 | S9 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 76 | — | — | 10 | 50 | 180 | 100 |
| 77 | — | — | 10 | 50 | 180 | 100 |
| 78 | — | — | 10 | 50 | 180 | 100 |
| 79 | — | — | 10 | 50 | 180 | 100 |
| 80 | — | — | 10 | 50 | 180 | 100 |
| 81 | — | — | 10 | 50 | 180 | 100 |
| 82 | — | — | 10 | 50 | 180 | 100 |
| 83 | — | — | 2 | 50 | 180 | 100 |
| 84 | — | — | 20 | 50 | 180 | 100 |
| 85 | — | — | 10 | 35 | 180 | 100 |
| 86 | — | — | 10 | 65 | 180 | 100 |
| 87 | — | — | 10 | 50 | 160 | 100 |
| 88 | — | — | 10 | 50 | 200 | 100 |
| 89 | — | — | 10 | 50 | 180 | 80 |
| 90 | — | — | 10 | 50 | 180 | 120 |
| 91 | — | — | 10 | 50 | 180 | 100 |
| 92 | — | — | 10 | 50 | 180 | 100 |
| 93 | — | — | 10 | 50 | 180 | 100 |
| 94 | — | — | 10 | 50 | 180 | 100 |
| 95 | — | — | 10 | 50 | 180 | 100 |
| 96 | — | — | 10 | 50 | 180 | 100 |
| 97 | — | — | 10 | 50 | 180 | 100 |
| 98 | — | — | 10 | 50 | 180 | 100 |
| 99 | — | — | 10 | 50 | 180 | 100 |
| 100 | — | — | 10 | 50 | 180 | 100 |

TABLE 20

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 101 | S9 | Al—Si—Mn BASED PLATING | 95 | 4.0 | 1.0 | 10 | — | — |
| 102 | S9 | Al—Si—Mn BASED PLATING | 95 | 4.0 | 1.0 | 10 | — | — |
| 103 | S9 | Al—Si—Mn BASED PLATING | 95 | 4.0 | 1.0 | 10 | — | — |
| 104 | S9 | Al—Si—Mn BASED PLATING | 95 | 4.0 | 1.0 | 10 | — | — |
| 105 | S9 | Al—Si—Mn BASED PLATING | 95 | 4.0 | 1.0 | 10 | — | — |
| 106 | S9 | Al—Si—Mn BASED PLATING | 95 | 4.0 | 1.0 | 10 | — | — |
| 107 | S9 | Al—Si—Mn BASED PLATING | 95 | 4.0 | 1.0 | 10 | — | — |
| 108 | S9 | Al—Si—Mn BASED PLATING | 95 | 4.0 | 1.0 | 10 | — | — |
| 109 | S9 | Al—Si—Mn BASED PLATING | 95 | 4.0 | 1.0 | 10 | — | — |
| 110 | S9 | Al—Si—Mn BASED PLATING | 95 | 4.0 | 1.0 | 10 | — | — |
| 111 | S9 | Al—Si—Mn BASED PLATING | 95 | 4.0 | 1.0 | 10 | — | — |
| 112 | S9 | Al—Si—Mn BASED PLATING | 95 | 4.0 | 1.0 | 10 | — | — |
| 113 | S9 | Al—Si—Mn BASED PLATING | 95 | 4.0 | 1.0 | 10 | — | — |
| 114 | S9 | Al—Si—Mn BASED PLATING | 95 | 4.0 | 1.0 | 10 | — | — |
| 115 | S9 | Al—Si—Mn BASED PLATING | 95 | 4.0 | 1.0 | 10 | — | — |
| 116 | S9 | Al—Si—Mn BASED PLATING | 95 | 4.0 | 1.0 | 10 | — | — |
| 117 | S9 | Al—Si—Mn BASED PLATING | 95 | 4.0 | 1.0 | 10 | — | — |
| 118 | S9 | Al—Si—Mn BASED PLATING | 95 | 4.0 | 1.0 | 10 | — | — |
| 119 | S9 | Al—Si—Mn BASED PLATING | 95 | 4.0 | 1.0 | 10 | — | — |
| 120 | S9 | Al—Si—Mn BASED PLATING | 95 | 4.0 | 1.0 | 10 | — | — |
| 121 | S9 | Al—Si—Mn BASED PLATING | 95 | 4.0 | 1.0 | 10 | — | — |
| 122 | S9 | Al—Si—Mn BASED PLATING | 95 | 4.0 | 1.0 | 10 | — | — |
| 123 | S9 | Al—Si—Mn BASED PLATING | 95 | 4.0 | 1.0 | 10 | — | — |
| 124 | S9 | Al—Si—Mn BASED PLATING | 95 | 4.0 | 1.0 | 10 | — | — |
| 125 | S9 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 101 | — | — | 10 | 50 | 180 | 100 |
| 102 | — | — | 10 | 50 | 180 | 100 |
| 103 | — | — | 10 | 50 | 180 | 100 |
| 104 | — | — | 10 | 50 | 180 | 100 |
| 105 | — | — | 10 | 50 | 180 | 100 |
| 106 | — | — | 10 | 50 | 180 | 100 |
| 107 | — | — | 10 | 50 | 180 | 100 |
| 108 | — | — | 10 | 50 | 180 | 100 |
| 109 | — | — | 10 | 50 | 180 | 100 |
| 110 | — | — | 10 | 50 | 180 | 100 |
| 111 | — | — | 10 | 50 | 180 | 100 |
| 112 | — | — | 10 | 50 | 180 | 100 |
| 113 | — | — | 10 | 50 | 180 | 100 |
| 114 | — | — | 10 | 50 | 180 | 100 |
| 115 | — | — | 10 | 50 | 180 | 100 |
| 116 | — | — | 10 | 50 | 180 | 100 |
| 117 | — | — | 10 | 50 | 180 | 100 |
| 118 | — | — | 10 | 50 | 180 | 100 |
| 119 | — | — | 10 | 50 | 180 | 100 |
| 120 | — | — | 10 | 50 | 180 | 100 |
| 121 | — | — | 10 | 50 | 180 | 100 |
| 122 | — | — | 10 | 50 | 180 | 100 |
| 123 | — | — | 10 | 50 | 180 | 100 |
| 124 | — | — | 10 | 50 | 180 | 100 |
| 125 | — | — | 10 | 50 | 180 | 100 |

TABLE 21

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 126 | S9 | Al—Si—Mn BASED PLATING | 95 | 4.0 | 1.0 | 10 | — | — |
| 127 | S9 | Al—Si—Mn BASED PLATING | 95 | 4.0 | 1.0 | 10 | — | — |
| 128 | S9 | Al—Si—Mn BASED PLATING | 95 | 4.0 | 1.0 | 10 | — | — |
| 129 | S67 | Al—Si—Mn BASED PLATING | 85 | 10.0 | 5.0 | 10 | — | — |
| 130 | S68 | Al—Mn BASED PLATING | 95 | 0 | 5.0 | 10 | — | — |
| 131 | S69 | Al—Si—Mn BASED PLATING | 87 | 12.0 | 1.0 | 10 | — | — |
| 132 | S70 | Al—Si BASED PLATING | 96 | 4.0 | 0 | 10 | — | — |
| 133 | S71 | Al—Si—Mn BASED PLATING | 91 | 3.5 | 5.5 | 10 | — | — |
| 134 | S72 | Al—Si—Mn BASED PLATING | 95 | 4.0 | 1.0 | 2 | — | — |
| 135 | S73 | Al—Si—Mn BASED PLATING | 95 | 4.0 | 1.0 | 37 | — | — |
| 136 | S74 | None | — | — | — | — | 100 | −25 |
| 137 | S9 | Al—Si—Mn BASED PLATING | 95 | 4.0 | 1.0 | 10 | — | — |
| 138 | S75 | Al—Si—Mn BASED PLATING | 95 | 4.0 | 1.0 | 10 | — | — |
| 139 | S76 | Al—Si—Mn BASED PLATING | 95 | 4.0 | 1.0 | 10 | — | — |
| 140 | S9 | — | — | — | — | — | — | — |
| 141 | S9 | Al—Si—Mn BASED PLATING | 95 | 4.0 | 1.0 | 10 | — | — |
| 142 | S9 | Al—Si—Mn BASED PLATING | 95 | 4.0 | 1.0 | 10 | — | — |
| 143 | S9 | Al—Si—Mn BASED PLATING | 95 | 4.0 | 1.0 | 10 | — | — |
| 144 | S9 | Al—Si—Mn BASED PLATING | 95 | 4.0 | 1.0 | 10 | — | — |
| 145 | S9 | Al—Si—Mn BASED PLATING | 95 | 4.0 | 1.0 | 10 | — | — |
| 146 | S9 | Al—Si—Mn BASED PLATING | 95 | 4.0 | 1.0 | 10 | — | — |
| 147 | S9 | Al—Si—Mn BASED PLATING | 95 | 4.0 | 1.0 | 10 | — | — |
| 148 | S9 | Al—Si—Mn BASED PLATING | 95 | 4.0 | 1.0 | 10 | — | — |
| 149 | S9 | Al—Si—Mn BASED PLATING | 95 | 4.0 | 1.0 | 10 | — | — |
| 150 | S9 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 126 | — | — | 10 | 50 | 180 | 100 |
| 127 | — | — | 10 | 50 | 180 | 100 |
| 128 | — | — | 10 | 50 | 180 | 100 |
| 129 | — | — | 10 | 50 | 180 | 100 |
| 130 | — | — | 10 | 50 | 180 | 100 |
| 131 | — | — | 10 | 50 | 180 | 100 |
| 132 | — | — | 10 | 50 | 180 | 100 |
| 133 | — | — | 10 | 50 | 180 | 100 |
| 134 | — | — | 10 | 50 | 180 | 100 |
| 135 | — | — | 10 | 50 | 180 | 100 |
| 136 | 770 | 80 | 10 | 50 | 180 | 100 |
| 137 | — | — | 10 | 50 | 180 | 100 |
| 138 | — | — | 10 | 50 | 180 | 100 |
| 139 | — | — | 10 | 50 | 180 | 100 |
| 140 | — | — | — | — | — | — |
| 141 | — | — | 7 | 50 | 180 | 100 |
| 142 | — | — | 9 | 50 | 180 | 100 |
| 143 | — | — | 11 | 50 | 180 | 100 |
| 144 | — | — | 13 | 50 | 180 | 100 |
| 145 | — | — | 10 | 42 | 180 | 100 |
| 146 | — | — | 10 | 44 | 180 | 100 |
| 147 | — | — | 10 | 56 | 180 | 100 |
| 148 | — | — | 10 | 58 | 180 | 100 |
| 149 | — | — | 10 | 50 | 175 | 100 |
| 150 | — | — | 10 | 50 | 185 | 100 |

TABLE 22

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 151 | S9 | Al—Si—Mn BASED PLATING | 95 | 4.0 | 1.0 | 10 | — | — |
| 152 | S9 | Al—Si—Mn BASED PLATING | 95 | 4.0 | 1.0 | 10 | — | — |
| 153 | S9 | Al—Si—Mn BASED PLATING | 95 | 4.0 | 1.0 | 10 | — | — |
| 154 | S9 | Al—Si—Mn BASED PLATING | 95 | 4.0 | 1.0 | 10 | — | — |
| 155 | S9 | Al—Si—Mn BASED PLATING | 95 | 4.0 | 1.0 | 10 | — | — |
| 156 | S9 | Al—Si—Mn BASED PLATING | 95 | 4.0 | 1.0 | 10 | — | — |
| 157 | S9 | Al—Si—Mn BASED PLATING | 95 | 4.0 | 1.0 | 10 | — | — |
| 158 | S9 | Al—Si—Mn BASED PLATING | 95 | 4.0 | 1.0 | 10 | — | — |
| 159 | S9 | Al—Si—Mn BASED PLATING | 95 | 4.0 | 1.0 | 10 | — | — |
| 160 | S9 | Al—Si—Mn BASED PLATING | 95 | 4.0 | 1.0 | 10 | — | — |
| 161 | S9 | Al—Si—Mn BASED PLATING | 95 | 4.0 | 1.0 | 10 | — | — |
| 162 | S9 | Al—Si—Mn BASED PLATING | 95 | 4.0 | 1.0 | 10 | — | — |
| 163 | S9 | Al—Si—Mn BASED PLATING | 95 | 4.0 | 1.0 | 10 | — | — |
| 164 | S9 | Al—Si—Mn BASED PLATING | 95 | 4.0 | 1.0 | 10 | — | — |
| 165 | S9 | Al—Si—Mn BASED PLATING | 95 | 4.0 | 1.0 | 10 | — | — |
| 166 | S9 | Al—Si—Mn BASED PLATING | 95 | 4.0 | 1.0 | 10 | — | — |
| 167 | S9 | Al—Si—Mn BASED PLATING | 95 | 4.0 | 1.0 | 10 | — | — |
| 168 | S9 | Al—Si—Mn BASED PLATING | 95 | 4.0 | 1.0 | 10 | — | — |
| 169 | S9 | Al—Si—Mn BASED PLATING | 95 | 4.0 | 1.0 | 10 | — | — |
| 170 | S9 | Al—Si—Mn BASED PLATING | 95 | 4.0 | 1.0 | 10 | — | — |
| 171 | S9 | Al—Si—Mn BASED PLATING | 95 | 4.0 | 1.0 | 10 | — | — |
| 172 | S9 | Al—Si—Mn BASED PLATING | 95 | 4.0 | 1.0 | 10 | — | — |
| 173 | S9 | Al—Si—Mn BASED PLATING | 95 | 4.0 | 1.0 | 10 | — | — |
| 174 | S9 | Al—Si—Mn BASED PLATING | 95 | 4.0 | 1.0 | 10 | — | — |
| 175 | S9 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 151 | — | — | 10 | 50 | 180 | 95 |
| 152 | — | — | 10 | 50 | 180 | 105 |
| 153 | — | — | 10 | 50 | 180 | 100 |
| 154 | — | — | 10 | 50 | 180 | 100 |
| 155 | — | — | 10 | 50 | 180 | 100 |
| 156 | — | — | 10 | 50 | 180 | 100 |
| 157 | — | — | 10 | 50 | 180 | 100 |
| 158 | — | — | 10 | 50 | 180 | 100 |
| 159 | — | — | 10 | 50 | 180 | 100 |
| 160 | — | — | 10 | 50 | 180 | 100 |
| 161 | — | — | 10 | 50 | 180 | 100 |
| 162 | — | — | 10 | 50 | 180 | 100 |
| 163 | — | — | 10 | 50 | 180 | 100 |
| 164 | — | — | 10 | 50 | 180 | 100 |
| 165 | — | — | 10 | 50 | 180 | 100 |
| 166 | — | — | 10 | 50 | 180 | 100 |
| 167 | — | — | 10 | 50 | 180 | 100 |
| 168 | — | — | 10 | 50 | 180 | 100 |
| 169 | — | — | 10 | 50 | 180 | 100 |
| 170 | — | — | 10 | 50 | 180 | 100 |
| 171 | — | — | 10 | 50 | 180 | 100 |
| 172 | — | — | 10 | 50 | 180 | 100 |
| 173 | — | — | 10 | 50 | 180 | 100 |
| 174 | — | — | 10 | 50 | 180 | 100 |
| 175 | — | — | 10 | 50 | 180 | 100 |

TABLE 23

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 176 | S9 | Al—Si—Mn BASED PLATING | 95 | 4.0 | 1.0 | 10 | — | — |
| 177 | S9 | Al—Si—Mn BASED PLATING | 95 | 4.0 | 1.0 | 10 | — | — |
| 178 | S9 | Al—Si—Mn BASED PLATING | 95 | 4.0 | 1.0 | 10 | — | — |
| 179 | S9 | Al—Si—Mn BASED PLATING | 95 | 4.0 | 1.0 | 10 | — | — |
| 180 | S9 | Al—Si—Mn BASED PLATING | 95 | 4.0 | 1.0 | 10 | — | — |
| 181 | S9 | Al—Si—Mn BASED PLATING | 95 | 4.0 | 1.0 | 10 | — | — |
| 182 | S9 | Al—Si—Mn BASED PLATING | 95 | 4.0 | 1.0 | 10 | — | — |
| 183 | S9 | Al—Si—Mn BASED PLATING | 95 | 4.0 | 1.0 | 10 | — | — |
| 184 | S9 | Al—Si—Mn BASED PLATING | 95 | 4.0 | 1.0 | 10 | — | — |
| 185 | S9 | Al—Si—Mn BASED PLATING | 95 | 4.0 | 1.0 | 10 | — | — |
| 186 | S9 | Al—Si—Mn BASED PLATING | 95 | 4.0 | 1.0 | 10 | — | — |
| 187 | S9 | Al—Si—Mn BASED PLATING | 95 | 4.0 | 1.0 | 10 | — | — |
| 188 | S9 | Al—Si—Mn BASED PLATING | 95 | 4.0 | 1.0 | 10 | — | — |
| 189 | S9 | Al—Si—Mn BASED PLATING | 95 | 4.0 | 1.0 | 10 | — | — |
| 190 | S9 | Al—Si—Mn BASED PLATING | 95 | 4.0 | 1.0 | 10 | — | — |
| 191 | S9 | Al—Si—Mn BASED PLATING | 95 | 4.0 | 1.0 | 10 | — | — |
| 192 | S9 | Al—Si—Mn BASED PLATING | 95 | 4.0 | 1.0 | 10 | — | — |
| 193 | S9 | Al—Si—Mn BASED PLATING | 95 | 4.0 | 1.0 | 10 | — | — |
| 194 | S9 | Al—Si—Mn BASED PLATING | 95 | 4.0 | 1.0 | 10 | — | — |
| 195 | S9 | Al—Si—Mn BASED PLATING | 95 | 4.0 | 1.0 | 10 | — | — |
| 196 | S9 | Al—Si—Mn BASED PLATING | 95 | 4.0 | 1.0 | 10 | — | — |
| 197 | S9 | Al—Si—Mn BASED PLATING | 95 | 4.0 | 1.0 | 10 | — | — |
| 198 | S9 | Al—Si—Mn BASED PLATING | 95 | 4.0 | 1.0 | 10 | — | — |
| 199 | S9 | Al—Si—Mn BASED PLATING | 95 | 4.0 | 1.0 | 10 | — | — |
| 200 | S9 | Al—Si—Mn BASED PLATING | 95 | 4.0 | 1.0 | 10 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 176 | — | — | 10 | 50 | 180 | 100 |
| 177 | — | — | 10 | 50 | 180 | 100 |
| 178 | — | — | 10 | 50 | 180 | 100 |
| 179 | — | — | 10 | 50 | 180 | 100 |
| 180 | — | — | 10 | 50 | 180 | 100 |
| 181 | — | — | 10 | 50 | 180 | 100 |
| 182 | — | — | 10 | 50 | 180 | 100 |
| 183 | — | — | 10 | 50 | 180 | 100 |
| 184 | — | — | 10 | 50 | 180 | 100 |
| 185 | — | — | 10 | 50 | 180 | 100 |
| 186 | — | — | 10 | 50 | 180 | 100 |
| 187 | — | — | 10 | 50 | 180 | 100 |
| 188 | — | — | 10 | 50 | 180 | 100 |
| 189 | — | — | 10 | 50 | 180 | 100 |
| 190 | — | — | 10 | 50 | 180 | 100 |
| 191 | — | — | 10 | 50 | 180 | 100 |
| 192 | — | — | 10 | 50 | 180 | 100 |
| 193 | — | — | 10 | 50 | 180 | 100 |
| 194 | — | — | 10 | 50 | 180 | 100 |
| 195 | — | — | 10 | 50 | 180 | 100 |
| 196 | — | — | 10 | 50 | 180 | 100 |
| 197 | — | — | 10 | 50 | 180 | 100 |
| 198 | — | — | 10 | 50 | 180 | 100 |
| 199 | — | — | 10 | 50 | 180 | 100 |
| 200 | — | — | 10 | 50 | 180 | 100 |

TABLE 24

| | | MANUFACTURING CONDITIONS | | | | | | |
|---|---|---|---|---|---|---|---|---|
| | | | | | | | NITRIDING ANNEALING | |
| | | SURFACE TREATMENT | | | | | ATMOSPHERE | |
| | | PLATING | | | | | | DEW |
| | STEEL | | Al | Si | Mn | THICKNESS | NITROGEN | POINT |
| No. | TYPE | TYPE OF PLATING | mass % | mass % | mass % | μm | vol % | ° C. |
| 201 | S9 | Al—Si—Mn BASED PLATING | 95 | 4.0 | 1.0 | 10 | — | — |
| 202 | S9 | Al—Si—Mn BASED PLATING | 95 | 4.0 | 1.0 | 10 | — | — |
| 203 | S9 | Al—Si—Mn BASED PLATING | 95 | 4.0 | 1.0 | 10 | — | — |
| 204 | S9 | Al—Si—Mn BASED PLATING | 95 | 4.0 | 1.0 | 10 | — | — |
| 205 | S9 | Al—Si—Mn BASED PLATING | 95 | 4.0 | 1.0 | 10 | — | — |
| 206 | S9 | Al—Si—Mn BASED PLATING | 95 | 4.0 | 1.0 | 10 | — | — |
| 207 | S9 | Al—Si—Mn BASED PLATING | 95 | 4.0 | 1.0 | 10 | — | — |
| 208 | S9 | Al—Si—Mn BASED PLATING | 95 | 4.0 | 1.0 | 10 | — | — |
| 209 | S9 | Al—Si—Mn BASED PLATING | 95 | 4.0 | 1.0 | 10 | — | — |
| 210 | S9 | Al—Si—Mn BASED PLATING | 95 | 4.0 | 1.0 | 10 | — | — |
| 211 | S9 | Al—Si—Mn BASED PLATING | 95 | 4.0 | 1.0 | 10 | — | — |
| 212 | S9 | Al—Si—Mn BASED PLATING | 95 | 4.0 | 1.0 | 10 | — | — |
| 213 | S9 | Al—Si—Mn BASED PLATING | 95 | 4.0 | 1.0 | 10 | — | — |
| 214 | S67 | Al—Si—Mn BASED PLATING | 90 | 9.0 | 1.0 | 15 | — | — |

| | MANUFACTURING CONDITIONS | | | | | |
|---|---|---|---|---|---|---|
| | | | FINAL ANNEALING | | | |
| | | | OXIDATION STAGE | | | |
| | NITRIDING ANNEALING | | ATMOSPHERE | | | |
| | HOLDING | HOLDING | | DEW | HOLDING | HOLDING |
| | TEMPERATURE | TIME | HYDROGEN | POINT | TEMPERATURE | TIME |
| No. | ° C. | sec. | vol % | ° C. | ° C. | sec. |
| 201 | — | — | 10 | 50 | 180 | 100 |
| 202 | — | — | 10 | 50 | 180 | 100 |
| 203 | — | — | 10 | 50 | 180 | 100 |
| 204 | — | — | 10 | 50 | 180 | 100 |
| 205 | — | — | 10 | 50 | 180 | 100 |
| 206 | — | — | 10 | 50 | 180 | 100 |
| 207 | — | — | 10 | 50 | 180 | 100 |
| 208 | — | — | 10 | 50 | 180 | 100 |
| 209 | — | — | 10 | 50 | 180 | 100 |
| 210 | — | — | 10 | 50 | 180 | 100 |
| 211 | — | — | 10 | 50 | 180 | 100 |
| 212 | — | — | 10 | 50 | 180 | 100 |
| 213 | — | — | 10 | 50 | 180 | 100 |
| 214 | — | — | 10 | 50 | 180 | 100 |

TABLE 25

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 1 | S1 | 10 | 50 | 50 | 700 | 10 | 10 |
| 2 | S2 | 10 | 50 | 50 | 700 | 10 | 10 |
| 3 | S3 | 10 | 50 | 50 | 700 | 10 | 10 |
| 4 | S4 | 10 | 50 | 50 | 700 | 10 | 10 |
| 5 | S5 | 10 | 50 | 50 | 700 | 10 | 10 |
| 6 | S6 | 10 | 50 | 50 | 700 | 10 | 10 |
| 7 | S7 | 10 | 50 | 50 | 700 | 10 | 10 |
| 8 | S8 | 10 | 50 | 50 | 700 | 10 | 10 |
| 9 | S9 | 10 | 50 | 50 | 700 | 10 | 10 |
| 10 | S10 | 10 | 50 | 50 | 700 | 10 | 10 |
| 11 | S11 | 10 | 50 | 50 | 700 | 10 | 10 |
| 12 | S12 | 10 | 50 | 50 | 700 | 10 | 10 |
| 13 | S13 | 10 | 50 | 50 | 700 | 10 | 10 |
| 14 | S14 | 10 | 50 | 50 | 700 | 10 | 10 |
| 15 | S15 | 10 | 50 | 50 | 700 | 10 | 10 |
| 16 | S16 | — | — | — | — | — | — |
| 17 | S17 | 10 | 50 | 50 | 700 | 10 | 10 |
| 18 | S18 | 10 | 50 | 50 | 700 | 10 | 10 |
| 19 | S19 | 10 | 50 | 50 | 700 | 10 | 10 |
| 20 | S20 | 10 | 50 | 50 | 700 | 10 | 10 |
| 21 | S21 | — | — | — | — | — | — |
| 22 | S22 | 10 | 50 | 50 | 700 | 10 | 10 |
| 23 | S23 | 10 | 50 | 50 | 700 | 10 | 10 |
| 24 | S24 | 10 | 50 | 50 | 700 | 10 | 10 |
| 25 | S25 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 1 | 50 | 850 | 10 | 10 | 850 | 15 |
| 2 | 50 | 850 | 10 | 10 | 850 | 15 |
| 3 | 50 | 850 | 10 | 10 | 850 | 15 |
| 4 | 50 | 850 | 10 | 10 | 850 | 15 |
| 5 | 50 | 850 | 10 | 10 | 850 | 15 |
| 6 | 50 | 850 | 10 | 10 | 850 | 15 |
| 7 | 50 | 850 | 10 | 10 | 850 | 15 |
| 8 | 50 | 850 | 10 | 10 | 850 | 15 |
| 9 | 50 | 850 | 10 | 10 | 850 | 15 |
| 10 | 50 | 850 | 10 | 10 | 850 | 15 |
| 11 | 50 | 850 | 10 | 10 | 850 | 15 |
| 12 | 50 | 850 | 10 | 10 | 850 | 15 |
| 13 | 50 | 850 | 10 | 10 | 850 | 15 |
| 14 | 50 | 850 | 10 | 10 | 850 | 15 |
| 15 | 50 | 850 | 10 | 10 | 850 | 15 |
| 16 | — | — | — | — | — | — |
| 17 | 50 | 850 | 10 | 10 | 850 | 15 |
| 18 | 50 | 850 | 10 | 10 | 850 | 15 |
| 19 | 50 | 850 | 10 | 10 | 850 | 15 |
| 20 | 50 | 850 | 10 | 10 | 850 | 15 |
| 21 | — | — | — | — | — | — |
| 22 | 50 | 850 | 10 | 10 | 850 | 15 |
| 23 | 50 | 850 | 10 | 10 | 850 | 15 |
| 24 | 50 | 850 | 10 | 10 | 850 | 15 |
| 25 | 50 | 850 | 10 | 10 | 850 | 15 |

TABLE 26

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 26 | S26 | 10 | 50 | 50 | 700 | 10 | 10 |
| 27 | S27 | 10 | 50 | 50 | 700 | 10 | 10 |
| 28 | S28 | 10 | 50 | 50 | 700 | 10 | 10 |
| 29 | S29 | 10 | 50 | 50 | 700 | 10 | 10 |
| 30 | S30 | 10 | 50 | 50 | 700 | 10 | 10 |
| 31 | S31 | 10 | 50 | 50 | 700 | 10 | 10 |
| 32 | S32 | 10 | 50 | 50 | 700 | 10 | 10 |
| 33 | S33 | 10 | 50 | 50 | 700 | 10 | 10 |
| 34 | S34 | 10 | 50 | 50 | 700 | 10 | 10 |
| 35 | S35 | 10 | 50 | 50 | 700 | 10 | 10 |
| 36 | S36 | 10 | 50 | 50 | 700 | 10 | 10 |
| 37 | S37 | 10 | 50 | 50 | 700 | 10 | 10 |
| 38 | S38 | — | — | — | — | — | — |
| 39 | S39 | 10 | 50 | 50 | 700 | 10 | 10 |
| 40 | S40 | 10 | 50 | 50 | 700 | 10 | 10 |
| 41 | S41 | — | — | — | — | — | — |
| 42 | S42 | 10 | 50 | 50 | 700 | 10 | 10 |
| 43 | S43 | 10 | 50 | 50 | 700 | 10 | 10 |
| 44 | S44 | 10 | 50 | 50 | 700 | 10 | 10 |
| 45 | S45 | 10 | 50 | 50 | 700 | 10 | 10 |
| 46 | S46 | 10 | 50 | 50 | 700 | 10 | 10 |
| 47 | S47 | 10 | 50 | 50 | 700 | 10 | 10 |
| 48 | S48 | 10 | 50 | 50 | 700 | 10 | 10 |
| 49 | S49 | 10 | 50 | 50 | 700 | 10 | 10 |
| 50 | S50 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 26 | 50 | 850 | 10 | 10 | 850 | 15 |
| 27 | 50 | 850 | 10 | 10 | 850 | 15 |
| 28 | 50 | 850 | 10 | 10 | 850 | 15 |
| 29 | 50 | 850 | 10 | 10 | 850 | 15 |
| 30 | 50 | 850 | 10 | 10 | 850 | 15 |
| 31 | 50 | 850 | 10 | 10 | 850 | 15 |
| 32 | 50 | 850 | 10 | 10 | 850 | 15 |
| 33 | 50 | 850 | 10 | 10 | 850 | 15 |
| 34 | 50 | 850 | 10 | 10 | 850 | 15 |
| 35 | 50 | 850 | 10 | 10 | 850 | 15 |
| 36 | 50 | 850 | 10 | 10 | 850 | 15 |
| 37 | 50 | 850 | 10 | 10 | 850 | 15 |
| 38 | — | — | — | — | — | — |
| 39 | 50 | 850 | 10 | 10 | 850 | 15 |
| 40 | 50 | 850 | 10 | 10 | 850 | 15 |
| 41 | — | — | — | — | — | — |
| 42 | 50 | 850 | 10 | 10 | 850 | 15 |
| 43 | 50 | 850 | 10 | 10 | 850 | 15 |
| 44 | 50 | 850 | 10 | 10 | 850 | 15 |
| 45 | 50 | 850 | 10 | 10 | 850 | 15 |
| 46 | 50 | 850 | 10 | 10 | 850 | 15 |
| 47 | 50 | 850 | 10 | 10 | 850 | 15 |
| 48 | 50 | 850 | 10 | 10 | 850 | 15 |
| 49 | 50 | 850 | 10 | 10 | 850 | 15 |
| 50 | 50 | 850 | 10 | 10 | 850 | 15 |

TABLE 27

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 51 | S51 | 10 | 50 | 50 | 700 | 10 | 10 |
| 52 | S52 | 10 | 50 | 50 | 700 | 10 | 10 |
| 53 | S53 | 10 | 50 | 50 | 700 | 10 | 10 |
| 54 | S54 | 10 | 50 | 50 | 700 | 10 | 10 |
| 55 | S55 | 10 | 50 | 50 | 700 | 10 | 10 |
| 56 | S56 | 10 | 50 | 50 | 700 | 10 | 10 |
| 57 | S57 | 10 | 50 | 50 | 700 | 10 | 10 |
| 58 | S58 | 10 | 50 | 50 | 700 | 10 | 10 |
| 59 | S59 | 10 | 50 | 50 | 700 | 10 | 10 |
| 60 | S60 | 10 | 50 | 50 | 700 | 10 | 10 |
| 61 | S61 | 10 | 50 | 50 | 700 | 10 | 10 |
| 62 | S62 | 10 | 50 | 50 | 700 | 10 | 10 |
| 63 | S63 | 10 | 50 | 50 | 700 | 10 | 10 |
| 64 | S64 | 10 | 50 | 50 | 700 | 10 | 10 |
| 65 | S65 | 10 | 50 | 50 | 700 | 10 | 10 |
| 66 | S66 | 10 | 50 | 50 | 700 | 10 | 10 |
| 67 | S9 | 10 | 50 | 50 | 700 | 10 | 10 |
| 68 | S9 | 10 | 50 | 50 | 700 | 10 | 10 |
| 69 | S9 | 10 | 50 | 50 | 700 | 10 | 10 |
| 70 | S9 | 10 | 50 | 50 | 700 | 10 | 10 |
| 71 | S9 | 10 | 50 | 50 | 700 | 10 | 10 |
| 72 | S9 | 10 | 50 | 50 | 700 | 10 | 10 |
| 73 | S9 | 10 | 50 | 50 | 700 | 10 | 10 |
| 74 | S9 | 10 | 50 | 50 | 700 | 10 | 10 |
| 75 | S9 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 51 | 50 | 850 | 10 | 10 | 850 | 15 |
| 52 | 50 | 850 | 10 | 10 | 850 | 15 |
| 53 | 50 | 850 | 10 | 10 | 850 | 15 |
| 54 | 50 | 850 | 10 | 10 | 850 | 15 |
| 55 | 50 | 850 | 10 | 10 | 850 | 15 |
| 56 | 50 | 850 | 10 | 10 | 850 | 15 |
| 57 | 50 | 850 | 10 | 10 | 850 | 15 |
| 58 | 50 | 850 | 10 | 10 | 850 | 15 |
| 59 | 50 | 850 | 10 | 10 | 850 | 15 |
| 60 | 50 | 850 | 10 | 10 | 850 | 15 |
| 61 | 50 | 850 | 10 | 10 | 850 | 15 |
| 62 | 50 | 850 | 10 | 10 | 850 | 15 |
| 63 | 50 | 850 | 10 | 10 | 850 | 15 |
| 64 | 50 | 850 | 10 | 10 | 850 | 15 |
| 65 | 50 | 850 | 10 | 10 | 850 | 15 |
| 66 | 50 | 850 | 10 | 10 | 850 | 15 |
| 67 | 50 | 850 | 10 | 10 | 850 | 15 |
| 68 | 50 | 850 | 10 | 10 | 850 | 15 |
| 69 | 50 | 850 | 10 | 10 | 850 | 15 |
| 70 | 50 | 850 | 10 | 10 | 850 | 15 |
| 71 | 50 | 850 | 10 | 10 | 850 | 15 |
| 72 | 50 | 850 | 10 | 10 | 850 | 15 |
| 73 | 50 | 850 | 10 | 10 | 850 | 15 |
| 74 | 50 | 850 | 10 | 10 | 850 | 15 |
| 75 | 50 | 850 | 10 | 10 | 850 | 15 |

TABLE 28

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 76 | S9 | 10 | 50 | 50 | 700 | 10 | 10 |
| 77 | S9 | 10 | 50 | 50 | 700 | 10 | 10 |
| 78 | S9 | 10 | 50 | 50 | 700 | 10 | 10 |
| 79 | S9 | 10 | 50 | 50 | 700 | 10 | 10 |
| 80 | S9 | 10 | 50 | 50 | 700 | 10 | 10 |
| 81 | S9 | 10 | 50 | 50 | 700 | 10 | 10 |
| 82 | S9 | 10 | 50 | 50 | 700 | 10 | 10 |
| 83 | S9 | 10 | 50 | 50 | 700 | 10 | 10 |
| 84 | S9 | 10 | 50 | 50 | 700 | 10 | 10 |
| 85 | S9 | 10 | 50 | 50 | 700 | 10 | 10 |
| 86 | S9 | 10 | 50 | 50 | 700 | 10 | 10 |
| 87 | S9 | 10 | 50 | 50 | 700 | 10 | 10 |
| 88 | S9 | 10 | 50 | 50 | 700 | 10 | 10 |
| 89 | S9 | 10 | 50 | 50 | 700 | 10 | 10 |
| 90 | S9 | 10 | 50 | 50 | 700 | 10 | 10 |
| 91 | S9 | 2 | 50 | 50 | 700 | 10 | 10 |
| 92 | S9 | 20 | 50 | 50 | 700 | 10 | 10 |
| 93 | S9 | 10 | 35 | 50 | 700 | 10 | 10 |
| 94 | S9 | 10 | 65 | 50 | 700 | 10 | 10 |
| 95 | S9 | 10 | 50 | 30 | 700 | 10 | 10 |
| 96 | S9 | 10 | 50 | 70 | 700 | 10 | 10 |
| 97 | S9 | 10 | 50 | 50 | 650 | 10 | 10 |
| 98 | S9 | 10 | 50 | 50 | 750 | 10 | 10 |
| 99 | S9 | 10 | 50 | 50 | 700 | 2 | 10 |
| 100 | S9 | 10 | 50 | 50 | 700 | 30 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 76 | 50 | 850 | 10 | 10 | 850 | 15 |
| 77 | 50 | 850 | 10 | 10 | 850 | 15 |
| 78 | 50 | 850 | 10 | 10 | 850 | 15 |
| 79 | 50 | 850 | 10 | 10 | 850 | 15 |
| 80 | 50 | 850 | 10 | 10 | 850 | 15 |
| 81 | 50 | 850 | 10 | 10 | 850 | 15 |
| 82 | 50 | 850 | 10 | 10 | 850 | 15 |
| 83 | 50 | 850 | 10 | 10 | 850 | 15 |
| 84 | 50 | 850 | 10 | 10 | 850 | 15 |
| 85 | 50 | 850 | 10 | 10 | 850 | 15 |
| 86 | 50 | 850 | 10 | 10 | 850 | 15 |
| 87 | 50 | 850 | 10 | 10 | 850 | 15 |
| 88 | 50 | 850 | 10 | 10 | 850 | 15 |
| 89 | 50 | 850 | 10 | 10 | 850 | 15 |
| 90 | 50 | 850 | 10 | 10 | 850 | 15 |
| 91 | 50 | 850 | 10 | 10 | 850 | 15 |
| 92 | 50 | 850 | 10 | 10 | 850 | 15 |
| 93 | 50 | 850 | 10 | 10 | 850 | 15 |
| 94 | 50 | 850 | 10 | 10 | 850 | 15 |
| 95 | 50 | 850 | 10 | 10 | 850 | 15 |
| 96 | 50 | 850 | 10 | 10 | 850 | 15 |
| 97 | 50 | 850 | 10 | 10 | 850 | 15 |
| 98 | 50 | 850 | 10 | 10 | 850 | 15 |
| 99 | 50 | 850 | 10 | 10 | 850 | 15 |
| 100 | 50 | 850 | 10 | 10 | 850 | 15 |

TABLE 29

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 101 | S9 | 10 | 50 | 50 | 700 | 10 | −25 |
| 102 | S9 | 10 | 50 | 50 | 700 | 10 | 25 |
| 103 | S9 | 10 | 50 | 50 | 700 | 10 | 10 |
| 104 | S9 | 10 | 50 | 50 | 700 | 10 | 10 |
| 105 | S9 | 10 | 50 | 50 | 700 | 10 | 10 |
| 106 | S9 | 10 | 50 | 50 | 700 | 10 | 10 |
| 107 | S9 | 10 | 50 | 50 | 700 | 10 | 10 |
| 108 | S9 | 10 | 50 | 50 | 700 | 10 | 10 |
| 109 | S9 | 10 | 50 | 50 | 700 | 10 | 10 |
| 110 | S9 | 10 | 50 | 50 | 700 | 10 | 10 |
| 111 | S9 | 10 | 50 | 50 | 700 | 10 | 10 |
| 112 | S9 | 10 | 50 | 50 | 700 | 10 | 10 |
| 113 | S9 | 10 | 50 | 50 | 700 | 10 | 10 |
| 114 | S9 | 10 | 50 | 50 | 700 | 10 | 10 |
| 115 | S9 | 10 | 50 | 50 | 700 | 10 | 10 |
| 116 | S9 | 10 | 50 | 50 | 700 | 10 | 10 |
| 117 | S9 | 10 | 50 | 50 | 700 | 10 | 10 |
| 118 | S9 | 10 | 50 | 50 | 700 | 10 | 10 |
| 119 | S9 | 10 | 50 | 50 | 700 | 10 | 10 |
| 120 | S9 | 10 | 50 | 50 | 700 | 10 | 10 |
| 121 | S9 | 10 | 50 | 50 | 700 | 10 | 10 |
| 122 | S9 | 10 | 50 | 50 | 700 | 10 | 10 |
| 123 | S9 | 10 | 50 | 50 | 700 | 10 | 10 |
| 124 | S9 | 10 | 50 | 50 | 700 | 10 | 10 |
| 125 | S9 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 101 | 50 | 850 | 10 | 10 | 850 | 15 |
| 102 | 50 | 850 | 10 | 10 | 850 | 15 |
| 103 | 35 | 850 | 10 | 10 | 850 | 15 |
| 104 | 65 | 850 | 10 | 10 | 850 | 15 |
| 105 | 50 | 750 | 10 | 10 | 750 | 15 |
| 106 | 50 | 1075 | 10 | 10 | 1075 | 15 |
| 107 | 50 | 850 | 2 | 10 | 850 | 15 |
| 108 | 50 | 850 | 30 | 10 | 850 | 15 |
| 109 | 50 | 850 | 10 | −25 | 850 | 15 |
| 110 | 50 | 850 | 10 | 25 | 850 | 15 |
| 111 | 50 | 850 | 10 | 10 | 850 | 5 |
| 112 | 50 | 850 | 10 | 10 | 850 | 30 |
| 113 | 50 | 850 | 10 | 10 | 850 | 15 |
| 114 | 50 | 850 | 10 | 10 | 850 | 15 |
| 115 | 50 | 850 | 10 | 10 | 850 | 15 |
| 116 | 50 | 850 | 10 | 10 | 850 | 15 |
| 117 | 50 | 850 | 10 | 10 | 850 | 15 |
| 118 | 50 | 850 | 10 | 10 | 850 | 15 |
| 119 | 50 | 850 | 10 | 10 | 850 | 15 |
| 120 | 50 | 850 | 10 | 10 | 850 | 15 |
| 121 | 50 | 850 | 10 | 10 | 850 | 15 |
| 122 | 50 | 850 | 10 | 10 | 850 | 15 |
| 123 | 50 | 850 | 10 | 10 | 850 | 15 |
| 124 | 50 | 850 | 10 | 10 | 850 | 15 |
| 125 | 50 | 850 | 10 | 10 | 850 | 15 |

TABLE 30

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 126 | S9 | 10 | 50 | 50 | 700 | 10 | 10 |
| 127 | S9 | 10 | 50 | 50 | 700 | 10 | 10 |
| 128 | S9 | 10 | 50 | 50 | 700 | 10 | 10 |
| 129 | S67 | 10 | 50 | 50 | 700 | 10 | 10 |
| 130 | S68 | 10 | 50 | 50 | 700 | 10 | 10 |
| 131 | S69 | 10 | 50 | 50 | 700 | 10 | 10 |
| 132 | S70 | 10 | 50 | 50 | 700 | 10 | 10 |
| 133 | S71 | 10 | 50 | 50 | 700 | 10 | 10 |
| 134 | S72 | 10 | 50 | 50 | 700 | 10 | 10 |
| 135 | S73 | 10 | 50 | 50 | 700 | 10 | 10 |
| 136 | S74 | 10 | 50 | 50 | 700 | 10 | 10 |
| 137 | S9 | 10 | 50 | 50 | 700 | 10 | 10 |
| 138 | S75 | 10 | 50 | 50 | 700 | 10 | 10 |
| 139 | S76 | 10 | 50 | 50 | 700 | 10 | 10 |
| 140 | S9 | — | — | — | — | — | — |
| 141 | S9 | 10 | 50 | 50 | 700 | 10 | 10 |
| 142 | S9 | 10 | 50 | 50 | 700 | 10 | 10 |
| 143 | S9 | 10 | 50 | 50 | 700 | 10 | 10 |
| 144 | S9 | 10 | 50 | 50 | 700 | 10 | 10 |
| 145 | S9 | 10 | 50 | 50 | 700 | 10 | 10 |
| 146 | S9 | 10 | 50 | 50 | 700 | 10 | 10 |
| 147 | S9 | 10 | 50 | 50 | 700 | 10 | 10 |
| 148 | S9 | 10 | 50 | 50 | 700 | 10 | 10 |
| 149 | S9 | 10 | 50 | 50 | 700 | 10 | 10 |
| 150 | S9 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 126 | 50 | 850 | 10 | 10 | 850 | 15 |
| 127 | 50 | 850 | 10 | 10 | 850 | 15 |
| 128 | 50 | 850 | 10 | 10 | 850 | 15 |
| 129 | 50 | 850 | 10 | 10 | 850 | 15 |
| 130 | 50 | 850 | 10 | 10 | 850 | 15 |
| 131 | 50 | 850 | 10 | 10 | 850 | 15 |
| 132 | 50 | 850 | 10 | 10 | 850 | 15 |
| 133 | 50 | 850 | 10 | 10 | 850 | 15 |
| 134 | 50 | 850 | 10 | 10 | 850 | 15 |
| 135 | 50 | 850 | 10 | 10 | 850 | 15 |
| 136 | 50 | 850 | 10 | 10 | 850 | 15 |
| 137 | 50 | 850 | 10 | 10 | 850 | 15 |
| 138 | 50 | 850 | 10 | 10 | 850 | 15 |
| 139 | 50 | 850 | 10 | 10 | 850 | 15 |
| 140 | — | — | — | — | — | — |
| 141 | 50 | 850 | 10 | 10 | 850 | 15 |
| 142 | 50 | 850 | 10 | 10 | 850 | 15 |
| 143 | 50 | 850 | 10 | 10 | 850 | 15 |
| 144 | 50 | 850 | 10 | 10 | 850 | 15 |
| 145 | 50 | 850 | 10 | 10 | 850 | 15 |
| 146 | 50 | 850 | 10 | 10 | 850 | 15 |
| 147 | 50 | 850 | 10 | 10 | 850 | 15 |
| 148 | 50 | 850 | 10 | 10 | 850 | 15 |
| 149 | 50 | 850 | 10 | 10 | 850 | 15 |
| 150 | 50 | 850 | 10 | 10 | 850 | 15 |

TABLE 31

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 151 | S9 | 10 | 50 | 50 | 700 | 10 | 10 |
| 152 | S9 | 10 | 50 | 50 | 700 | 10 | 10 |
| 153 | S9 | 7 | 50 | 50 | 700 | 10 | 10 |
| 154 | S9 | 9 | 50 | 50 | 700 | 10 | 10 |
| 155 | S9 | 11 | 50 | 50 | 700 | 10 | 10 |
| 156 | S9 | 13 | 50 | 50 | 700 | 10 | 10 |
| 157 | S9 | 10 | 42 | 50 | 700 | 10 | 10 |
| 158 | S9 | 10 | 44 | 50 | 700 | 10 | 10 |
| 159 | S9 | 10 | 56 | 50 | 700 | 10 | 10 |
| 160 | S9 | 10 | 58 | 50 | 700 | 10 | 10 |
| 161 | S9 | 10 | 50 | 45 | 700 | 10 | 10 |
| 162 | S9 | 10 | 50 | 55 | 700 | 10 | 10 |
| 163 | S9 | 10 | 50 | 50 | 690 | 10 | 10 |
| 164 | S9 | 10 | 50 | 50 | 710 | 10 | 10 |
| 165 | S9 | 10 | 50 | 50 | 700 | 7 | 10 |
| 166 | S9 | 10 | 50 | 50 | 700 | 9 | 10 |
| 167 | S9 | 10 | 50 | 50 | 700 | 21 | 10 |
| 168 | S9 | 10 | 50 | 50 | 700 | 23 | 10 |
| 169 | S9 | 10 | 50 | 50 | 700 | 10 | −18 |
| 170 | S9 | 10 | 50 | 50 | 700 | 10 | −16 |
| 171 | S9 | 10 | 50 | 50 | 700 | 10 | −5 |
| 172 | S9 | 10 | 50 | 50 | 700 | 10 | 0 |
| 173 | S9 | 10 | 50 | 50 | 700 | 10 | 16 |
| 174 | S9 | 10 | 50 | 50 | 700 | 10 | 18 |
| 175 | S9 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 151 | 50 | 850 | 10 | 10 | 850 | 15 |
| 152 | 50 | 850 | 10 | 10 | 850 | 15 |
| 153 | 50 | 850 | 10 | 10 | 850 | 15 |
| 154 | 50 | 850 | 10 | 10 | 850 | 15 |
| 155 | 50 | 850 | 10 | 10 | 850 | 15 |
| 156 | 50 | 850 | 10 | 10 | 850 | 15 |
| 157 | 50 | 850 | 10 | 10 | 850 | 15 |
| 158 | 50 | 850 | 10 | 10 | 850 | 15 |
| 159 | 50 | 850 | 10 | 10 | 850 | 15 |
| 160 | 50 | 850 | 10 | 10 | 850 | 15 |
| 161 | 50 | 850 | 10 | 10 | 850 | 15 |
| 162 | 50 | 850 | 10 | 10 | 850 | 15 |
| 163 | 50 | 850 | 10 | 10 | 850 | 15 |
| 164 | 50 | 850 | 10 | 10 | 850 | 15 |
| 165 | 50 | 850 | 10 | 10 | 850 | 15 |
| 166 | 50 | 850 | 10 | 10 | 850 | 15 |
| 167 | 50 | 850 | 10 | 10 | 850 | 15 |
| 168 | 50 | 850 | 10 | 10 | 850 | 15 |
| 169 | 50 | 850 | 10 | 10 | 850 | 15 |
| 170 | 50 | 850 | 10 | 10 | 850 | 15 |
| 171 | 50 | 850 | 10 | 10 | 850 | 15 |
| 172 | 50 | 850 | 10 | 10 | 850 | 15 |
| 173 | 50 | 850 | 10 | 10 | 850 | 15 |
| 174 | 50 | 850 | 10 | 10 | 850 | 15 |
| 175 | 45 | 850 | 10 | 10 | 850 | 15 |

TABLE 32

| | | MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 176 | S9 | 10 | 50 | 50 | 700 | 10 | 10 |
| 177 | S9 | 10 | 50 | 50 | 700 | 10 | 10 |
| 178 | S9 | 10 | 50 | 50 | 700 | 10 | 10 |
| 179 | S9 | 10 | 50 | 50 | 700 | 10 | 10 |
| 180 | S9 | 10 | 50 | 50 | 700 | 10 | 10 |
| 181 | S9 | 10 | 50 | 50 | 700 | 10 | 10 |
| 182 | S9 | 10 | 50 | 50 | 700 | 10 | 10 |
| 183 | S9 | 10 | 50 | 50 | 700 | 10 | 10 |
| 184 | S9 | 10 | 50 | 50 | 700 | 10 | 10 |
| 185 | S9 | 10 | 50 | 50 | 700 | 10 | 10 |
| 186 | S9 | 10 | 50 | 50 | 700 | 10 | 10 |
| 187 | S9 | 10 | 50 | 50 | 700 | 10 | 10 |
| 188 | S9 | 10 | 50 | 50 | 700 | 10 | 10 |
| 189 | S9 | 10 | 50 | 50 | 700 | 10 | 10 |
| 190 | S9 | 10 | 50 | 50 | 700 | 10 | 10 |
| 191 | S9 | 10 | 50 | 50 | 700 | 10 | 10 |
| 192 | S9 | 10 | 50 | 50 | 700 | 10 | 10 |
| 193 | S9 | 10 | 50 | 50 | 700 | 10 | 10 |
| 194 | S9 | 10 | 50 | 50 | 700 | 10 | 10 |
| 195 | S9 | 10 | 50 | 50 | 700 | 10 | 10 |
| 196 | S9 | 10 | 50 | 50 | 700 | 10 | 10 |
| 197 | S9 | 10 | 50 | 50 | 700 | 10 | 10 |
| 198 | S9 | 10 | 50 | 50 | 700 | 10 | 10 |
| 199 | S9 | 10 | 50 | 50 | 700 | 10 | 10 |
| 200 | S9 | 10 | 50 | 50 | 700 | 10 | 10 |

| | MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 176 | 55 | 850 | 10 | 10 | 850 | 15 |
| 177 | 50 | 790 | 10 | 10 | 850 | 15 |
| 178 | 50 | 900 | 10 | 10 | 850 | 15 |
| 179 | 50 | 950 | 10 | 10 | 850 | 15 |
| 180 | 50 | 1030 | 10 | 10 | 850 | 15 |
| 181 | 50 | 850 | 7 | 10 | 850 | 15 |
| 182 | 50 | 850 | 9 | 10 | 850 | 15 |
| 183 | 50 | 850 | 21 | 10 | 850 | 15 |
| 184 | 50 | 850 | 23 | 10 | 850 | 15 |
| 185 | 50 | 850 | 10 | −18 | 850 | 15 |
| 186 | 50 | 850 | 10 | −16 | 850 | 15 |
| 187 | 50 | 850 | 10 | 16 | 850 | 15 |
| 188 | 50 | 850 | 10 | 18 | 850 | 15 |
| 189 | 50 | 850 | 10 | 10 | 790 | 15 |
| 190 | 50 | 850 | 10 | 10 | 900 | 15 |
| 191 | 50 | 850 | 10 | 10 | 950 | 15 |
| 192 | 50 | 850 | 10 | 10 | 1030 | 15 |
| 193 | 50 | 850 | 10 | 10 | 850 | 12 |
| 194 | 50 | 850 | 10 | 10 | 850 | 18 |
| 195 | 50 | 850 | 10 | 10 | 850 | 15 |
| 196 | 50 | 850 | 10 | 10 | 850 | 15 |
| 197 | 50 | 850 | 10 | 10 | 850 | 15 |
| 198 | 50 | 850 | 10 | 10 | 850 | 15 |
| 199 | 50 | 850 | 10 | 10 | 850 | 15 |
| 200 | 50 | 850 | 10 | 10 | 850 | 15 |

TABLE 33

| | | STEEL MANUFACTURING CONDITIONS | | | | | |
|---|---|---|---|---|---|---|---|
| | | FINAL ANNEALING | | | | | |
| | | HEATING STAGE (FIRST HALF) | | | | HEATING STAGE (SECOND HALF) | |
| | | ATMOSPHERE | | AVERAGE | | ATMOSPHERE | |
| | | | DEW | HEATING | HEATING | | DEW |
| | STEEL | HYDROGEN | POINT | RATE | TEMPERATURE | HYDROGEN | POINT |
| No. | TYPE | vol % | ° C. | ° C./sec. | ° C. | vol % | ° C. |
| 201 | S9 | 10 | 50 | 50 | 700 | 10 | 10 |
| 202 | S9 | 10 | 50 | 50 | 700 | 10 | 10 |
| 203 | S9 | 10 | 50 | 50 | 700 | 10 | 10 |
| 204 | S9 | 10 | 50 | 50 | 700 | 10 | 10 |
| 205 | S9 | 10 | 50 | 50 | 700 | 10 | 10 |
| 206 | S9 | 10 | 50 | 50 | 700 | 10 | 10 |
| 207 | S9 | 10 | 50 | 50 | 700 | 10 | 10 |
| 208 | S9 | 10 | 50 | 50 | 700 | 10 | 10 |
| 209 | S9 | 10 | 50 | 50 | 700 | 10 | 10 |
| 210 | S9 | 10 | 50 | 50 | 700 | 10 | 10 |
| 211 | S9 | 10 | 50 | 50 | 700 | 10 | 10 |
| 212 | S9 | 10 | 50 | 50 | 700 | 10 | 10 |
| 213 | S9 | 10 | 50 | 50 | 700 | 10 | 10 |
| 214 | S67 | 10 | 50 | 50 | 700 | 10 | 10 |

| | STEEL MANUFACTURING CONDITIONS | | | | | |
|---|---|---|---|---|---|---|
| | FINAL ANNEALING | | | | | |
| | HEATING STAGE (SECOND HALF) | | HOLDING STAGE | | | |
| | AVERAGE | | ATMOSPHERE | | | |
| | HEATING | HEATING | | DEW | HOLDING | HOLDING |
| | RATE | TEMPERATURE | HYDROGEN | POINT | TEMPERATURE | TIME |
| No. | ° C./sec. | ° C. | vol % | ° C. | ° C. | sec. |
| 201 | 50 | 850 | 10 | 10 | 850 | 15 |
| 202 | 50 | 850 | 10 | 10 | 850 | 15 |
| 203 | 50 | 850 | 10 | 10 | 850 | 15 |
| 204 | 50 | 850 | 10 | 10 | 850 | 15 |
| 205 | 50 | 850 | 10 | 10 | 850 | 15 |
| 206 | 50 | 850 | 10 | 10 | 850 | 15 |
| 207 | 50 | 850 | 10 | 10 | 850 | 15 |
| 208 | 50 | 850 | 10 | 10 | 850 | 15 |
| 209 | 50 | 850 | 10 | 10 | 850 | 15 |
| 210 | 50 | 850 | 10 | 10 | 850 | 15 |
| 211 | 50 | 850 | 10 | 10 | 850 | 15 |
| 212 | 50 | 850 | 10 | 10 | 850 | 15 |
| 213 | 50 | 850 | 10 | 10 | 850 | 15 |
| 214 | 50 | 850 | 10 | 10 | 850 | 15 |

TABLE 34

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 1 | S1 | 700 | 15 | 100 | −25 | 700 | 80 |
| 2 | S2 | 700 | 15 | 100 | −25 | 700 | 80 |
| 3 | S3 | 700 | 15 | 100 | −25 | 700 | 80 |
| 4 | S4 | 700 | 15 | 100 | −25 | 700 | 80 |
| 5 | S5 | 700 | 15 | 100 | −25 | 700 | 80 |
| 6 | S6 | 700 | 15 | 100 | −25 | 700 | 80 |
| 7 | S7 | 700 | 15 | 100 | −25 | 700 | 80 |
| 8 | S8 | 700 | 15 | 100 | −25 | 700 | 80 |
| 9 | S9 | 700 | 15 | 100 | −25 | 700 | 80 |
| 10 | S10 | 700 | 15 | 100 | −25 | 700 | 80 |
| 11 | S11 | 700 | 15 | 100 | −25 | 700 | 80 |
| 12 | S12 | 700 | 15 | 100 | −25 | 700 | 80 |
| 13 | S13 | 700 | 15 | 100 | −25 | 700 | 80 |
| 14 | S14 | 700 | 15 | 100 | −25 | 700 | 80 |
| 15 | S15 | 700 | 15 | 100 | −25 | 700 | 80 |
| 16 | S16 | — | — | — | — | — | — |
| 17 | S17 | 700 | 15 | 100 | −25 | 700 | 80 |
| 18 | S18 | 700 | 15 | 100 | −25 | 700 | 80 |
| 19 | S19 | 700 | 15 | 100 | −25 | 700 | 80 |
| 20 | S20 | 700 | 15 | 100 | −25 | 700 | 80 |
| 21 | S21 | — | — | — | — | — | — |
| 22 | S22 | 700 | 15 | 100 | −25 | 700 | 80 |
| 23 | S23 | 700 | 15 | 100 | −25 | 700 | 80 |
| 24 | S24 | 700 | 15 | 100 | −25 | 700 | 80 |
| 25 | S25 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 1 | ORGANIC-INORGANIC COMPOSITE | 800 | 60 |
| 2 | ORGANIC-INORGANIC COMPOSITE | 800 | 60 |
| 3 | ORGANIC-INORGANIC COMPOSITE | 800 | 60 |
| 4 | ORGANIC-INORGANIC COMPOSITE | 800 | 60 |
| 5 | ORGANIC-INORGANIC COMPOSITE | 800 | 60 |
| 6 | ORGANIC-INORGANIC COMPOSITE | 800 | 60 |
| 7 | ORGANIC-INORGANIC COMPOSITE | 800 | 60 |
| 8 | ORGANIC-INORGANIC COMPOSITE | 800 | 60 |
| 9 | ORGANIC-INORGANIC COMPOSITE | 800 | 60 |
| 10 | ORGANIC-INORGANIC COMPOSITE | 800 | 60 |
| 11 | ORGANIC-INORGANIC COMPOSITE | 800 | 60 |
| 12 | ORGANIC-INORGANIC COMPOSITE | 800 | 60 |
| 13 | ORGANIC-INORGANIC COMPOSITE | 800 | 60 |
| 14 | ORGANIC-INORGANIC COMPOSITE | 800 | 60 |
| 15 | ORGANIC-INORGANIC COMPOSITE | 800 | 60 |
| 16 | — | — | — |
| 17 | ORGANIC-INORGANIC COMPOSITE | 800 | 60 |
| 18 | ORGANIC-INORGANIC COMPOSITE | 800 | 60 |
| 19 | ORGANIC-INORGANIC COMPOSITE | 800 | 60 |
| 20 | ORGANIC-INORGANIC COMPOSITE | 800 | 60 |
| 21 | — | — | — |
| 22 | ORGANIC-INORGANIC COMPOSITE | 800 | 60 |
| 23 | ORGANIC-INORGANIC COMPOSITE | 800 | 60 |
| 24 | ORGANIC-INORGANIC COMPOSITE | 800 | 60 |
| 25 | ORGANIC-INORGANIC COMPOSITE | 800 | 60 |

TABLE 35

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 26 | S26 | 700 | 15 | 100 | −25 | 700 | 80 |
| 27 | S27 | 700 | 15 | 100 | −25 | 700 | 80 |
| 28 | S28 | 700 | 15 | 100 | −25 | 700 | 80 |
| 29 | S29 | 700 | 15 | 100 | −25 | 700 | 80 |
| 30 | S30 | 700 | 15 | 100 | −25 | 700 | 80 |
| 31 | S31 | 700 | 15 | 100 | −25 | 700 | 80 |
| 32 | S32 | 700 | 15 | 100 | −25 | 700 | 80 |
| 33 | S33 | 700 | 15 | 100 | −25 | 700 | 80 |
| 34 | S34 | 700 | 15 | 100 | −25 | 700 | 80 |
| 35 | S35 | 700 | 15 | 100 | −25 | 700 | 80 |
| 36 | S36 | 700 | 15 | 100 | −25 | 700 | 80 |
| 37 | S37 | 700 | 15 | 100 | −25 | 700 | 80 |
| 38 | S38 | — | — | — | — | — | — |
| 39 | S39 | 700 | 15 | 100 | −25 | 700 | 80 |
| 40 | S40 | 700 | 15 | 100 | −25 | 700 | 80 |
| 41 | S41 | — | — | — | — | — | — |
| 42 | S42 | 700 | 15 | 100 | −25 | 700 | 80 |
| 43 | S43 | 700 | 15 | 100 | −25 | 700 | 80 |
| 44 | S44 | 700 | 15 | 100 | −25 | 700 | 80 |
| 45 | S45 | 700 | 15 | 100 | −25 | 700 | 80 |
| 46 | S46 | 700 | 15 | 100 | −25 | 700 | 80 |
| 47 | S47 | 700 | 15 | 100 | −25 | 700 | 80 |
| 48 | S48 | 700 | 15 | 100 | −25 | 700 | 80 |
| 49 | S49 | 700 | 15 | 100 | −25 | 700 | 80 |
| 50 | S50 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 26 | ORGANIC-INORGANIC COMPOSITE | 800 | 60 |
| 27 | ORGANIC-INORGANIC COMPOSITE | 800 | 60 |
| 28 | ORGANIC-INORGANIC COMPOSITE | 800 | 60 |
| 29 | ORGANIC-INORGANIC COMPOSITE | 800 | 60 |
| 30 | ORGANIC-INORGANIC COMPOSITE | 800 | 60 |
| 31 | ORGANIC-INORGANIC COMPOSITE | 800 | 60 |
| 32 | ORGANIC-INORGANIC COMPOSITE | 800 | 60 |
| 33 | ORGANIC-INORGANIC COMPOSITE | 800 | 60 |
| 34 | ORGANIC-INORGANIC COMPOSITE | 800 | 60 |
| 35 | ORGANIC-INORGANIC COMPOSITE | 800 | 60 |
| 36 | ORGANIC-INORGANIC COMPOSITE | 800 | 60 |
| 37 | ORGANIC-INORGANIC COMPOSITE | 800 | 60 |
| 38 | — | — | — |
| 39 | ORGANIC-INORGANIC COMPOSITE | 800 | 60 |
| 40 | ORGANIC-INORGANIC COMPOSITE | 800 | 60 |
| 41 | — | — | — |
| 42 | ORGANIC-INORGANIC COMPOSITE | 800 | 60 |
| 43 | ORGANIC-INORGANIC COMPOSITE | 800 | 60 |
| 44 | ORGANIC-INORGANIC COMPOSITE | 800 | 60 |
| 45 | ORGANIC-INORGANIC COMPOSITE | 800 | 60 |
| 46 | ORGANIC-INORGANIC COMPOSITE | 800 | 60 |
| 47 | ORGANIC-INORGANIC COMPOSITE | 800 | 60 |
| 48 | ORGANIC-INORGANIC COMPOSITE | 800 | 60 |
| 49 | ORGANIC-INORGANIC COMPOSITE | 800 | 60 |
| 50 | ORGANIC-INORGANIC COMPOSITE | 800 | 60 |

TABLE 36

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 51 | S51 | 700 | 15 | 100 | −25 | 700 | 80 |
| 52 | S52 | 700 | 15 | 100 | −25 | 700 | 80 |
| 53 | S53 | 700 | 15 | 100 | −25 | 700 | 80 |
| 54 | S54 | 700 | 15 | 100 | −25 | 700 | 80 |
| 55 | S55 | 700 | 15 | 100 | −25 | 700 | 80 |
| 56 | S56 | 700 | 15 | 100 | −25 | 700 | 80 |
| 57 | S57 | 700 | 15 | 100 | −25 | 700 | 80 |
| 58 | S58 | 700 | 15 | 100 | −25 | 700 | 80 |
| 59 | S59 | 700 | 15 | 100 | −25 | 700 | 80 |
| 60 | S60 | 700 | 15 | 100 | −25 | 700 | 80 |
| 61 | S61 | 700 | 15 | 100 | −25 | 700 | 80 |
| 62 | S62 | 700 | 15 | 100 | −25 | 700 | 80 |
| 63 | S63 | 700 | 15 | 100 | −25 | 700 | 80 |
| 64 | S64 | 700 | 15 | 100 | −25 | 700 | 80 |
| 65 | S65 | 700 | 15 | 100 | −25 | 700 | 80 |
| 66 | S66 | 700 | 15 | 100 | −25 | 700 | 80 |
| 67 | S9 | 700 | 15 | 100 | −25 | 700 | 80 |
| 68 | S9 | 700 | 15 | 100 | −25 | 700 | 80 |
| 69 | S9 | 700 | 15 | 100 | −25 | 700 | 80 |
| 70 | S9 | 700 | 15 | 100 | −25 | 700 | 80 |
| 71 | S9 | 700 | 15 | 100 | −25 | 700 | 80 |
| 72 | S9 | 700 | 15 | 100 | −25 | 700 | 80 |
| 73 | S9 | 700 | 15 | 100 | −25 | 700 | 80 |
| 74 | S9 | 700 | 15 | 100 | −25 | 700 | 80 |
| 75 | S9 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERTURE | TIME |
| No. | TYPE OF COATING | ° C. | min. |
| 51 | ORGANIC-INORGANIC COMPOSITE | 800 | 60 |
| 52 | ORGANIC-INORGANIC COMPOSITE | 800 | 60 |
| 53 | ORGANIC-INORGANIC COMPOSITE | 800 | 60 |
| 54 | ORGANIC-INORGANIC COMPOSITE | 800 | 60 |
| 55 | ORGANIC-INORGANIC COMPOSITE | 800 | 60 |
| 56 | ORGANIC-INORGANIC COMPOSITE | 800 | 60 |
| 57 | ORGANIC-INORGANIC COMPOSITE | 800 | 60 |
| 58 | ORGANIC-INORGANIC COMPOSITE | 800 | 60 |
| 59 | ORGANIC-INORGANIC COMPOSITE | 800 | 60 |
| 60 | ORGANIC-INORGANIC COMPOSITE | 800 | 60 |
| 61 | ORGANIC-INORGANIC COMPOSITE | 800 | 60 |
| 62 | ORGANIC-INORGANIC COMPOSITE | 800 | 60 |
| 63 | ORGANIC-INORGANIC COMPOSITE | 800 | 60 |
| 64 | ORGANIC-INORGANIC COMPOSITE | 800 | 60 |
| 65 | ORGANIC-INORGANIC COMPOSITE | 800 | 60 |
| 66 | ORGANIC-INORGANIC COMPOSITE | 800 | 60 |
| 67 | ORGANIC-INORGANIC COMPOSITE | 800 | 60 |
| 68 | ORGANIC-INORGANIC COMPOSITE | 800 | 60 |
| 69 | ORGANIC-INORGANIC COMPOSITE | 800 | 60 |
| 70 | ORGANIC-INORGANIC COMPOSITE | 800 | 60 |
| 71 | ORGANIC-INORGANIC COMPOSITE | 800 | 60 |
| 72 | ORGANIC-INORGANIC COMPOSITE | 800 | 60 |
| 73 | ORGANIC-INORGANIC COMPOSITE | 800 | 60 |
| 74 | ORGANIC-INORGANIC COMPOSITE | 800 | 60 |
| 75 | ORGANIC-INORGANIC COMPOSITE | 800 | 60 |

TABLE 37

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 76 | S9 | 700 | 15 | 100 | −25 | 700 | 80 |
| 77 | S9 | 700 | 15 | 100 | −25 | 700 | 80 |
| 78 | S9 | 700 | 15 | 100 | −25 | 700 | 80 |
| 79 | S9 | 700 | 15 | 100 | −25 | 700 | 80 |
| 80 | S9 | 700 | 15 | 100 | −25 | 700 | 80 |
| 81 | S9 | 700 | 15 | 100 | −25 | 700 | 80 |
| 82 | S9 | 700 | 15 | 100 | −25 | 700 | 80 |
| 83 | S9 | 700 | 15 | 100 | −25 | 700 | 80 |
| 84 | S9 | 700 | 15 | 100 | −25 | 700 | 80 |
| 85 | S9 | 700 | 15 | 100 | −25 | 700 | 80 |
| 86 | S9 | 700 | 15 | 100 | −25 | 700 | 80 |
| 87 | S9 | 700 | 15 | 100 | −25 | 700 | 80 |
| 88 | S9 | 700 | 15 | 100 | −25 | 700 | 80 |
| 89 | S9 | 700 | 15 | 100 | −25 | 700 | 80 |
| 90 | S9 | 700 | 15 | 100 | −25 | 700 | 80 |
| 91 | S9 | 700 | 15 | 100 | −25 | 700 | 80 |
| 92 | S9 | 700 | 15 | 100 | −25 | 700 | 80 |
| 93 | S9 | 700 | 15 | 100 | −25 | 700 | 80 |
| 94 | S9 | 700 | 15 | 100 | −25 | 700 | 80 |
| 95 | S9 | 700 | 15 | 100 | −25 | 700 | 80 |
| 96 | S9 | 700 | 15 | 100 | −25 | 700 | 80 |
| 97 | S9 | 700 | 15 | 100 | −25 | 700 | 80 |
| 98 | S9 | 700 | 15 | 100 | −25 | 700 | 80 |
| 99 | S9 | 700 | 15 | 100 | −25 | 700 | 80 |
| 100 | S9 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 76 | ORGANIC-INORGANIC COMPOSITE | 800 | 60 |
| 77 | ORGANIC-INORGANIC COMPOSITE | 800 | 60 |
| 78 | ORGANIC-INORGANIC COMPOSITE | 800 | 60 |
| 79 | ORGANIC-INORGANIC COMPOSITE | 800 | 60 |
| 80 | ORGANIC-INORGANIC COMPOSITE | 800 | 60 |
| 81 | ORGANIC-INORGANIC COMPOSITE | 800 | 60 |
| 82 | ORGANIC-INORGANIC COMPOSITE | 800 | 60 |
| 83 | ORGANIC-INORGANIC COMPOSITE | 800 | 60 |
| 84 | ORGANIC-INORGANIC COMPOSITE | 800 | 60 |
| 85 | ORGANIC-INORGANIC COMPOSITE | 800 | 60 |
| 86 | ORGANIC-INORGANIC COMPOSITE | 800 | 60 |
| 87 | ORGANIC-INORGANIC COMPOSITE | 800 | 60 |
| 88 | ORGANIC-INORGANIC COMPOSITE | 800 | 60 |
| 89 | ORGANIC-INORGANIC COMPOSITE | 800 | 60 |
| 90 | ORGANIC-INORGANIC COMPOSITE | 800 | 60 |
| 91 | ORGANIC-INORGANIC COMPOSITE | 800 | 60 |
| 92 | ORGANIC-INORGANIC COMPOSITE | 800 | 60 |
| 93 | ORGANIC-INORGANIC COMPOSITE | 800 | 60 |
| 94 | ORGANIC-INORGANIC COMPOSITE | 800 | 60 |
| 95 | ORGANIC-INORGANIC COMPOSITE | 800 | 60 |
| 96 | ORGANIC-INORGANIC COMPOSITE | 800 | 60 |
| 97 | ORGANIC-INORGANIC COMPOSITE | 800 | 60 |
| 98 | ORGANIC-INORGANIC COMPOSITE | 800 | 60 |
| 99 | ORGANIC-INORGANIC COMPOSITE | 800 | 60 |
| 100 | ORGANIC-INORGANIC COMPOSITE | 800 | 60 |

TABLE 38

| | | MANUFACTURING CONDITIONS | | | | | |
|---|---|---|---|---|---|---|---|
| | | FINAL ANNEALING | | NITRIDING ANNEALING | | | |
| | | COOLING STAGE | | | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 101 | S9 | 700 | 15 | 100 | −25 | 700 | 80 |
| 102 | S9 | 700 | 15 | 100 | −25 | 700 | 80 |
| 103 | S9 | 700 | 15 | 100 | −25 | 700 | 80 |
| 104 | S9 | 700 | 15 | 100 | −25 | 700 | 80 |
| 105 | S9 | 700 | 15 | 100 | −25 | 700 | 80 |
| 106 | S9 | 700 | 15 | 100 | −25 | 700 | 80 |
| 107 | S9 | 700 | 15 | 100 | −25 | 700 | 80 |
| 108 | S9 | 700 | 15 | 100 | −25 | 700 | 80 |
| 109 | S9 | 700 | 15 | 100 | −25 | 700 | 80 |
| 110 | S9 | 700 | 15 | 100 | −25 | 700 | 80 |
| 111 | S9 | 700 | 15 | 100 | −25 | 700 | 80 |
| 112 | S9 | 700 | 15 | 100 | −25 | 700 | 80 |
| 113 | S9 | 0 | 15 | 100 | −25 | 700 | 80 |
| 114 | S9 | 750 | 15 | 100 | −25 | 750 | 80 |
| 115 | S9 | 700 | 3 | 100 | −25 | 700 | 80 |
| 116 | S9 | 700 | 25 | 100 | −25 | 700 | 80 |
| 117 | S9 | 700 | 15 | 90 | −25 | 700 | 80 |
| 118 | S9 | 700 | 15 | 100 | −55 | 700 | 80 |
| 119 | S9 | 700 | 15 | 100 | 5 | 700 | 80 |
| 120 | S9 | 700 | 15 | 100 | −25 | 650 | 80 |
| 121 | S9 | 700 | 15 | 100 | −25 | 750 | 80 |
| 122 | S9 | 700 | 15 | 100 | −25 | 700 | 60 |
| 123 | S9 | 700 | 15 | 100 | −25 | 700 | 120 |
| 124 | S9 | 700 | 15 | 100 | −25 | 700 | 80 |
| 125 | S9 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 101 | ORGANIC-INORGANIC COMPOSITE | 800 | 60 |
| 102 | ORGANIC-INORGANIC COMPOSITE | 800 | 60 |
| 103 | ORGANIC-INORGANIC COMPOSITE | 800 | 60 |
| 104 | ORGANIC-INORGANIC COMPOSITE | 800 | 60 |
| 105 | ORGANIC-INORGANIC COMPOSITE | 800 | 60 |
| 106 | ORGANIC-INORGANIC COMPOSITE | 800 | 60 |
| 107 | ORGANIC-INORGANIC COMPOSITE | 800 | 60 |
| 108 | ORGANIC-INORGANIC COMPOSITE | 800 | 60 |
| 109 | ORGANIC-INORGANIC COMPOSITE | 800 | 60 |
| 110 | ORGANIC-INORGANIC COMPOSITE | 800 | 60 |
| 111 | ORGANIC-INORGANIC COMPOSITE | 800 | 60 |
| 112 | ORGANIC-INORGANIC COMPOSITE | 800 | 60 |
| 113 | ORGANIC-INORGANIC COMPOSITE | 800 | 60 |
| 114 | ORGANIC-INORGANIC COMPOSITE | 800 | 60 |
| 115 | ORGANIC-INORGANIC COMPOSITE | 800 | 60 |
| 116 | ORGANIC-INORGANIC COMPOSITE | 800 | 60 |
| 117 | ORGANIC-INORGANIC COMPOSITE | 800 | 60 |
| 118 | ORGANIC-INORGANIC COMPOSITE | 800 | 60 |
| 119 | ORGANIC-INORGANIC COMPOSITE | 800 | 60 |
| 120 | ORGANIC-INORGANIC COMPOSITE | 800 | 60 |
| 121 | ORGANIC-INORGANIC COMPOSITE | 800 | 60 |
| 122 | ORGANIC-INORGANIC COMPOSITE | 800 | 60 |
| 123 | ORGANIC-INORGANIC COMPOSITE | 800 | 60 |
| 124 | None | 800 | 60 |
| 125 | ORGANIC-INORGANIC COMPOSITE | 700 | 60 |

TABLE 39

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 126 | S9 | 700 | 15 | 100 | −25 | 700 | 80 |
| 127 | S9 | 700 | 15 | 100 | −25 | 700 | 80 |
| 128 | S9 | 700 | 15 | 100 | −25 | 700 | 80 |
| 129 | S67 | 700 | 15 | 100 | −25 | 700 | 80 |
| 130 | S68 | 700 | 15 | 100 | −25 | 700 | 80 |
| 131 | S69 | 700 | 15 | 100 | −25 | 700 | 80 |
| 132 | S70 | 700 | 15 | 100 | −25 | 700 | 80 |
| 133 | S71 | 700 | 15 | 100 | −25 | 700 | 80 |
| 134 | S72 | 700 | 15 | 100 | −25 | 700 | 80 |
| 135 | S73 | 700 | 15 | 100 | −25 | 700 | 80 |
| 136 | S74 | 700 | 15 | — | — | — | — |
| 137 | S9 | 700 | 15 | 100 | −25 | 700 | 80 |
| 138 | S75 | 700 | 15 | 100 | −25 | 700 | 80 |
| 139 | S76 | 700 | 15 | 100 | −25 | 700 | 80 |
| 140 | S9 | — | — | — | — | — | — |
| 141 | S9 | 700 | 15 | 100 | −25 | 700 | 80 |
| 142 | S9 | 700 | 15 | 100 | −25 | 700 | 80 |
| 143 | S9 | 700 | 15 | 100 | −25 | 700 | 80 |
| 144 | S9 | 700 | 15 | 100 | −25 | 700 | 80 |
| 145 | S9 | 700 | 15 | 100 | −25 | 700 | 80 |
| 146 | S9 | 700 | 15 | 100 | −25 | 700 | 80 |
| 147 | S9 | 700 | 15 | 100 | −25 | 700 | 80 |
| 148 | S9 | 700 | 15 | 100 | −25 | 700 | 80 |
| 149 | S9 | 700 | 15 | 100 | −25 | 700 | 80 |
| 150 | S9 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 126 | ORGANIC-INORGANIC COMPOSITE | 875 | 60 |
| 127 | ORGANIC-INORGANIC COMPOSITE | 800 | 15 |
| 128 | ORGANIC-INORGANIC COMPOSITE | 800 | 180 |
| 129 | ORGANIC-INORGANIC COMPOSITE | 800 | 60 |
| 130 | ORGANIC-INORGANIC COMPOSITE | 800 | 60 |
| 131 | ORGANIC-INORGANIC COMPOSITE | 800 | 60 |
| 132 | ORGANIC-INORGANIC COMPOSITE | 800 | 60 |
| 133 | ORGANIC-INORGANIC COMPOSITE | 800 | 60 |
| 134 | ORGANIC-INORGANIC COMPOSITE | 800 | 60 |
| 135 | ORGANIC-INORGANIC COMPOSITE | 800 | 60 |
| 136 | ORGANIC-INORGANIC COMPOSITE | 800 | 60 |
| 137 | ORGANIC-INORGANIC COMPOSITE | — | — |
| 138 | ORGANIC-INORGANIC COMPOSITE | 800 | 60 |
| 139 | ORGANIC-INORGANIC COMPOSITE | 800 | 60 |
| 140 | — | — | — |
| 141 | ORGANIC-INORGANIC COMPOSITE | 800 | 60 |
| 142 | ORGANIC-INORGANIC COMPOSITE | 800 | 60 |
| 143 | ORGANIC-INORGANIC COMPOSITE | 800 | 60 |
| 144 | ORGANIC-INORGANIC COMPOSITE | 800 | 60 |
| 145 | ORGANIC-INORGANIC COMPOSITE | 800 | 60 |
| 146 | ORGANIC-INORGANIC COMPOSITE | 800 | 60 |
| 147 | ORGANIC-INORGANIC COMPOSITE | 800 | 60 |
| 148 | ORGANIC-INORGANIC COMPOSITE | 800 | 60 |
| 149 | ORGANIC-INORGANIC COMPOSITE | 800 | 60 |
| 150 | ORGANIC-INORGANIC COMPOSITE | 800 | 60 |

TABLE 40

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 151 | S9 | 700 | 15 | 100 | −25 | 700 | 80 |
| 152 | S9 | 700 | 15 | 100 | −25 | 700 | 80 |
| 153 | S9 | 700 | 15 | 100 | −25 | 700 | 80 |
| 154 | S9 | 700 | 15 | 100 | −25 | 700 | 80 |
| 155 | S9 | 700 | 15 | 100 | −25 | 700 | 80 |
| 156 | S9 | 700 | 15 | 100 | −25 | 700 | 80 |
| 157 | S9 | 700 | 15 | 100 | −25 | 700 | 80 |
| 158 | S9 | 700 | 15 | 100 | −25 | 700 | 80 |
| 159 | S9 | 700 | 15 | 100 | −25 | 700 | 80 |
| 160 | S9 | 700 | 15 | 100 | −25 | 700 | 80 |
| 161 | S9 | 700 | 15 | 100 | −25 | 700 | 80 |
| 162 | S9 | 700 | 15 | 100 | −25 | 700 | 80 |
| 163 | S9 | 700 | 15 | 100 | −25 | 700 | 80 |
| 164 | S9 | 700 | 15 | 100 | −25 | 700 | 80 |
| 165 | S9 | 700 | 15 | 100 | −25 | 700 | 80 |
| 166 | S9 | 700 | 15 | 100 | −25 | 700 | 80 |
| 167 | S9 | 700 | 15 | 100 | −25 | 700 | 80 |
| 168 | S9 | 700 | 15 | 100 | −25 | 700 | 80 |
| 169 | S9 | 700 | 15 | 100 | −25 | 700 | 80 |
| 170 | S9 | 700 | 15 | 100 | −25 | 700 | 80 |
| 171 | S9 | 700 | 15 | 100 | −25 | 700 | 80 |
| 172 | S9 | 700 | 15 | 100 | −25 | 700 | 80 |
| 173 | S9 | 700 | 15 | 100 | −25 | 700 | 80 |
| 174 | S9 | 700 | 15 | 100 | −25 | 700 | 80 |
| 175 | S9 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 151 | ORGANIC-INORGANIC COMPOSITE | 800 | 60 |
| 152 | ORGANIC-INORGANIC COMPOSITE | 800 | 60 |
| 153 | ORGANIC-INORGANIC COMPOSITE | 800 | 60 |
| 154 | ORGANIC-INORGANIC COMPOSITE | 800 | 60 |
| 155 | ORGANIC-INORGANIC COMPOSITE | 800 | 60 |
| 156 | ORGANIC-INORGANIC COMPOSITE | 800 | 60 |
| 157 | ORGANIC-INORGANIC COMPOSITE | 800 | 60 |
| 158 | ORGANIC-INORGANIC COMPOSITE | 800 | 60 |
| 159 | ORGANIC-INORGANIC COMPOSITE | 800 | 60 |
| 160 | ORGANIC-INORGANIC COMPOSITE | 800 | 60 |
| 161 | ORGANIC-INORGANIC COMPOSITE | 800 | 60 |
| 162 | ORGANIC-INORGANIC COMPOSITE | 800 | 60 |
| 163 | ORGANIC-INORGANIC COMPOSITE | 800 | 60 |
| 164 | ORGANIC-INORGANIC COMPOSITE | 800 | 60 |
| 165 | ORGANIC-INORGANIC COMPOSITE | 800 | 60 |
| 166 | ORGANIC-INORGANIC COMPOSITE | 800 | 60 |
| 167 | ORGANIC-INORGANIC COMPOSITE | 800 | 60 |
| 168 | ORGANIC-INORGANIC COMPOSITE | 800 | 60 |
| 169 | ORGANIC-INORGANIC COMPOSITE | 800 | 60 |
| 170 | ORGANIC-INORGANIC COMPOSITE | 800 | 60 |
| 171 | ORGANIC-INORGANIC COMPOSITE | 800 | 60 |
| 172 | ORGANIC-INORGANIC COMPOSITE | 800 | 60 |
| 173 | ORGANIC-INORGANIC COMPOSITE | 800 | 60 |
| 174 | ORGANIC-INORGANIC COMPOSITE | 800 | 60 |
| 175 | ORGANIC-INORGANIC COMPOSITE | 800 | 60 |

TABLE 41

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 176 | S9 | 700 | 15 | 100 | −25 | 700 | 80 |
| 177 | S9 | 700 | 15 | 100 | −25 | 700 | 80 |
| 178 | S9 | 700 | 15 | 100 | −25 | 700 | 80 |
| 179 | S9 | 700 | 15 | 100 | −25 | 700 | 80 |
| 180 | S9 | 700 | 15 | 100 | −25 | 700 | 80 |
| 181 | S9 | 700 | 15 | 100 | −25 | 700 | 80 |
| 182 | S9 | 700 | 15 | 100 | −25 | 700 | 80 |
| 183 | S9 | 700 | 15 | 100 | −25 | 700 | 80 |
| 184 | S9 | 700 | 15 | 100 | −25 | 700 | 80 |
| 185 | S9 | 700 | 15 | 100 | −25 | 700 | 80 |
| 186 | S9 | 700 | 15 | 100 | −25 | 700 | 80 |
| 187 | S9 | 700 | 15 | 100 | −25 | 700 | 80 |
| 188 | S9 | 700 | 15 | 100 | −25 | 700 | 80 |
| 189 | S9 | 700 | 15 | 100 | −25 | 700 | 80 |
| 190 | S9 | 700 | 15 | 100 | −25 | 700 | 80 |
| 191 | S9 | 700 | 15 | 100 | −25 | 700 | 80 |
| 192 | S9 | 700 | 15 | 100 | −25 | 700 | 80 |
| 193 | S9 | 700 | 15 | 100 | −25 | 700 | 80 |
| 194 | S9 | 700 | 15 | 100 | −25 | 700 | 80 |
| 195 | S9 | 100 | 15 | 100 | −25 | 700 | 80 |
| 196 | S9 | 150 | 15 | 100 | −25 | 700 | 80 |
| 197 | S9 | 300 | 15 | 100 | −25 | 700 | 80 |
| 198 | S9 | 650 | 15 | 100 | −25 | 700 | 80 |
| 199 | S9 | 700 | 7 | 100 | −25 | 700 | 80 |
| 200 | S9 | 700 | 10 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 176 | ORGANIC-INORGANIC COMPOSITE | 800 | 60 |
| 177 | ORGANIC-INORGANIC COMPOSITE | 800 | 60 |
| 178 | ORGANIC-INORGANIC COMPOSITE | 800 | 60 |
| 179 | ORGANIC-INORGANIC COMPOSITE | 800 | 60 |
| 180 | ORGANIC-INORGANIC COMPOSITE | 800 | 60 |
| 181 | ORGANIC-INORGANIC COMPOSITE | 800 | 60 |
| 182 | ORGANIC-INORGANIC COMPOSITE | 800 | 60 |
| 183 | ORGANIC-INORGANIC COMPOSITE | 800 | 60 |
| 184 | ORGANIC-INORGANIC COMPOSITE | 800 | 60 |
| 185 | ORGANIC-INORGANIC COMPOSITE | 800 | 60 |
| 186 | ORGANIC-INORGANIC COMPOSITE | 800 | 60 |
| 187 | ORGANIC-INORGANIC COMPOSITE | 800 | 60 |
| 188 | ORGANIC-INORGANIC COMPOSITE | 800 | 60 |
| 189 | ORGANIC-INORGANIC COMPOSITE | 800 | 60 |
| 190 | ORGANIC-INORGANIC COMPOSITE | 800 | 60 |
| 191 | ORGANIC-INORGANIC COMPOSITE | 800 | 60 |
| 192 | ORGANIC-INORGANIC COMPOSITE | 800 | 60 |
| 193 | ORGANIC-INORGANIC COMPOSITE | 800 | 60 |
| 194 | ORGANIC-INORGANIC COMPOSITE | 800 | 60 |
| 195 | ORGANIC-INORGANIC COMPOSITE | 800 | 60 |
| 196 | ORGANIC-INORGANIC COMPOSITE | 800 | 60 |
| 197 | ORGANIC-INORGANIC COMPOSITE | 800 | 60 |
| 198 | ORGANIC-INORGANIC COMPOSITE | 800 | 60 |
| 199 | ORGANIC-INORGANIC COMPOSITE | 800 | 60 |
| 200 | ORGANIC-INORGANIC COMPOSITE | 800 | 60 |

TABLE 42

| | | MANUFACTURING CONDITIONS | | | | | |
|---|---|---|---|---|---|---|---|
| | | FINAL ANNEALING | | | | | |
| | | COOLING STAGE | | NITRIDING ANNEALING | | | |
| | | | AVERAGE | ATMOSPHERE | | | |
| | | COOLING | COOLING | | DEW | HOLDING | HOLDING |
| | STEEL | TEMPERATURE | RATE | NITROGEN | POINT | TEMPERATURE | TIME |
| No. | TYPE | ° C. | ° C./sec. | vol % | ° C. | ° C. | sec. |
| 201 | S9 | 700 | 18 | 100 | −25 | 700 | 80 |
| 202 | S9 | 700 | 15 | 96 | −25 | 700 | 80 |
| 203 | S9 | 700 | 15 | 98 | −25 | 700 | 80 |
| 204 | S9 | 700 | 15 | 100 | −45 | 700 | 80 |
| 205 | S9 | 700 | 15 | 100 | −40 | 700 | 80 |
| 206 | S9 | 700 | 15 | 100 | −30 | 700 | 80 |
| 207 | S9 | 700 | 15 | 100 | −20 | 700 | 80 |
| 208 | S9 | 700 | 15 | 100 | −10 | 700 | 80 |
| 209 | S9 | 700 | 15 | 100 | −5 | 700 | 80 |
| 210 | S9 | 700 | 15 | 100 | −25 | 690 | 80 |
| 211 | S9 | 700 | 15 | 100 | −25 | 710 | 80 |
| 212 | S9 | 700 | 15 | 100 | −25 | 700 | 75 |
| 213 | S9 | 700 | 15 | 100 | −25 | 700 | 85 |
| 214 | S67 | 700 | 15 | 100 | −25 | 700 | 80 |

| | MANUFACTURING CONDITIONS | | |
|---|---|---|---|
| | COATING FORMATION | | |
| | | ANNEALING STAGE | |
| | | ANNEALING | ANNEALING |
| | | TEMPERATURE | TIME |
| No. | TYPE OF COATING | ° C. | min. |
| 201 | ORGANIC-INORGANIC COMPOSITE | 800 | 60 |
| 202 | ORGANIC-INORGANIC COMPOSITE | 800 | 60 |
| 203 | ORGANIC-INORGANIC COMPOSITE | 800 | 60 |
| 204 | ORGANIC-INORGANIC COMPOSITE | 800 | 60 |
| 205 | ORGANIC-INORGANIC COMPOSITE | 800 | 60 |
| 206 | ORGANIC-INORGANIC COMPOSITE | 800 | 60 |
| 207 | ORGANIC-INORGANIC COMPOSITE | 800 | 60 |
| 208 | ORGANIC-INORGANIC COMPOSITE | 800 | 60 |
| 209 | ORGANIC-INORGANIC COMPOSITE | 800 | 60 |
| 210 | ORGANIC-INORGANIC COMPOSITE | 800 | 60 |
| 211 | ORGANIC-INORGANIC COMPOSITE | 800 | 60 |
| 212 | ORGANIC-INORGANIC COMPOSITE | 800 | 60 |
| 213 | ORGANIC-INORGANIC COMPOSITE | 800 | 60 |
| 214 | ORGANIC-INORGANIC COMPOSITE | 800 | 60 |

TABLE 43

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 1 | S1 | 8 | 86 | 90 | 107 | 56 | 5.0 | 21 |
| 2 | S2 | 8 | 89 | 91 | 108 | 57 | 5.1 | 21 |
| 3 | S3 | 8 | 85 | 87 | 108 | 58 | 5.0 | 21 |
| 4 | S4 | 8 | 106 | 110 | 96 | 44 | 5.5 | 23 |
| 5 | S5 | 8 | 80 | 83 | 112 | 61 | 5.2 | 21 |
| 6 | S6 | 8 | 80 | 84 | 113 | 63 | 5.2 | 22 |
| 7 | S7 | 8 | 78 | 80 | 113 | 61 | 5.4 | 23 |
| 8 | S8 | 8 | 77 | 80 | 112 | 62 | 5.4 | 23 |
| 9 | S9 | 8 | 95 | 98 | 105 | 54 | 5.0 | 20 |
| 10 | S10 | 8 | 107 | 112 | 98 | 46 | 5.0 | 21 |
| 11 | S11 | 8 | 104 | 106 | 98 | 48 | 5.1 | 22 |
| 12 | S12 | 8 | 98 | 102 | 99 | 49 | 5.1 | 22 |
| 13 | S13 | 8 | 93 | 95 | 104 | 52 | 5.0 | 20 |
| 14 | S14 | 8 | 91 | 92 | 107 | 56 | 4.9 | 20 |
| 15 | S15 | 8 | 84 | 87 | 110 | 58 | 5.1 | 22 |
| 16 | S16 | — | — | — | — | — | — | — |
| 17 | S17 | 8 | 93 | 95 | 105 | 54 | 5.0 | 21 |
| 18 | S18 | 8 | 94 | 96 | 102 | 52 | 4.9 | 21 |
| 19 | S19 | 8 | 75 | 78 | 104 | 53 | 5.1 | 20 |
| 20 | S20 | 8 | 70 | 73 | 124 | 72 | 4.5 | 18 |
| 21 | S21 | — | — | — | — | — | — | — |
| 22 | S22 | 8 | 72 | 75 | 105 | 54 | 5.1 | 22 |
| 23 | S23 | 8 | 75 | 77 | 105 | 53 | 5.0 | 22 |
| 24 | S24 | 8 | 73 | 75 | 105 | 53 | 4.9 | 20 |
| 25 | S25 | 8 | 72 | 75 | 105 | 53 | 5.0 | 20 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 1 | 31 | 0.012 | 2.14 | 1.65 | INVENTIVE EXAMPLE |
| 2 | 30 | 0.013 | 2.12 | 1.66 | INVENTIVE EXAMPLE |
| 3 | 29 | 0.011 | 2.11 | 1.67 | INVENTIVE EXAMPLE |
| 4 | 36 | 0.014 | 2.08 | 1.72 | INVENTIVE EXAMPLE |
| 5 | 28 | 0.012 | 2.11 | 1.67 | INVENTIVE EXAMPLE |
| 6 | 28 | 0.013 | 2.10 | 1.67 | INVENTIVE EXAMPLE |
| 7 | 28 | 0.011 | 2.11 | 1.70 | INVENTIVE EXAMPLE |
| 8 | 28 | 0.014 | 2.10 | 1.70 | INVENTIVE EXAMPLE |
| 9 | 31 | 0.012 | 2.09 | 1.69 | INVENTIVE EXAMPLE |
| 10 | 37 | 0.014 | 2.08 | 1.68 | COMPARATIVE EXAMPLE |
| 11 | 35 | 0.011 | 2.09 | 1.68 | INVENTIVE EXAMPLE |
| 12 | 33 | 0.013 | 2.10 | 1.71 | INVENTIVE EXAMPLE |
| 13 | 32 | 0.012 | 2.10 | 1.70 | INVENTIVE EXAMPLE |
| 14 | 31 | 0.014 | 2.10 | 1.69 | INVENTIVE EXAMPLE |
| 15 | 30 | 0.011 | 2.11 | 1.69 | INVENTIVE EXAMPLE |
| 16 | — | — | — | — | COMPARATIVE EXAMPLE |
| 17 | 32 | 0.012 | 2.10 | 1.66 | INVENTIVE EXAMPLE |
| 18 | 32 | 0.014 | 2.09 | 1.66 | INVENTIVE EXAMPLE |
| 19 | 38 | 0.012 | 2.18 | 1.69 | COMPARATIVE EXAMPLE |
| 20 | 37 | 0.011 | 2.19 | 1.64 | COMPARATIVE EXAMPLE |
| 21 | — | — | — | — | COMPARATIVE EXAMPLE |
| 22 | 38 | 0.011 | 2.17 | 1.69 | COMPARATIVE EXAMPLE |
| 23 | 38 | 0.010 | 2.18 | 1.69 | COMPARATIVE EXAMPLE |
| 24 | 38 | 0.010 | 2.18 | 1.69 | COMPARATIVE EXAMPLE |
| 25 | 38 | 0.011 | 2.17 | 1.69 | COMPARATIVE EXAMPLE |

TABLE 44

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 26 | S26 | 8 | 95 | 96 | 106 | 54 | 5.0 | 22 |
| 27 | S27 | 8 | 93 | 95 | 106 | 54 | 5.1 | 20 |
| 28 | S28 | 8 | 95 | 98 | 107 | 55 | 5.1 | 20 |
| 29 | S29 | 8 | 74 | 75 | 106 | 54 | 5.1 | 22 |
| 30 | S30 | 8 | 75 | 77 | 105 | 54 | 5.1 | 20 |
| 31 | S31 | 8 | 75 | 76 | 106 | 55 | 4.9 | 21 |
| 32 | S32 | 8 | 61 | 62 | 133 | 82 | 5.1 | 22 |
| 33 | S33 | 8 | 95 | 98 | 105 | 53 | 5.1 | 21 |
| 34 | S34 | 8 | 93 | 95 | 106 | 54 | 5.1 | 20 |
| 35 | S35 | 8 | 72 | 75 | 105 | 54 | 4.9 | 20 |
| 36 | S36 | 10 | 95 | 97 | 105 | 54 | 4.9 | 21 |
| 37 | S37 | 10 | 94 | 95 | 104 | 54 | 5.1 | 21 |
| 38 | S38 | — | — | — | — | — | — | — |
| 39 | S39 | 8 | 95 | 96 | 105 | 53 | 4.9 | 20 |
| 40 | S40 | 8 | 95 | 97 | 104 | 54 | 5.0 | 22 |
| 41 | S41 | — | — | — | — | — | — | — |
| 42 | S42 | 8 | 95 | 96 | 105 | 53 | 5.0 | 21 |
| 43 | S43 | 8 | 91 | 95 | 105 | 54 | 5.1 | 22 |
| 44 | S44 | 8 | 75 | 77 | 104 | 53 | 4.9 | 22 |
| 45 | S45 | 8 | 75 | 76 | 105 | 55 | 5.1 | 22 |
| 46 | S46 | 8 | 72 | 75 | 105 | 54 | 5.0 | 21 |
| 47 | S47 | 8 | 75 | 78 | 107 | 55 | 4.9 | 21 |
| 48 | S48 | 8 | 71 | 75 | 104 | 53 | 4.9 | 20 |
| 49 | S49 | 8 | 73 | 75 | 105 | 53 | 5.1 | 20 |
| 50 | S50 | 8 | 75 | 77 | 106 | 55 | 4.9 | 22 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 26 | 32 | 0.013 | 2.09 | 1.69 | INVENTIVE EXAMPLE |
| 27 | 31 | 0.011 | 2.10 | 1.69 | INVENTIVE EXAMPLE |
| 28 | 33 | 0.012 | 2.09 | 1.69 | INVENTIVE EXAMPLE |
| 29 | 38 | 0.011 | 2.18 | 1.69 | COMPARATIVE EXAMPLE |
| 30 | 38 | 0.010 | 2.19 | 1.69 | COMPARATIVE EXAMPLE |
| 31 | 38 | 0.011 | 2.18 | 1.69 | COMPARATIVE EXAMPLE |
| 32 | 43 | 0.010 | 2.19 | 1.51 | COMPARATIVE EXAMPLE |
| 33 | 38 | 0.014 | 2.16 | 1.64 | COMPARATIVE EXAMPLE |
| 34 | 38 | 0.013 | 2.14 | 1.60 | COMPARATIVE EXAMPLE |
| 35 | 38 | 0.010 | 2.17 | 1.69 | COMPARATIVE EXAMPLE |
| 36 | 35 | 0.012 | 2.15 | 1.69 | INVENTIVE EXAMPLE |
| 37 | 36 | 0.012 | 2.16 | 1.69 | INVENTIVE EXAMPLE |
| 38 | — | — | — | — | COMPARATIVE EXAMPLE |
| 39 | 31 | 0.011 | 2.17 | 1.69 | INVENTIVE EXAMPLE |
| 40 | 31 | 0.012 | 2.14 | 1.69 | INVENTIVE EXAMPLE |
| 41 | — | — | — | — | COMPARATIVE EXAMPLE |
| 42 | 32 | 0.013 | 2.15 | 1.69 | INVENTIVE EXAMPLE |
| 43 | 33 | 0.014 | 2.14 | 1.69 | INVENTIVE EXAMPLE |
| 44 | 38 | 0.011 | 2.17 | 1.69 | COMPARATIVE EXAMPLE |
| 45 | 38 | 0.011 | 2.18 | 1.69 | COMPARATIVE EXAMPLE |
| 46 | 38 | 0.010 | 2.18 | 1.69 | COMPARATIVE EXAMPLE |
| 47 | 38 | 0.011 | 2.18 | 1.69 | COMPARATIVE EXAMPLE |
| 48 | 38 | 0.010 | 2.17 | 1.69 | COMPARATIVE EXAMPLE |
| 49 | 38 | 0.010 | 2.19 | 1.69 | COMPARATIVE EXAMPLE |
| 50 | 38 | 0.011 | 2.17 | 1.69 | COMPARATIVE EXAMPLE |

TABLE 45

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 51 | S51 | 8 | 95 | 99 | 105 | 55 | 5.0 | 20 |
| 52 | S52 | 8 | 95 | 98 | 105 | 53 | 5.0 | 21 |
| 53 | S53 | 8 | 92 | 95 | 107 | 55 | 4.9 | 22 |
| 54 | S54 | 8 | 95 | 97 | 103 | 53 | 5.1 | 20 |
| 55 | S55 | 8 | 81 | 83 | 111 | 61 | 4.9 | 22 |
| 56 | S56 | 8 | 92 | 95 | 105 | 54 | 4.9 | 21 |
| 57 | S57 | 8 | 95 | 97 | 104 | 53 | 5.0 | 20 |
| 58 | S58 | 8 | 94 | 95 | 105 | 54 | 4.9 | 21 |
| 59 | S59 | 8 | 95 | 96 | 107 | 55 | 5.1 | 21 |
| 60 | S60 | 8 | 93 | 95 | 104 | 54 | 5.0 | 20 |
| 61 | S61 | 8 | 92 | 95 | 103 | 53 | 5.0 | 21 |
| 62 | S62 | 8 | 95 | 98 | 106 | 55 | 5.0 | 21 |
| 63 | S63 | 8 | 95 | 97 | 105 | 53 | 5.0 | 21 |
| 64 | S64 | 8 | 92 | 95 | 105 | 53 | 5.1 | 20 |
| 65 | S65 | 8 | 82 | 85 | 113 | 61 | 5.0 | 20 |
| 66 | S66 | 8 | 76 | 77 | 116 | 64 | 5.0 | 21 |
| 67 | S9 | 8 | 95 | 97 | 104 | 54 | 2.0 | 10 |
| 68 | S9 | 8 | 92 | 95 | 104 | 54 | 2.3 | 10 |
| 69 | S9 | 8 | 91 | 95 | 105 | 54 | 2.4 | 12 |
| 70 | S9 | 8 | 95 | 98 | 105 | 54 | 2.3 | 11 |
| 71 | S9 | 8 | 65 | 66 | 105 | 54 | 5.5 | 24 |
| 72 | S9 | 8 | 93 | 95 | 105 | 53 | 3.5 | 19 |
| 73 | S9 | 8 | 95 | 96 | 106 | 55 | 4.8 | 19 |
| 74 | S9 | 8 | 95 | 97 | 103 | 53 | 2.5 | 18 |
| 75 | S9 | 8 | 49 | 50 | 107 | 55 | 7.5 | 30 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 51 | 32 | 0.013 | 2.16 | 1.69 | INVENTIVE EXAMPLE |
| 52 | 32 | 0.012 | 2.15 | 1.69 | INVENTIVE EXAMPLE |
| 53 | 33 | 0.011 | 2.14 | 1.69 | INVENTIVE EXAMPLE |
| 54 | 32 | 0.014 | 2.15 | 1.69 | INVENTIVE EXAMPLE |
| 55 | 29 | 0.012 | 2.14 | 1.65 | INVENTIVE EXAMPLE |
| 56 | 31 | 0.014 | 2.14 | 1.68 | INVENTIVE EXAMPLE |
| 57 | 31 | 0.012 | 2.15 | 1.67 | INVENTIVE EXAMPLE |
| 58 | 32 | 0.013 | 2.15 | 1.69 | INVENTIVE EXAMPLE |
| 59 | 32 | 0.014 | 2.14 | 1.69 | INVENTIVE EXAMPLE |
| 60 | 32 | 0.011 | 2.15 | 1.69 | INVENTIVE EXAMPLE |
| 61 | 32 | 0.011 | 2.14 | 1.69 | INVENTIVE EXAMPLE |
| 62 | 32 | 0.014 | 2.13 | 1.69 | INVENTIVE EXAMPLE |
| 63 | 32 | 0.012 | 2.13 | 1.69 | INVENTIVE EXAMPLE |
| 64 | 32 | 0.013 | 2.14 | 1.69 | INVENTIVE EXAMPLE |
| 65 | 29 | 0.013 | 2.16 | 1.67 | INVENTIVE EXAMPLE |
| 66 | 27 | 0.012 | 2.17 | 1.66 | INVENTIVE EXAMPLE |
| 67 | 36 | 0.007 | 2.22 | 1.61 | INVENTIVE EXAMPLE |
| 68 | 34 | 0.008 | 2.21 | 1.61 | INVENTIVE EXAMPLE |
| 69 | 34 | 0.009 | 2.21 | 1.62 | INVENTIVE EXAMPLE |
| 70 | 33 | 0.009 | 2.22 | 1.63 | INVENTIVE EXAMPLE |
| 71 | 34 | 0.012 | 2.18 | 1.69 | INVENTIVE EXAMPLE |
| 72 | 33 | 0.014 | 2.16 | 1.72 | INVENTIVE EXAMPLE |
| 73 | 35 | 0.013 | 2.15 | 1.66 | INVENTIVE EXAMPLE |
| 74 | 36 | 0.014 | 2.17 | 1.62 | INVENTIVE EXAMPLE |
| 75 | 36 | 0.012 | 2.21 | 1.73 | INVENTIVE EXAMPLE |

TABLE 46

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 76 | S9 | 8 | 93 | 95 | 107 | 55 | 2.6 | 18 |
| 77 | S9 | 8 | 140 | 146 | 104 | 54 | 6.0 | 25 |
| 78 | S9 | 76 | 92 | 95 | 106 | 55 | 3.3 | 19 |
| 79 | S9 | 8 | 91 | 95 | 104 | 53 | 4.8 | 21 |
| 80 | S9 | 8 | 95 | 97 | 105 | 55 | 4.7 | 20 |
| 81 | S9 | 8 | 95 | 99 | 104 | 53 | 4.6 | 18 |
| 82 | S9 | 8 | 92 | 95 | 54 | 53 | 4.9 | 21 |
| 83 | S9 | 60 | 95 | 97 | 103 | 53 | 5.1 | 21 |
| 84 | S9 | 70 | 95 | 98 | 106 | 54 | 5.1 | 21 |
| 85 | S9 | 15 | 92 | 95 | 106 | 55 | 4.9 | 20 |
| 86 | S9 | 23 | 25 | 95 | 104 | 54 | 4.9 | 22 |
| 87 | S9 | 12 | 95 | 96 | 107 | 55 | 4.9 | 22 |
| 88 | S9 | 25 | 91 | 95 | 106 | 54 | 4.9 | 22 |
| 89 | S9 | 11 | 95 | 97 | 104 | 54 | 4.9 | 22 |
| 90 | S9 | 12 | 94 | 95 | 105 | 55 | 4.9 | 21 |
| 91 | S9 | 12 | 22 | 95 | 103 | 53 | 5.1 | 21 |
| 92 | S9 | 45 | 95 | 98 | 107 | 55 | 5.1 | 20 |
| 93 | S9 | 26 | 92 | 95 | 105 | 54 | 5.0 | 21 |
| 94 | S9 | 16 | 18 | 97 | 103 | 53 | 4.9 | 22 |
| 95 | S9 | 13 | 93 | 95 | 104 | 53 | 5.0 | 21 |
| 96 | S9 | 6 | 45 | 95 | 107 | 55 | 5.1 | 22 |
| 97 | S9 | 6 | 48 | 96 | 104 | 54 | 5.0 | 21 |
| 98 | S9 | 12 | 95 | 98 | 105 | 55 | 4.9 | 20 |
| 99 | S9 | 8 | 47 | 95 | 105 | 55 | 4.9 | 20 |
| 100 | S9 | 15 | 91 | 95 | 107 | 55 | 4.9 | 21 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 76 | 35 | 0.011 | 2.16 | 1.63 | INVENTIVE EXAMPLE |
| 77 | 36 | 0.012 | 2.07 | 1.71 | INVENTIVE EXAMPLE |
| 78 | 72 | 0.012 | 2.13 | 1.71 | COMPARATIVE EXAMPLE |
| 79 | 29 | 0.013 | 2.12 | 1.69 | INVENTIVE EXAMPLE |
| 80 | 21 | 0.012 | 2.13 | 1.59 | COMPARATIVE EXAMPLE |
| 81 | 81 | 0.011 | 2.15 | 1.69 | COMPARATIVE EXAMPLE |
| 82 | 35 | 0.014 | 2.16 | 1.71 | INVENTIVE EXAMPLE |
| 83 | 38 | 0.013 | 2.13 | 1.67 | COMPARATIVE EXAMPLE |
| 84 | 39 | 0.013 | 2.12 | 1.66 | COMPARATIVE EXAMPLE |
| 85 | 37 | 0.012 | 2.14 | 1.68 | COMPARATIVE EXAMPLE |
| 86 | 40 | 0.009 | 2.22 | 1.62 | COMPARATIVE EXAMPLE |
| 87 | 37 | 0.013 | 2.15 | 1.69 | COMPARATIVE EXAMPLE |
| 88 | 38 | 0.012 | 2.14 | 1.69 | COMPARATIVE EXAMPLE |
| 89 | 37 | 0.014 | 2.13 | 1.69 | COMPARATIVE EXAMPLE |
| 90 | 37 | 0.014 | 2.14 | 1.69 | COMPARATIVE EXAMPLE |
| 91 | 39 | 0.009 | 2.21 | 1.64 | COMPARATIVE EXAMPLE |
| 92 | 37 | 0.013 | 2.16 | 1.69 | COMPARATIVE EXAMPLE |
| 93 | 38 | 0.012 | 2.15 | 1.63 | COMPARATIVE EXAMPLE |
| 94 | 40 | 0.008 | 2.22 | 1.61 | COMPARATIVE EXAMPLE |
| 95 | 37 | 0.013 | 2.15 | 1.69 | COMPARATIVE EXAMPLE |
| 96 | 31 | 0.009 | 2.21 | 1.69 | INVENTIVE EXAMPLE |
| 97 | 33 | 0.009 | 2.21 | 1.69 | INVENTIVE EXAMPLE |
| 98 | 37 | 0.011 | 2.16 | 1.69 | COMPARATIVE EXAMPLE |
| 99 | 36 | 0.009 | 2.21 | 1.64 | INVENTIVE EXAMPLE |
| 100 | 37 | 0.012 | 2.14 | 1.69 | COMPARATIVE EXAMPLE |

TABLE 47

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 101 | S9 | 12 | 95 | 96 | 104 | 54 | 4.9 | 21 |
| 102 | S9 | 8 | 40 | 98 | 104 | 53 | 5.0 | 22 |
| 103 | S9 | 11 | 120 | 126 | 105 | 53 | 5.1 | 22 |
| 104 | S9 | 8 | 49 | 80 | 105 | 54 | 4.9 | 22 |
| 105 | S9 | 8 | 47 | 66 | 106 | 54 | 3.5 | 18 |
| 106 | S9 | 40 | 114 | 120 | 103 | 53 | 4.9 | 22 |
| 107 | s9 | 15 | 26 | 95 | 104 | 54 | 4.9 | 21 |
| 108 | S9 | 10 | 48 | 95 | 104 | 54 | 5.0 | 20 |
| 109 | S9 | 13 | 95 | 97 | 106 | 54 | 4.9 | 21 |
| 110 | S9 | 8 | 47 | 95 | 107 | 55 | 4.9 | 22 |
| 111 | S9 | 8 | 45 | 72 | 103 | 53 | 5.0 | 21 |
| 112 | S9 | 16 | 97 | 100 | 106 | 54 | 4.9 | 22 |
| 113 | S9 | 15 | 95 | 98 | 104 | 53 | 5.0 | 21 |
| 114 | S9 | 35 | 95 | 96 | 106 | 55 | 5.0 | 21 |
| 115 | S9 | 8 | 92 | 95 | 106 | 55 | 4.9 | 22 |
| 116 | S9 | 8 | 95 | 97 | 105 | 54 | 5.0 | 22 |
| 117 | S9 | 25 | 95 | 96 | 105 | 53 | 5.0 | 21 |
| 118 | S9 | 15 | 92 | 95 | 106 | 55 | 4.9 | 22 |
| 119 | S9 | 8 | 49 | 95 | 107 | 55 | 5.0 | 20 |
| 120 | sg | 50 | 95 | 96 | 107 | 55 | 4.9 | 21 |
| 121 | S9 | 35 | 95 | 98 | 105 | 53 | 4.9 | 22 |
| 122 | S9 | 24 | 91 | 95 | 105 | 53 | 5.0 | 21 |
| 123 | S9 | 8 | 47 | 98 | 105 | 54 | 4.9 | 21 |
| 124 | S9 | 8 | 93 | 95 | 104 | 53 | 4.9 | 20 |
| 125 | S9 | 8 | 45 | 46 | 104 | 54 | 5.1 | 20 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 101 | 37 | 0.013 | 2.13 | 1.69 | COMPARATIVE EXAMPLE |
| 102 | 36 | 0.009 | 2.21 | 1.62 | INVENTIVE EXAMPLE |
| 103 | 37 | 0.014 | 2.08 | 1.66 | COMPARATIVE EXAMPLE |
| 104 | 31 | 0.009 | 2.21 | 1.67 | INVENTIVE EXAMPLE |
| 105 | 33 | 0.009 | 2.22 | 1.63 | INVENTIVE EXAMPLE |
| 106 | 40 | 0.013 | 2.08 | 1.69 | COMPARATIVE EXAMPLE |
| 107 | 41 | 0.008 | 2.22 | 1.63 | COMPARATIVE EXAMPLE |
| 108 | 35 | 0.009 | 2.21 | 1.69 | INVENTIVE EXAMPLE |
| 109 | 38 | 0.011 | 2.13 | 1.69 | COMPARATIVE EXAMPLE |
| 110 | 36 | 0.009 | 2.21 | 1.62 | INVENTIVE EXAMPLE |
| 111 | 34 | 0.008 | 2.21 | 1.69 | INVENTIVE EXAMPLE |
| 112 | 37 | 0.013 | 2.14 | 1.69 | COMPARATIVE EXAMPLE |
| 113 | 37 | 0.012 | 2.15 | 1.69 | COMPARATIVE EXAMPLE |
| 114 | 38 | 0.012 | 2.15 | 1.69 | COMPARATIVE EXAMPLE |
| 115 | 31 | 0.013 | 2.14 | 1.69 | INVENTIVE EXAMPLE |
| 116 | 34 | 0.011 | 2.13 | 1.69 | INVENTIVE EXAMPLE |
| 117 | 38 | 0.011 | 2.15 | 1.69 | COMPARATIVE EXAMPLE |
| 118 | 37 | 0.011 | 2.14 | 1.69 | COMPARATIVE EXAMPLE |
| 119 | 36 | 0.009 | 2.21 | 1.63 | INVENTIVE EXAMPLE |
| 120 | 42 | 0.011 | 2.16 | 1.69 | COMPARATIVE EXAMPLE |
| 121 | 39 | 0.012 | 2.15 | 1.69 | COMPARATIVE EXAMPLE |
| 122 | 38 | 0.011 | 2.17 | 1.69 | COMPARATIVE EXAMPLE |
| 123 | 36 | 0.009 | 2.21 | 1.69 | INVENTIVE EXAMPLE |
| 124 | — | — | — | — | COMPARATIVE EXAMPLE |
| 125 | 36 | 0.008 | 2.22 | 1.62 | INVENTIVE EXAMPLE |

TABLE 48

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 126 | S9 | 60 | 110 | 112 | 103 | 53 | 4.9 | 20 |
| 127 | S9 | 8 | 54 | 55 | 104 | 53 | 5.0 | 22 |
| 128 | S9 | 8 | 120 | 125 | 106 | 54 | 5.0 | 22 |
| 129 | S67 | 8 | 95 | 96 | 59 | 45 | 5.1 | 20 |
| 130 | S68 | 8 | 93 | 95 | 57 | 47 | 5.1 | 20 |
| 131 | S69 | 8 | 95 | 98 | 133 | 63 | 5.1 | 22 |
| 132 | S70 | 8 | 92 | 95 | 118 | 63 | 5.1 | 20 |
| 133 | S71 | 8 | 91 | 95 | 57 | 47 | 5.0 | 20 |
| 134 | S72 | 8 | 95 | 98 | 59 | 50 | 5.1 | 20 |
| 135 | S73 | 8 | 93 | 95 | 143 | 63 | 4.9 | 20 |
| 136 | S74 | 18 | 37 | 72 | 53 | 53 | 4.5 | 19 |
| 137 | S9 | 8 | 95 | 98 | 105 | 54 | 5.0 | 20 |
| 138 | S75 | 8 | 89 | 91 | 108 | 57 | 5.1 | 21 |
| 139 | S76 | 8 | 93 | 95 | 105 | 54 | 5.0 | 21 |
| 140 | S9 | — | — | — | — | — | — | — |
| 141 | S9 | 6 | 93 | 98 | 105 | 54 | 5.0 | 20 |
| 142 | S9 | 8 | 93 | 98 | 105 | 54 | 5.0 | 20 |
| 143 | S9 | 9 | 96 | 98 | 105 | 54 | 5.0 | 20 |
| 144 | SS | 9 | 97 | 98 | 105 | 54 | 5.0 | 20 |
| 145 | S9 | 10 | 97 | 98 | 105 | 54 | 5.0 | 20 |
| 146 | S9 | 10 | 96 | 98 | 105 | 54 | 5.0 | 20 |
| 147 | S9 | 6 | 93 | 98 | 105 | 54 | 5.0 | 20 |
| 148 | S9 | 6 | 92 | 98 | 105 | 54 | 5.0 | 20 |
| 149 | S9 | 10 | 95 | 98 | 105 | 54 | 5.0 | 20 |
| 150 | S9 | 7 | 94 | 98 | 105 | 54 | 5.0 | 20 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 126 | 37 | 0.012 | 2.09 | 1.69 | COMPARATIVE EXAMPLE |
| 127 | 31 | 0.013 | 2.17 | 1.69 | INVENTIVE EXAMPLE |
| 128 | 35 | 0.012 | 2.08 | 1.69 | INVENTIVE EXAMPLE |
| 129 | 35 | 0.014 | 2.14 | 1.72 | INVENTIVE EXAMPLE |
| 130 | 36 | 0.012 | 2.15 | 1.68 | INVENTIVE EXAMPLE |
| 131 | 33 | 0.013 | 2.14 | 1.62 | INVENTIVE EXAMPLE |
| 132 | 34 | 0.012 | 2.15 | 1.61 | INVENTIVE EXAMPLE |
| 133 | 36 | 0.011 | 2.15 | 1.64 | INVENTIVE EXAMPLE |
| 134 | 36 | 0.013 | 2.14 | 1.70 | INVENTIVE EXAMPLE |
| 135 | 33 | 0.012 | 2.13 | 1.61 | INVENTIVE EXAMPLE |
| 136 | 41 | 0.008 | 2.21 | 1.62 | COMPARATIVE EXAMPLE |
| 137 | 31 | 0.014 | 2.16 | 1.69 | INVENTIVE EXAMPLE |
| 138 | 30 | 0.013 | 2.12 | 1.66 | INVENTIVE EXAMPLE |
| 139 | 32 | 0.012 | 2.10 | 1.66 | INVENTIVE EXAMPLE |
| 140 | — | — | — | — | COMPARATIVE EXAMPLE |
| 141 | 29 | 0.012 | 2.09 | 1.69 | INVENTIVE EXAMPLE |
| 142 | 30 | 0.012 | 2.09 | 1.69 | INVENTIVE EXAMPLE |
| 143 | 32 | 0.012 | 2.09 | 1.69 | INVENTIVE EXAMPLE |
| 144 | 33 | 0.012 | 2.09 | 1.69 | INVENTIVE EXAMPLE |
| 145 | 34 | 0.012 | 2.09 | 1.69 | INVENTIVE EXAMPLE |
| 146 | 33 | 0.012 | 2.09 | 1.69 | INVENTIVE EXAMPLE |
| 147 | 29 | 0.012 | 2.09 | 1.69 | INVENTIVE EXAMPLE |
| 148 | 28 | 0.012 | 2.09 | 1.69 | INVENTIVE EXAMPLE |
| 149 | 33 | 0.012 | 2.09 | 1.69 | INVENTIVE EXAMPLE |
| 150 | 29 | 0.012 | 2.09 | 1.69 | INVENTIVE EXAMPLE |

TABLE 49

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 151 | S9 | 9 | 95 | 98 | 105 | 54 | 5.0 | 20 |
| 152 | S9 | 8 | 95 | 98 | 105 | 54 | 5.0 | 20 |
| 153 | S9 | 7 | 95 | 98 | 105 | 54 | 5.0 | 20 |
| 154 | S9 | 8 | 95 | 98 | 105 | 54 | 5.0 | 20 |
| 155 | S9 | 9 | 95 | 98 | 105 | 54 | 5.0 | 20 |
| 156 | S9 | 9 | 95 | 98 | 105 | 54 | 5.0 | 20 |
| 157 | S9 | 10 | 95 | 98 | 105 | 54 | 5.0 | 20 |
| 158 | S9 | 8 | 95 | 98 | 105 | 54 | 5.0 | 20 |
| 159 | S9 | 8 | 95 | 98 | 105 | 54 | 5.0 | 20 |
| 160 | S9 | 7 | 95 | 98 | 105 | 54 | 5.0 | 20 |
| 161 | S9 | 9 | 95 | 98 | 105 | 54 | 5.0 | 20 |
| 162 | S9 | 8 | 95 | 98 | 105 | 54 | 5.0 | 20 |
| 163 | S9 | 8 | 95 | 98 | 105 | 54 | 5.0 | 20 |
| 164 | S9 | 9 | 95 | 98 | 105 | 54 | 5.0 | 20 |
| 165 | S9 | 8 | 95 | 98 | 105 | 54 | 5.0 | 20 |
| 166 | S9 | 8 | 95 | 98 | 105 | 54 | 5.0 | 20 |
| 167 | S9 | 9 | 95 | 98 | 105 | 54 | 5.0 | 20 |
| 168 | S9 | 9 | 95 | 98 | 105 | 54 | 5.0 | 20 |
| 169 | S9 | 9 | 95 | 98 | 105 | 54 | 5.0 | 20 |
| 170 | S9 | 9 | 95 | 98 | 105 | 54 | 5.0 | 20 |
| 171 | S9 | 8 | 95 | 98 | 105 | 54 | 5.0 | 20 |
| 172 | S9 | 8 | 95 | 98 | 105 | 54 | 5.0 | 20 |
| 173 | S9 | 7 | 95 | 98 | 105 | 54 | 5.0 | 20 |
| 174 | S9 | 7 | 95 | 98 | 105 | 54 | 5.0 | 20 |
| 175 | S9 | 8 | 95 | 98 | 105 | 54 | 5.0 | 20 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 151 | 32 | 0.012 | 2.09 | 1.69 | INVENTIVE EXAMPLE |
| 152 | 30 | 0.012 | 2.09 | 1.69 | INVENTIVE EXAMPLE |
| 153 | 30 | 0.012 | 2.09 | 1.69 | INVENTIVE EXAMPLE |
| 154 | 31 | 0.012 | 2.09 | 1.69 | INVENTIVE EXAMPLE |
| 155 | 31 | 0.012 | 2.09 | 1.69 | INVENTIVE EXAMPLE |
| 156 | 32 | 0.012 | 2.09 | 1.69 | INVENTIVE EXAMPLE |
| 157 | 33 | 0.012 | 2.09 | 1.69 | INVENTIVE EXAMPLE |
| 158 | 32 | 0.012 | 2.09 | 1.69 | INVENTIVE EXAMPLE |
| 159 | 30 | 0.012 | 2.09 | 1.69 | INVENTIVE EXAMPLE |
| 160 | 30 | 0.012 | 2.09 | 1.69 | INVENTIVE EXAMPLE |
| 161 | 32 | 0.012 | 2.09 | 1.69 | INVENTIVE EXAMPLE |
| 162 | 30 | 0.012 | 2.09 | 1.71 | INVENTIVE EXAMPLE |
| 163 | 30 | 0.012 | 2.09 | 1.69 | INVENTIVE EXAMPLE |
| 164 | 31 | 0.012 | 2.09 | 1.69 | INVENTIVE EXAMPLE |
| 165 | 30 | 0.012 | 2.09 | 1.69 | INVENTIVE EXAMPLE |
| 166 | 30 | 0.012 | 2.09 | 1.69 | INVENTIVE EXAMPLE |
| 167 | 31 | 0.012 | 2.09 | 1.69 | INVENTIVE EXAMPLE |
| 168 | 32 | 0.012 | 2.09 | 1.69 | INVENTIVE EXAMPLE |
| 169 | 32 | 0.012 | 2.09 | 1.69 | INVENTIVE EXAMPLE |
| 170 | 32 | 0.012 | 2.09 | 1.69 | INVENTIVE EXAMPLE |
| 171 | 31 | 0.012 | 2.09 | 1.69 | INVENTIVE EXAMPLE |
| 172 | 31 | 0.012 | 2.09 | 1.69 | INVENTIVE EXAMPLE |
| 173 | 30 | 0.012 | 2.09 | 1.69 | INVENTIVE EXAMPLE |
| 174 | 30 | 0.012 | 2.09 | 1.69 | INVENTIVE EXAMPLE |
| 175 | 30 | 0.012 | 2.09 | 1.69 | INVENTIVE EXAMPLE |

TABLE 50

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 176 | S9 | 8 | 95 | 98 | 105 | 54 | 5.0 | 20 |
| 177 | S9 | 9 | 95 | 98 | 105 | 54 | 5.0 | 20 |
| 178 | S9 | 8 | 95 | 98 | 105 | 54 | 5.0 | 20 |
| 179 | S9 | 8 | 95 | 98 | 105 | 54 | 5.0 | 20 |
| 180 | S9 | 7 | 95 | 98 | 105 | 54 | 5.0 | 20 |
| 181 | S9 | 10 | 95 | 98 | 105 | 54 | 5.0 | 20 |
| 182 | S9 | 10 | 95 | 98 | 105 | 54 | 5.0 | 20 |
| 183 | S9 | 8 | 95 | 98 | 105 | 54 | 5.0 | 20 |
| 184 | S9 | 8 | 95 | 98 | 105 | 54 | 5.0 | 20 |
| 185 | S9 | 7 | 95 | 98 | 105 | 54 | 5.0 | 20 |
| 186 | S9 | 8 | 95 | 98 | 105 | 54 | 5.0 | 20 |
| 187 | S9 | 10 | 95 | 98 | 105 | 54 | 5.0 | 20 |
| 188 | S9 | 10 | 95 | 98 | 105 | 54 | 5.0 | 20 |
| 189 | S9 | 7 | 94 | 96 | 105 | 54 | 5.0 | 20 |
| 190 | S9 | 8 | 95 | 98 | 105 | 54 | 5.0 | 20 |
| 191 | S9 | 8 | 97 | 100 | 105 | 54 | 5.0 | 20 |
| 192 | S9 | 10 | 98 | 100 | 105 | 54 | 5.0 | 20 |
| 193 | S9 | 8 | 95 | 98 | 105 | 54 | 5.0 | 20 |
| 194 | S9 | 8 | 96 | 99 | 105 | 54 | 5.0 | 20 |
| 195 | S9 | 8 | 95 | 98 | 105 | 54 | 5.0 | 20 |
| 196 | S9 | 8 | 95 | 98 | 105 | 54 | 5.0 | 20 |
| 197 | S9 | 8 | 95 | 98 | 105 | 54 | 5.0 | 20 |
| 198 | S9 | 8 | 95 | 98 | 105 | 54 | 5.0 | 20 |
| 199 | S9 | 8 | 95 | 98 | 105 | 54 | 5.0 | 20 |
| 200 | S9 | 8 | 95 | 98 | 105 | 54 | 5.0 | 20 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 176 | 31 | 0.012 | 2.09 | 1.69 | INVENTIVE EXAMPLE |
| 177 | 32 | 0.012 | 2.09 | 1.69 | INVENTIVE EXAMPLE |
| 178 | 31 | 0.012 | 2.09 | 1.69 | INVENTIVE EXAMPLE |
| 179 | 31 | 0.012 | 2.09 | 1.69 | INVENTIVE EXAMPLE |
| 180 | 30 | 0.012 | 2.09 | 1.69 | INVENTIVE EXAMPLE |
| 181 | 33 | 0.010 | 2.11 | 1.68 | INVENTIVE EXAMPLE |
| 182 | 32 | 0.011 | 2.10 | 1.69 | INVENTIVE EXAMPLE |
| 183 | 30 | 0.013 | 2.08 | 1.69 | INVENTIVE EXAMPLE |
| 184 | 29 | 0.014 | 2.07 | 1.70 | INVENTIVE EXAMPLE |
| 185 | 28 | 0.014 | 2.07 | 1.71 | INVENTIVE EXAMPLE |
| 186 | 29 | 0.013 | 2.08 | 1.70 | INVENTIVE EXAMPLE |
| 187 | 32 | 0.011 | 2.10 | 1.69 | INVENTIVE EXAMPLE |
| 188 | 33 | 0.010 | 2.11 | 1.68 | INVENTIVE EXAMPLE |
| 189 | 30 | 0.012 | 2.12 | 1.70 | INVENTIVE EXAMPLE |
| 190 | 31 | 0.012 | 2.10 | 1.69 | INVENTIVE EXAMPLE |
| 191 | 31 | 0.012 | 2.07 | 1.69 | INVENTIVE EXAMPLE |
| 192 | 32 | 0.012 | 2.06 | 1.68 | INVENTIVE EXAMPLE |
| 193 | 31 | 0.012 | 2.09 | 1.69 | INVENTIVE EXAMPLE |
| 194 | 31 | 0.012 | 2.10 | 1.69 | INVENTIVE EXAMPLE |
| 195 | 31 | 0.010 | 2.12 | 1.69 | INVENTIVE EXAMPLE |
| 196 | 31 | 0.011 | 2.11 | 1.69 | INVENTIVE EXAMPLE |
| 197 | 31 | 0.012 | 2.09 | 1.69 | INVENTIVE EXAMPLE |
| 198 | 31 | 0.012 | 2.09 | 1.69 | INVENTIVE EXAMPLE |
| 199 | 31 | 0.014 | 2.07 | 1.69 | INVENTIVE EXAMPLE |
| 200 | 31 | 0.012 | 2.09 | 1.69 | INVENTIVE EXAMPLE |

TABLE 51

| | | MANUFACTURING RESULTS | | | | | | |
|---|---|---|---|---|---|---|---|---|
| | | AVERAGE GRAIN SIZE | | | | | | |
| | | FROM SURFACE | FROM | FROM | R VALUE | | | |
| | | OF BASE | 1/20 OF | ¼ OF | FROM SURFACE | FROM | | |
| | | STEEL SHEET | THICKNESS | THICKNESS | OF BASE | 1/10 OF | {100} ORIENTED GRAINS | |
| | | TO 1/20 OF | TO ¼ OF | TO ½ OF | STEEL SHEET | THICKNESS | | AREA |
| | STEEL | THICKNESS | THICKNESS | THICKNESS | TO 1/10 OF | TO ½ OF | REFLECTED | FRACTION |
| No. | TYPE | μm | μm | μm | THICKNESS | THICKNESS | INTENSITY | area % |
| 201 | S9 | 8 | 95 | 98 | 105 | 54 | 5.0 | 20 |
| 202 | S9 | 10 | 95 | 98 | 105 | 54 | 5.0 | 20 |
| 203 | S9 | 9 | 95 | 98 | 105 | 54 | 5.0 | 20 |
| 204 | S9 | 8 | 95 | 98 | 105 | 54 | 5.0 | 20 |
| 205 | S9 | 8 | 95 | 98 | 105 | 54 | 5.0 | 20 |
| 206 | S9 | 8 | 95 | 98 | 105 | 54 | 5.0 | 20 |
| 207 | S9 | 8 | 95 | 98 | 105 | 54 | 5.0 | 20 |
| 208 | S9 | 9 | 95 | 98 | 105 | 54 | 5.0 | 20 |
| 209 | S9 | 10 | 95 | 98 | 105 | 54 | 5.0 | 20 |
| 210 | S9 | 8 | 95 | 98 | 105 | 54 | 5.0 | 20 |
| 211 | S9 | 9 | 95 | 98 | 105 | 54 | 5.0 | 20 |
| 212 | S9 | 8 | 95 | 98 | 105 | 54 | 5.0 | 20 |
| 213 | S9 | 9 | 95 | 98 | 105 | 54 | 5.0 | 20 |
| 214 | S67 | 8 | 95 | 96 | 62 | 45 | 5.1 | 20 |

| | EVALUATION RESULTS | | | | |
|---|---|---|---|---|---|
| | | | | MAGNETIC | |
| | | MAGNETIC | | FLUX | |
| | IRON LOSS | PERMEABILITY | IRON LOSS | DENSITY | |
| | W_{10/1k} | μ1.0 | W15/50 | B₅₀ | |
| No. | W/kg | H/m | W/kg | T | NOTE |
| 201 | 31 | 0.011 | 2.10 | 1.69 | INVENTIVE EXAMPLE |
| 202 | 32 | 0.012 | 2.09 | 1.69 | INVENTIVE EXAMPLE |
| 203 | 31 | 0.012 | 2.09 | 1.69 | INVENTIVE EXAMPLE |
| 204 | 30 | 0.012 | 2.09 | 1.69 | INVENTIVE EXAMPLE |
| 205 | 30 | 0.012 | 2.09 | 1.69 | INVENTIVE EXAMPLE |
| 206 | 31 | 0.012 | 2.09 | 1.69 | INVENTIVE EXAMPLE |
| 207 | 31 | 0.012 | 2.09 | 1.69 | INVENTIVE EXAMPLE |
| 208 | 32 | 0.012 | 2.09 | 1.69 | INVENTIVE EXAMPLE |
| 209 | 32 | 0.012 | 2.09 | 1.69 | INVENTIVE EXAMPLE |
| 210 | 31 | 0.012 | 2.09 | 1.69 | INVENTIVE EXAMPLE |
| 211 | 32 | 0.012 | 2.09 | 1.69 | INVENTIVE EXAMPLE |
| 212 | 31 | 0.012 | 2.09 | 1.69 | INVENTIVE EXAMPLE |
| 213 | 31 | 0.012 | 2.09 | 1.69 | INVENTIVE EXAMPLE |
| 214 | 34 | 0.014 | 2.14 | 1.72 | INVENTIVE EXAMPLE |

### INDUSTRIAL APPLICABILITY

According to the above aspects of the present invention, it is possible to provide a non-oriented electrical steel sheet having excellent high-frequency iron loss. In addition, it is possible to provide an iron core including the non-oriented electrical steel sheet and a manufacturing method for the iron core, and a motor including the iron core and a manufacturing method for the motor. Accordingly, the present invention has significant industrial applicability.

### REFERENCE SIGNS LIST

1 Non-oriented electrical steel sheet
11 Insulating coating
12 Base steel sheet
12a Surface region which ranges from surface of base steel sheet to 1/20 of thickness
12b Intermediate region which ranges from 1/20 of thickness to ¼ of thickness of base steel sheet
12c Central region which ranges from ¼ of thickness to ½ of thickness of base steel sheet

1. A non-oriented electrical steel sheet comprising: a base steel sheet; and an insulating coating, characterized in that
the base steel sheet includes, as a chemical composition, in terms of mass %,
1.0% or more and 5.0% or less of Si,
0% or more and 0.0050% or less of C,
0% or more and 3.0% or less of Mn,
0% or more and 0.30% or less of P,
0% or more and 0.010% or less of S,
0% or more and 3.0% or less of Al,
0% or more and 0.10% or less of Zn,
0% or more and 0.010% or less of N,
0% or more and 0.10% or less of Sn,
0% or more and 0.10% or less of Sb,
0% or more and 0.010% or less of Ca,
0% or more and 5.0% or less of Cr,
0% or more and 5.0% or less of Ni,
0% or more and 5.0% or less of Cu,
0% or more and 0.10% or less of Ce,
0% or more and 0.10% or less of B,
0% or more and 0.10% or less of O,
0% or more and 0.10% or less of Mg,
0% or more and 0.10% or less of Ti,
0% or more and 0.10% or less of V,
0% or more and 0.10% or less of Zr,
0% or more and 0.10% or less of Nd,
0% or more and 0.10% or less of Bi,
0% or more and 0.10% or less of W,
0% or more and 0.10% or less of Mo,
0% or more and 0.10% or less of Nb,
0% or more and 0.10% or less of Y, and
a balance consisting of Fe and impurities,
a thickness of the base steel sheet is 0.10 mm or more and 0.35 mm or less, and
when the base steel sheet is viewed in a cross section whose cutting direction is parallel to a thickness direction, an average grain size is 10 μm or less in a surface region which ranges from a surface of the base steel sheet to 1/20 of the thickness.

2. The non-oriented electrical steel sheet according to claim 1,
wherein, when the base steel sheet is viewed in the cross section,
an average grain size is 50 μm or more and 200 μm or less in an intermediate region which ranges from 1/20 of the thickness to ¼ of the thickness based on the surface, and
an average grain size is 50 μm or more and 200 μm or less in a central region which ranges from ¼ of the thickness to ½ of the thickness based on the surface.

3. The non-oriented electrical steel sheet according to claim 1,
wherein the base steel sheet includes, as the chemical composition, in terms of mass %, 0% or more and less than 0.030% of Sn.

4. The non-oriented electrical steel sheet according to claim 1,
wherein, when the base steel sheet is viewed in the cross section and when an R value is defined as R=9.9+12.4[Si]+10.0[Al]+6.6[Mn] which is calculated using a Si content, an Al content, and a Mn content in mass % in the chemical composition of the base steel sheet, the R value is 60 or more and 250 or less in a region which ranges from the surface to 1/10 of the thickness, and
the R value is 30 or more and less than 60 in a region which ranges from 1/10 of the thickness to ½ of the thickness based on the surface.

5. The non-oriented electrical steel sheet according to claim 2,
wherein, when the base steel sheet is viewed in the cross section, and when an R value which is calculated using a Si content, an Al content, and a Mn content in mass % in the chemical composition of the base steel sheet is defined as R=9.9+12.4[Si]+10.0[Al]+6.6[Mn],
the R value is 60 or more and 250 or less in a region which ranges from the surface to 1/10 of the thickness, and
the R value is 30 or more and less than 60 in a region which ranges from 1/10 of the thickness to ½ of the thickness based on the surface.

6. The non-oriented electrical steel sheet according to claim 1, wherein
at a position of ½ of the thickness based on the surface, a {100} reflected intensity is 2.4 or more, and an area fraction of {100} oriented grains is 18% or more in an observed visual field.

7. The non-oriented electrical steel sheet according to claim 2, wherein
at a position of ½ of the thickness based on the surface, a {100} reflected intensity is 2.4 or more, and an area fraction of {100} oriented grains is 18% or more in an observed visual field.

8. The non-oriented electrical steel sheet according to claim 4, wherein
at a position of ½ of the thickness based on the surface, a {100} reflected intensity is 2.4 or more, and an area fraction of {100} oriented grains is 18% or more in an observed visual field.

9. The non-oriented electrical steel sheet according to claim 5, wherein
at a position of ½ of the thickness based on the surface, a {100} reflected intensity is 2.4 or more, and an area fraction of {100} oriented grains is 18% or more in an observed visual field.

10. An iron core comprising the non-oriented electrical steel sheet according to claim 1.

11. A manufacturing method for an iron core, the method comprising a process of laminating the non-oriented electrical steel sheet according to claim 1.

12. A motor comprising the iron core according to claim 10.

13. A manufacturing method for a motor, the method comprising: a process of laminating the non-oriented electrical steel sheet according to claim 1 to obtain an iron core; and a process of assembling the iron core into a motor.

14. A non-oriented electrical steel sheet comprising: a base steel sheet; and an insulating coating, characterized in that
the base steel sheet includes, as a chemical composition, in terms of mass %,
1.0% or more and 5.0% or less of Si,
0% or more and 0.0050% or less of C,
0% or more and 3.0% or less of Mn,
0% or more and 0.30% or less of P,
0% or more and 0.010% or less of S,
0% or more and 3.0% or less of Al,
0% or more and 0.10% or less of Zn,
0% or more and 0.010% or less of N,
0% or more and 0.10% or less of Sn,
0% or more and 0.10% or less of Sb,
0% or more and 0.010% or less of Ca,
0% or more and 5.0% or less of Cr,
0% or more and 5.0% or less of Ni,
0% or more and 5.0% or less of Cu,
0% or more and 0.10% or less of Ce,
0% or more and 0.10% or less of B,
0% or more and 0.10% or less of O,
0% or more and 0.10% or less of Mg,
0% or more and 0.10% or less of Ti,
0% or more and 0.10% or less of V,
0% or more and 0.10% or less of Zr,
0% or more and 0.10% or less of Nd,
0% or more and 0.10% or less of Bi,
0% or more and 0.10% or less of W,
0% or more and 0.10% or less of Mo,
0% or more and 0.10% or less of Nb,
0% or more and 0.10% or less of Y, and
a balance comprising Fe and impurities,
a thickness of the base steel sheet is 0.10 mm or more and 0.35 mm or less, and
when the base steel sheet is viewed in a cross section whose cutting direction is parallel to a thickness direction, an average grain size is 10 μm or less in a surface region which ranges from a surface of the base steel sheet to 1/20 of the thickness.

15. An iron core comprising the non-oriented electrical steel sheet according to claim 2.

16. An iron core comprising the non-oriented electrical steel sheet according to claim 3.

17. An iron core comprising the non-oriented electrical steel sheet according to claim 4.

18. An iron core comprising the non-oriented electrical steel sheet according to claim 5.

19. An iron core comprising the non-oriented electrical steel sheet according to claim 6.

20. An iron core comprising the non-oriented electrical steel sheet according to claim 7.
